(19) United States
(12) Patent Application Publication
(10) Pub. No.: US 2024/0370480 A1
(43) Pub. Date: Nov. 7, 2024

(54) SYSTEM AND METHOD FOR CLASSIFICATION OF UNSTRUCTURED DATA

(71) Applicant: blueFlash Software LLC, Barrington, IL (US)

(72) Inventors: Antonio Cesar Amorin, Barrington, IL (US); Georgiann Amorin, Barrington, IL (US)

(73) Assignee: blueFlash Software LLC, Barrington, IL (US)

(21) Appl. No.: 18/142,578

(22) Filed: May 2, 2023

Related U.S. Application Data
(63) Continuation-in-part of application No. 17/661,664, filed on May 2, 2022.
(60) Provisional application No. 63/182,449, filed on Apr. 30, 2021.
(60) Provisional application No. 63/363,970, filed on May 2, 2022.

(51) Int. Cl. G06F 16/35

(52) U.S. Cl. CPC G06F 16/35

(57) ABSTRACT

The present disclosure provides a system, method, and computer program for modeling unstructured data. More specifically, a data modeling solution is provided that enables classification of values within unstructured data sources. The system, method, and computer program operate at a content level. This means that the content of unstructured data is analyzed to classify it. The system extracts information from the pool of unstructured data and classifies it for analysis. The system, method, and computer program maintain classification data types using a supervised machine learning process. Valid values are fed to the classification engine to add/update data constraints. This is an at least partially automated process for maintaining data types. Classification of data-including values, data type, class type, data class, and domain—may be saved to a data repository for further use by the system such that full classification need only be done once per value.

### CROSS REFERENCE TO RELATED APPLICATIONS

The present application is a Continuation-in-Part of U.S. application Ser. No. 17/661,664 filed May 2, 2022, which claims the benefit of U.S. Provisional Patent applications, Ser. Nos. 63/363,970 filed May 2, 2022 and 63/182,449 filed Apr. 30, 2021, both of which are hereby incorporated herein their entireties.

### FIELD OF THE DISCLOSURE

The present disclosure relates to a technological solution that includes a system, a method and computer program for creating relational and non-relational databases from structured, semi-structured, and unstructured data sources, including model building, data classification, data certification, and resolution of data quality problems.

### BACKGROUND

The present disclosure provides a technological solution that includes a system, a method and computer program for creating relational and non-relational databases from structured, semi-structured, and unstructured data sources, including model building, data classification, data certification, and resolution of data quality problems. The technological solution can include big data modeling technologies. The system, method and computer program create relational and non-relational (for example, NoSQL) databases from structured, semi-structured, and unstructured data sources. This can be accomplished based on the data itself, allowing a user to create data targets that are perfect for capturing the data, since all of the physical characteristics can be inferred from the data itself.

### SUMMARY OF THE DISCLOSURE

The present disclosure provides a technological solution that includes a system, a method and computer program for creating relational and non-relational databases from structured and unstructured data sources, including data classification, data certification and resolution of data quality problems. The technological solution can include big data modeling technologies. The system, method and computer program create relational and non-relational (for example, NoSQL) databases from both structured and unstructured data sources. This can be accomplished based on the data itself, allowing a user to create data targets that are perfect for capturing the data, since all of the physical characteristics can be inferred from the data itself.

The present disclosure provides a system, method, and computer program for modeling unstructured data. More specifically, a data modeling solution is provided that enables classification of values within unstructured data sources. The system, method, and computer program operate at a content level. This means that the content of unstructured data is analyzed to classify it. The system extracts information from the pool of unstructured data and classifies it for analysis. The system, method, and computer program maintain classification data types using a supervised machine learning process. Valid values are fed to the classification engine to add/update data constraints. This is an at least partially automated process for maintaining data types. Classification of data-including values, data type, class type, data class, and domain—may be saved to a data repository for further use by the system such that full classification need only be done once per value.

A method for data modeling is provided. The method comprises classification of raw values to establish classified values, profile analysis of the classified values, position analysis of the classified values; and data quality assessment of the classified values. The method may further comprise certification of the classified values. The raw values may be unstructured. Classification may be done by a classification engine. The classification engine may learn by machine learning.

Additional features, advantages, and embodiments of the disclosure may be set forth or apparent from consideration of the detailed description and drawings. Moreover, it is to be understood that the foregoing summary of the disclosure and the following detailed description and drawings provide non-limiting examples that are intended to provide further explanation without limiting the scope of the disclosure as claimed.

### BRIEF DESCRIPTION OF THE DRA WINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

The present disclosure is further described in the detailed description that follows.

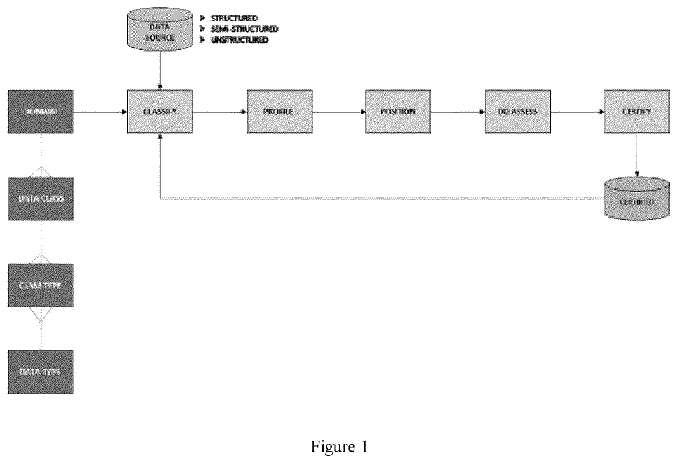

FIG. 1 illustrates an overview of components and steps of the modeling system, in accordance with one embodiment.

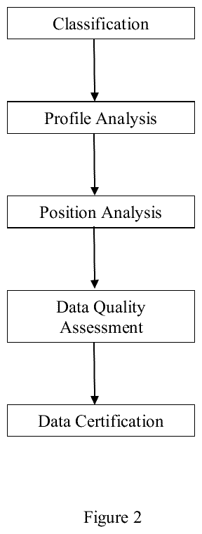

FIG. 2 illustrates steps of data modeling and classification, in accordance with one embodiment.

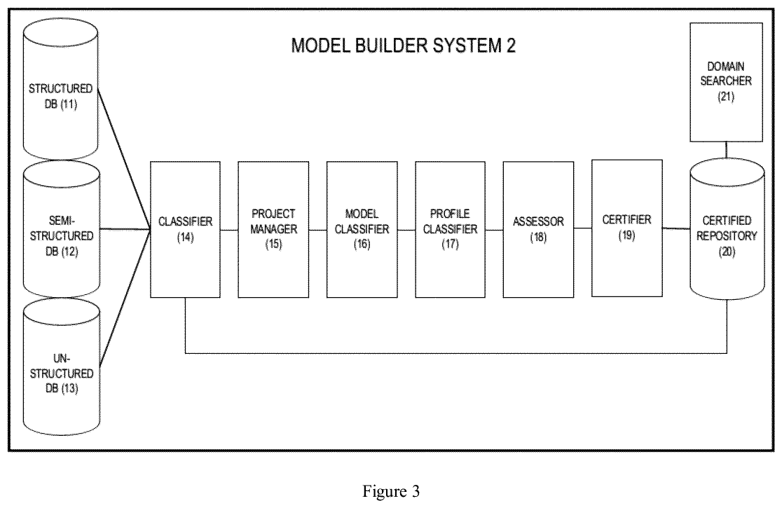

FIG. 3 illustrates a high-level overview of a data modeling solution, in accordance with one embodiment.

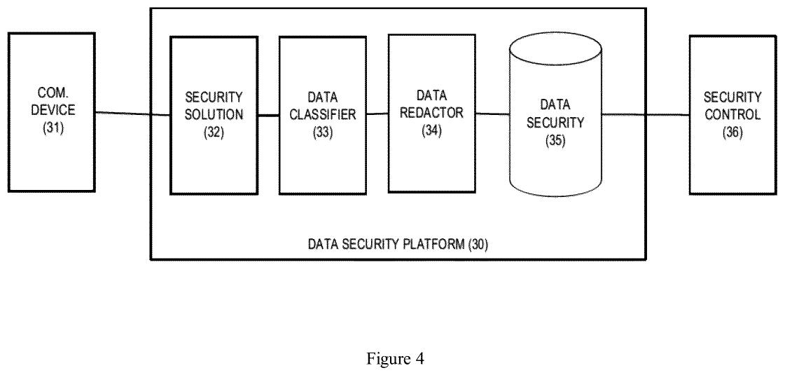

FIG. 4 illustrates a data security module that may be implemented with the data modeling solution, in accordance with one embodiment.

FIG. 5 illustrates a high-level overview of the process the data modeler follows to create and test new data types, classes, and domains (the class types are part of the data classes), in accordance with one embodiment.

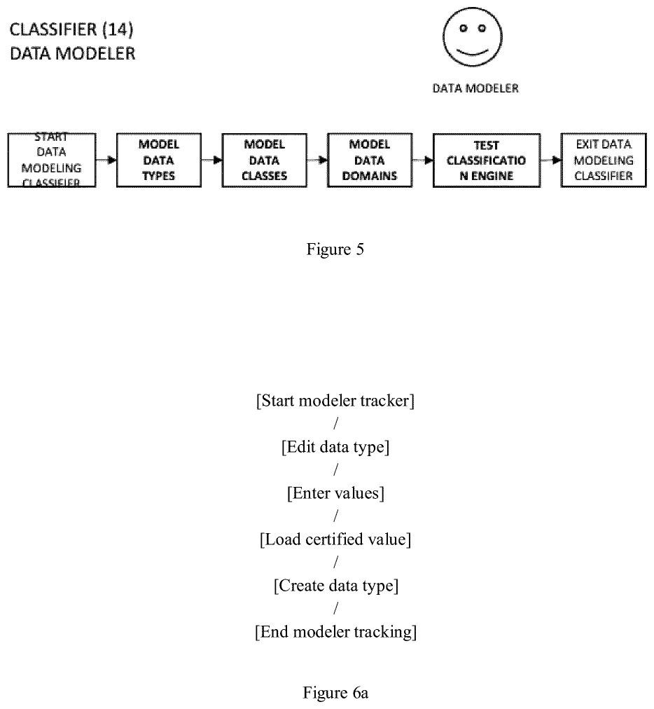

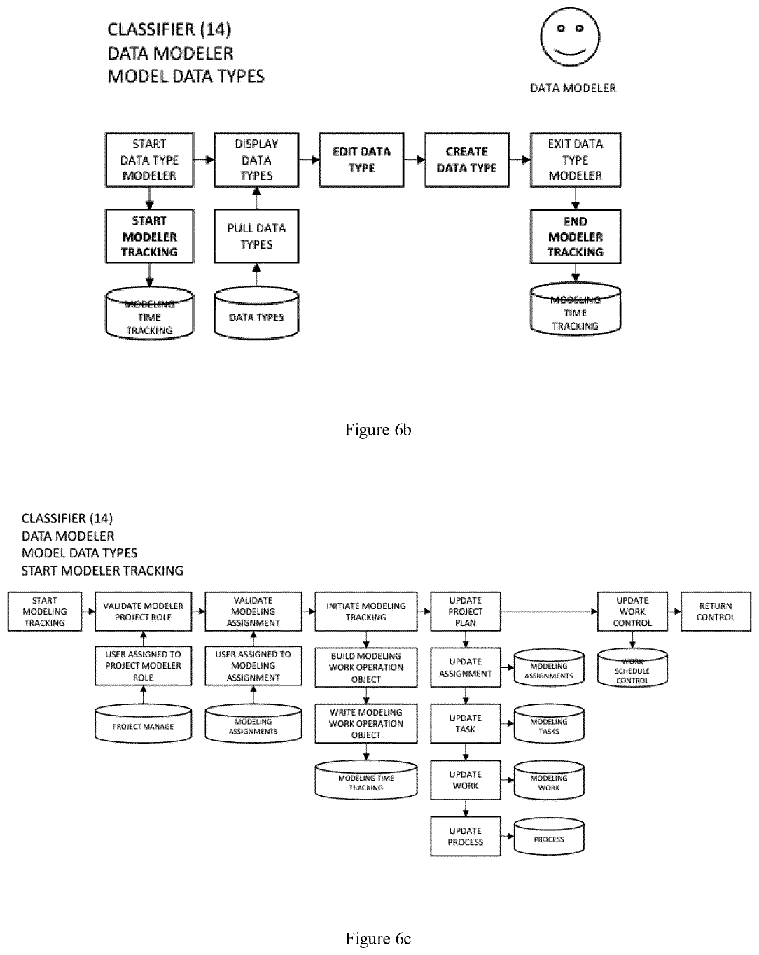

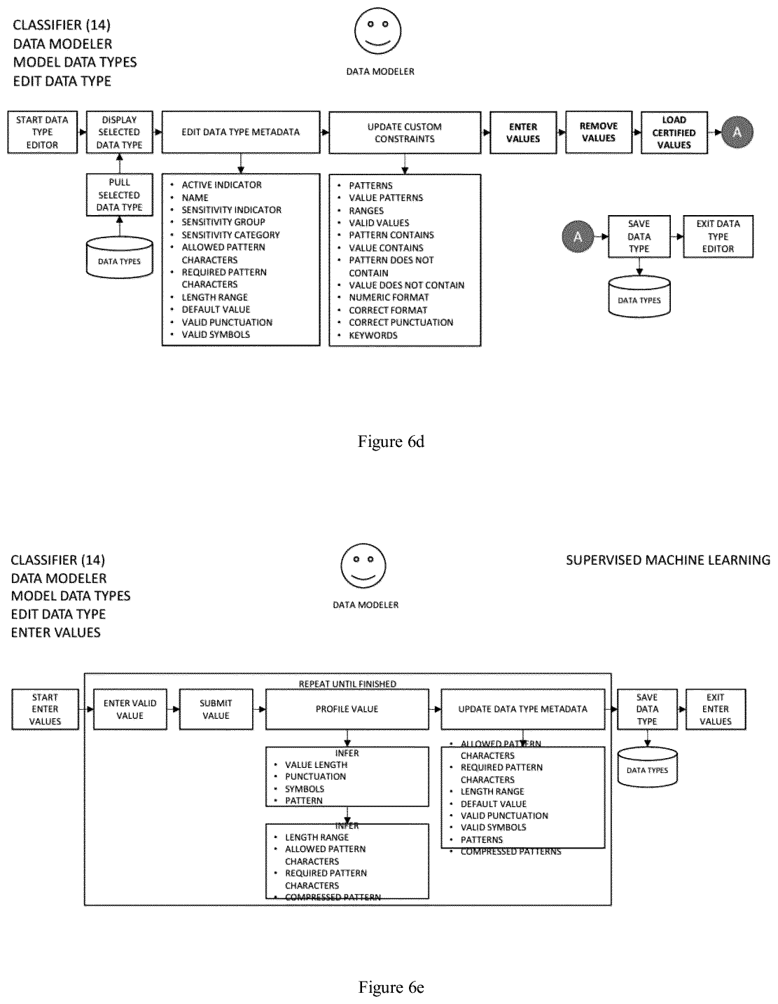

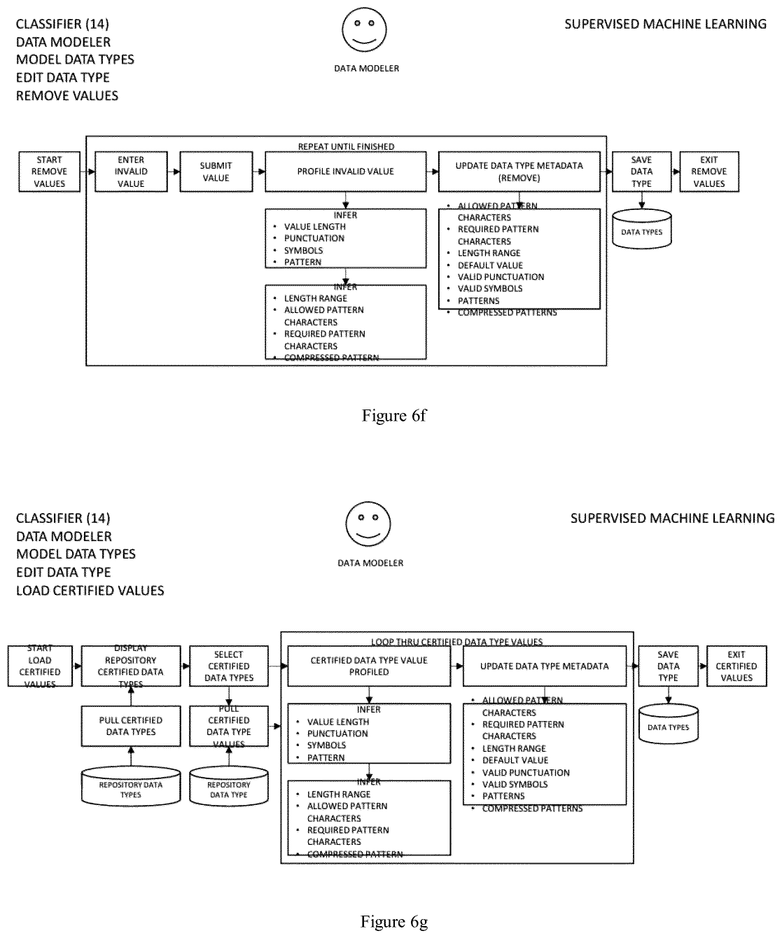

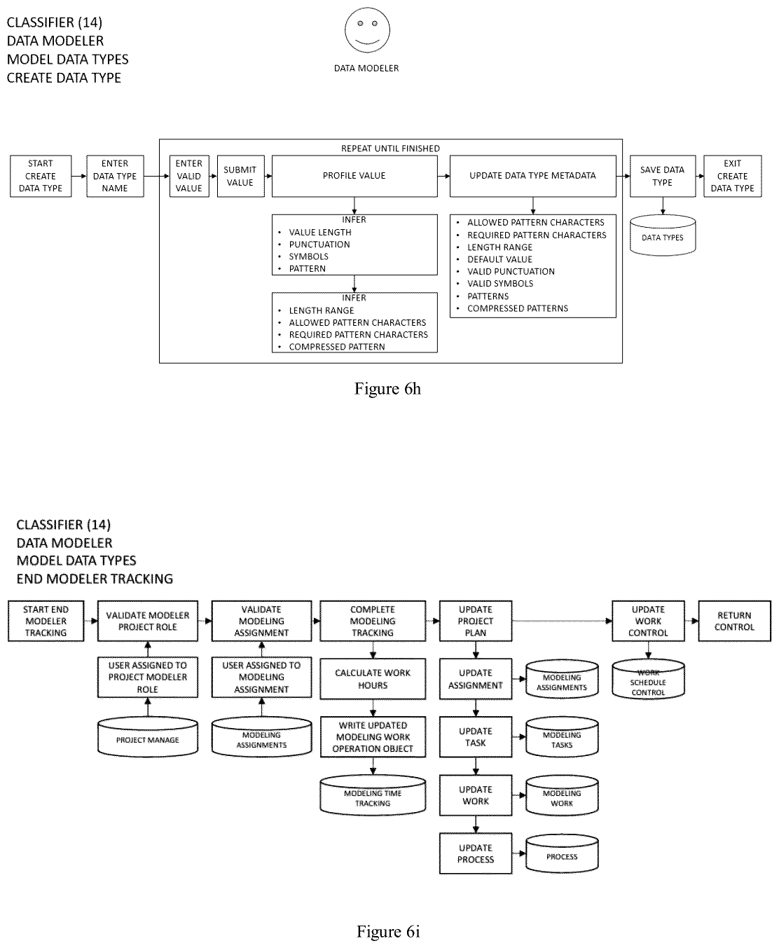

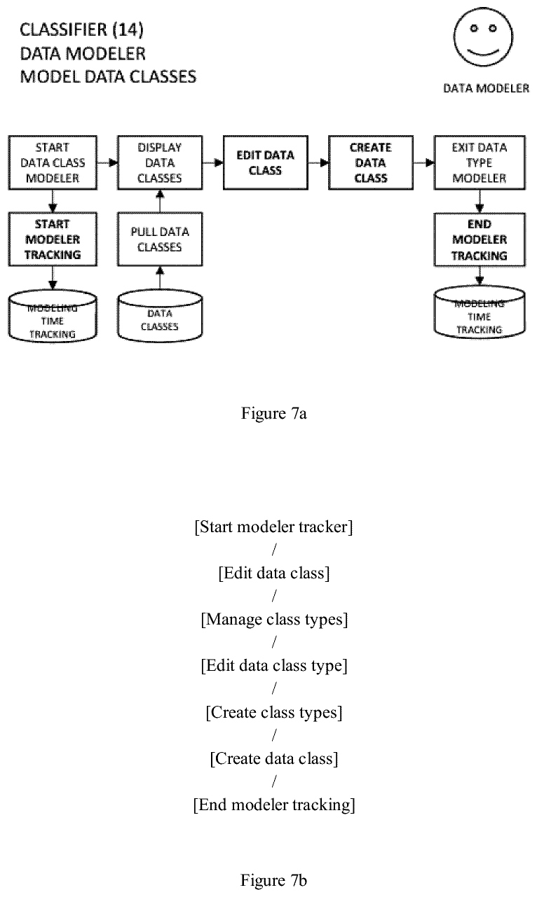

FIG. 6a illustrates a high level process flow for creating data types, in accordance with one embodiment.

FIG. 6b illustrates the process the data modeler follows to create and maintain data types, in accordance with one embodiment.

FIG. 6c illustrates start of modeling tracking, in accordance with one embodiment.

FIG. 6d illustrates editing of a data type, in accordance with one embodiment.

FIG. 6e illustrates entering values as part of editing data type, in accordance with one embodiment.

FIG. 6f illustrates removing values as part of editing data type, in accordance with one embodiment, in accordance with one embodiment.

FIG. 6g illustrates loading certified values as part of editing data type, in accordance with one embodiment.

FIG. 6h illustrates creating a data type, in accordance with one embodiment.

FIG. 6i illustrates ending modeler tracking, in accordance with one embodiment.

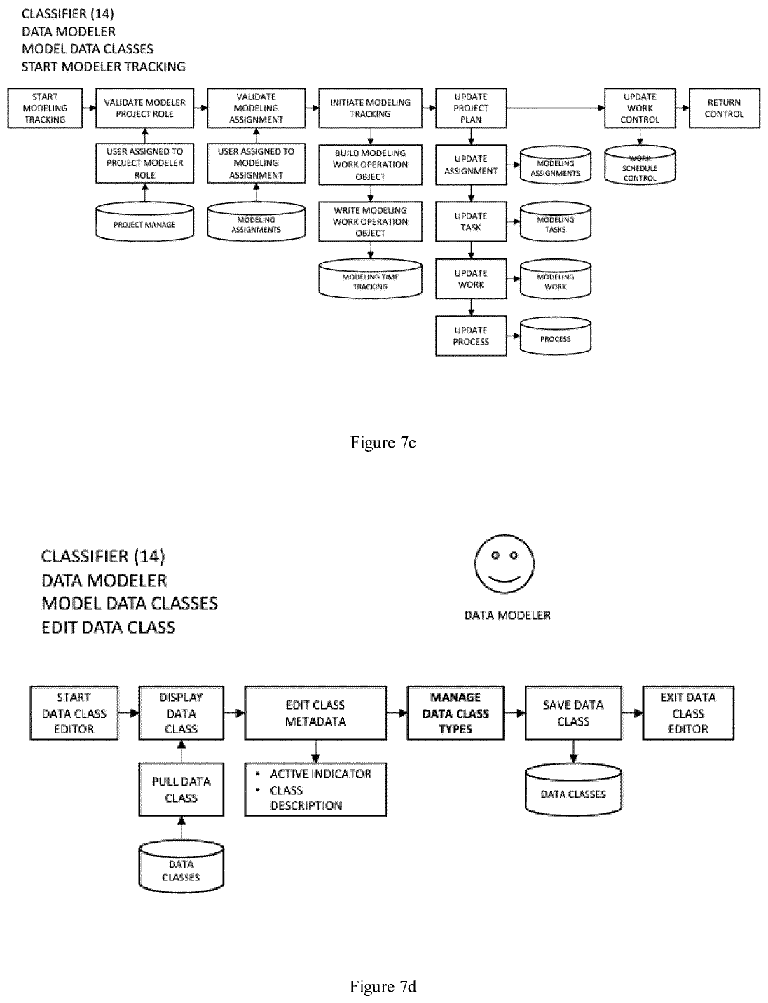

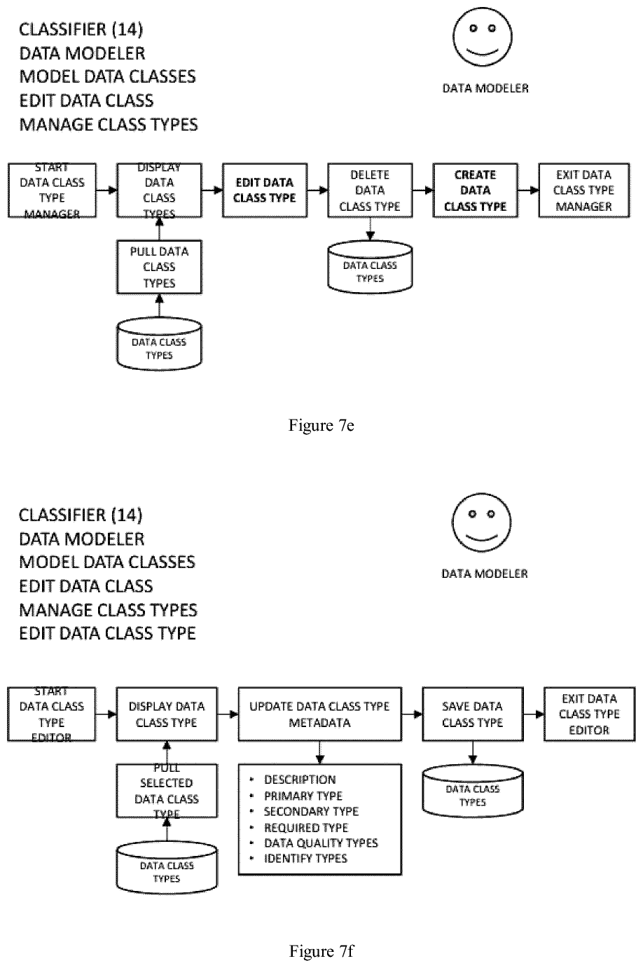

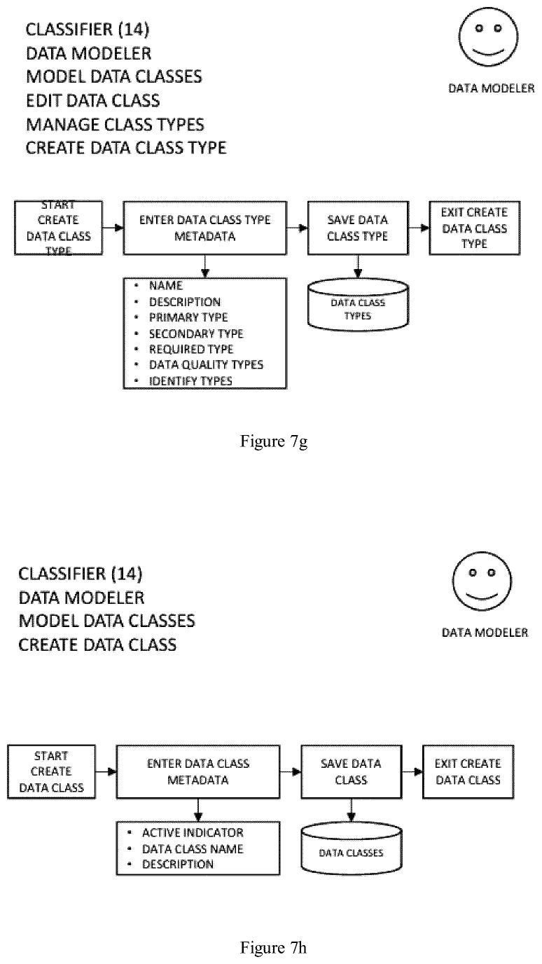

FIG. 7a illustrates creating data classes, in accordance with one embodiment.

FIG. 7b illustrates a high level process flow for creating data classes, in accordance with one embodiment.

FIG. 7c illustrates starting modeler tracking, in accordance with one embodiment.

FIG. 7d illustrates editing the data class, in accordance with one embodiment.

FIG. 7e illustrates the step of managing class types in editing data classes, in accordance with one embodiment.

FIG. 7f illustrates the step of editing data class types in editing data classes, in accordance with one embodiment.

FIG. 7g illustrates the creating data class types, in accordance with one embodiment.

FIG. 7h illustrates the creating data class, in accordance with one embodiment.

FIG. 7i illustrates ending modeler tracking, in accordance with one embodiment.

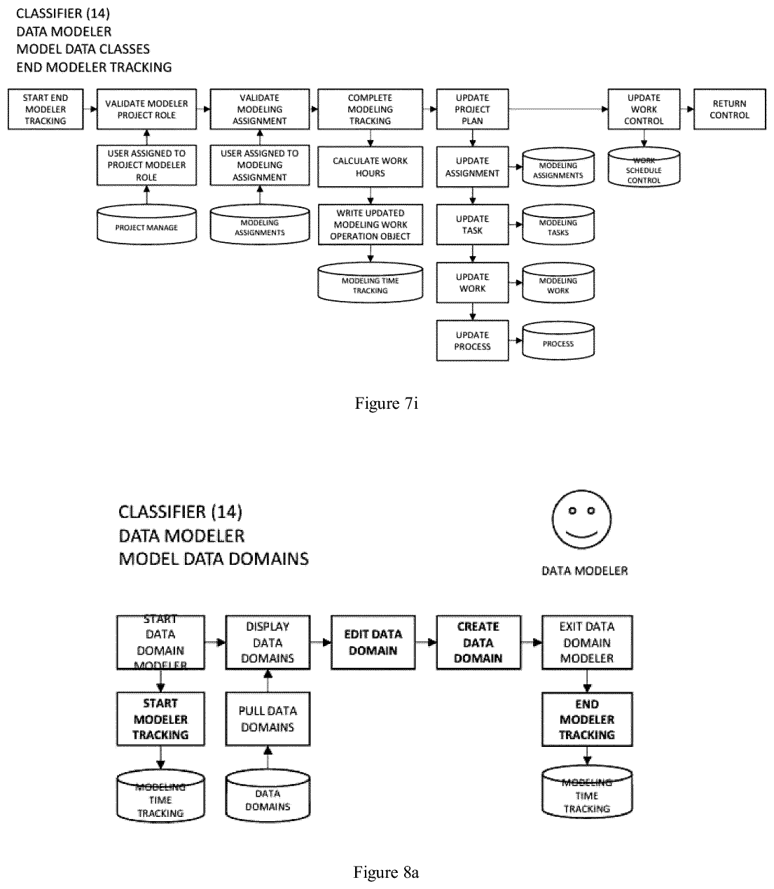

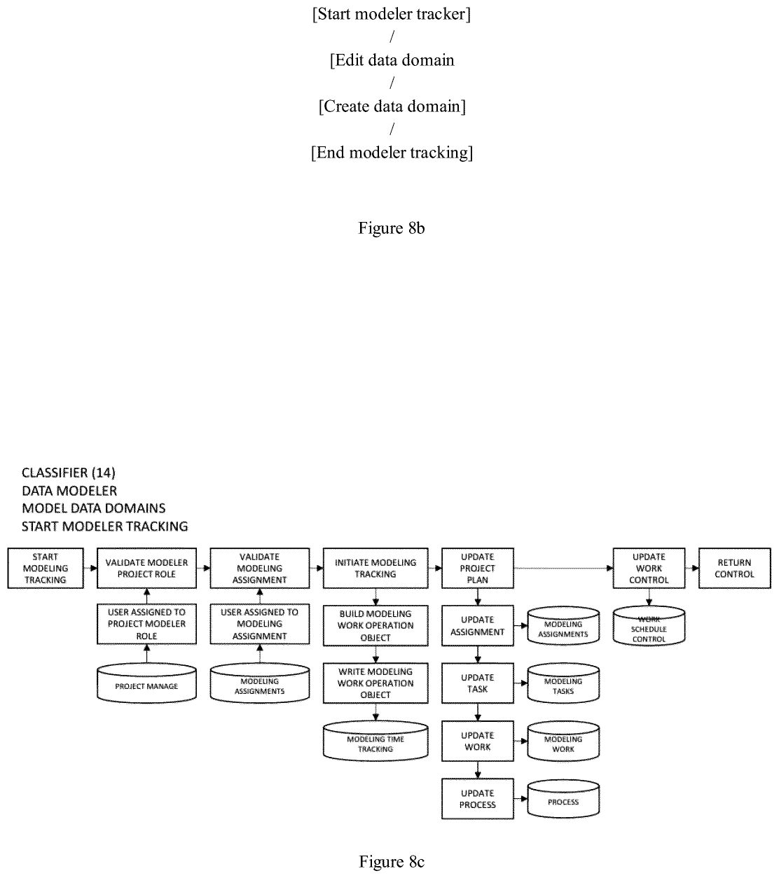

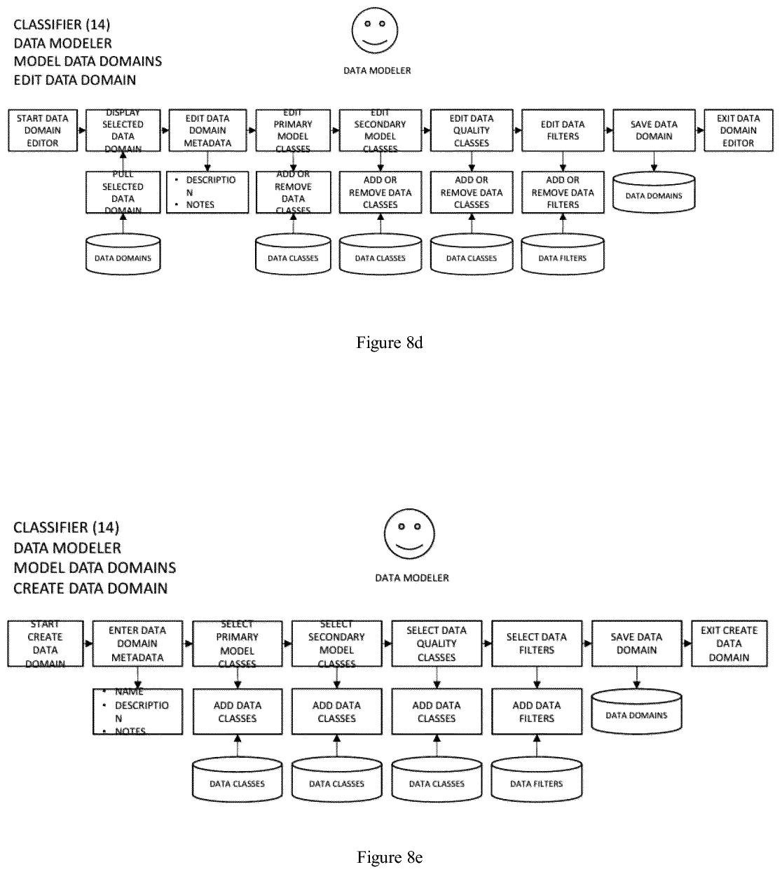

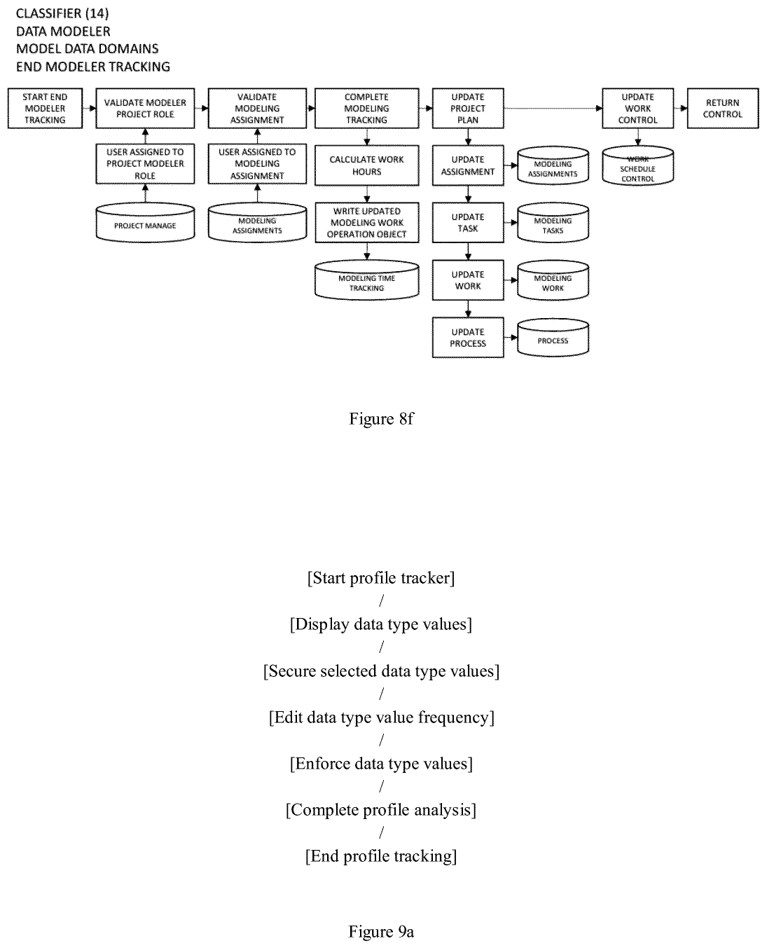

FIG. 8a illustrates creating data domains, in accordance with one embodiment.

FIG. 8b illustrates a high level process flow for creating data domains, in accordance with one embodiment.

FIG. 8c illustrates starting modeler tracking, in accordance with one embodiment.

FIG. 8d illustrates editing the data domain, in accordance with one embodiment.

FIG. 8e illustrates creating the data domain, in accordance with one embodiment.

FIG. 8f illustrates ending modeler tracking, in accordance with one embodiment.

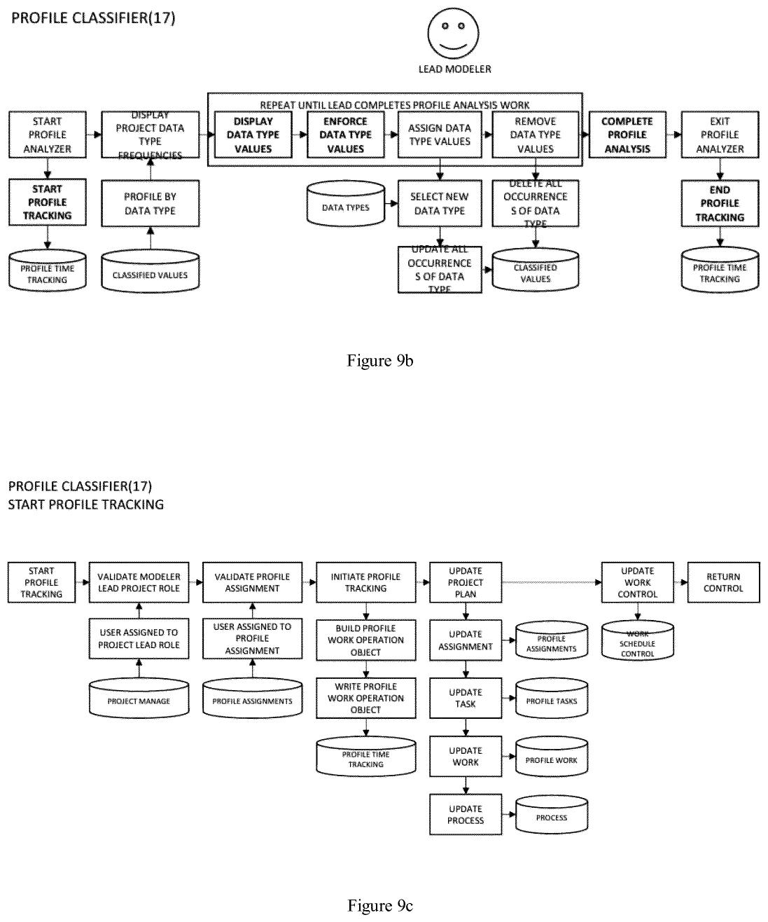

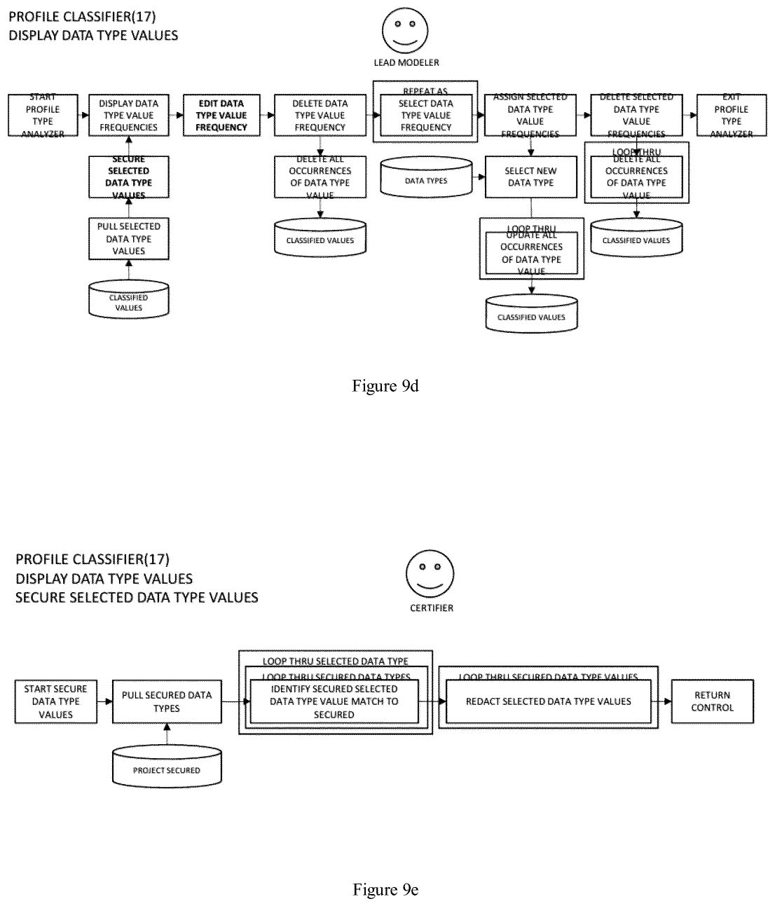

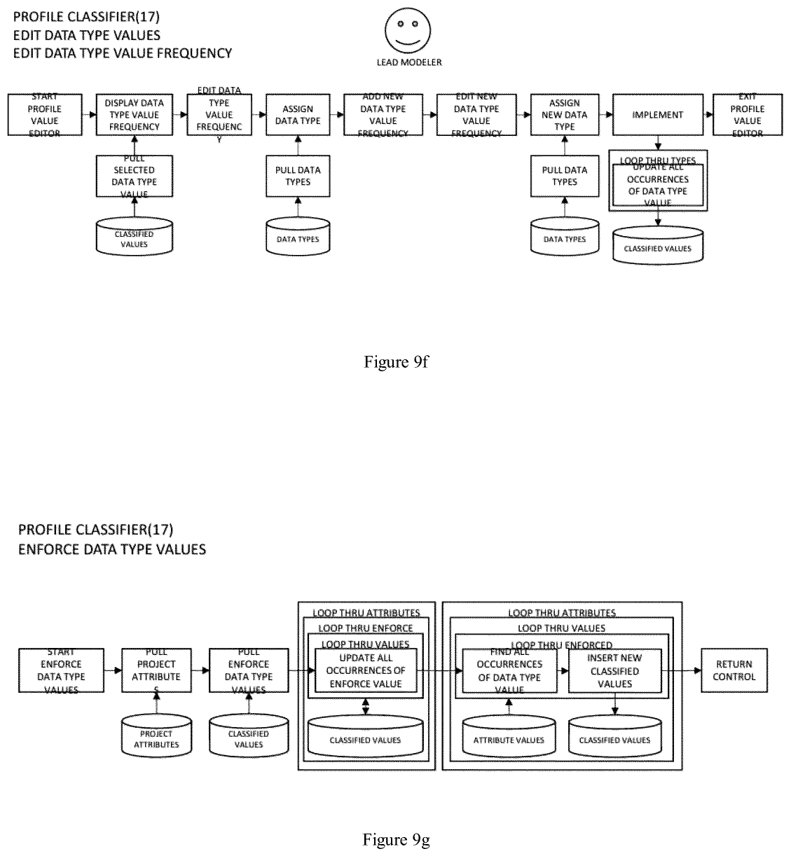

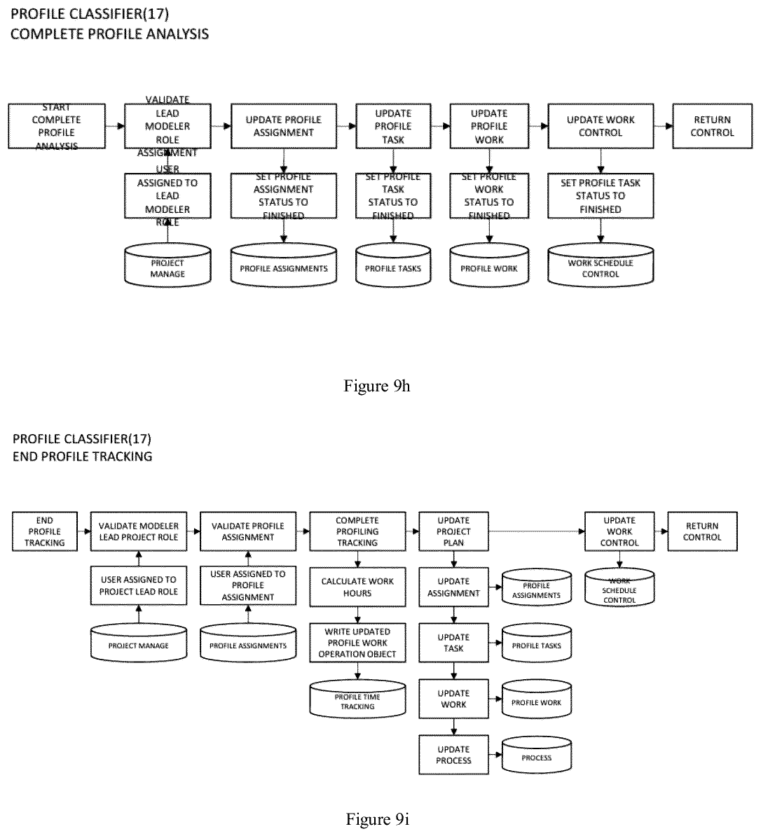

FIG. 9a illustrates a high level process flow for profile analysis, in accordance with one embodiment.

FIG. 9b illustrates the process of profiling analysis, in accordance with one embodiment.

FIG. 9c illustrates starting profile tracking, in accordance with one embodiment.

FIG. 9d illustrates displaying data type values, in accordance with one embodiment.

FIG. 9e illustrates securing selected data type values, in accordance with one embodiment.

FIG. 9f illustrates editing data type value frequency, in accordance with one embodiment.

FIG. 9g illustrates enforcing data type values, in accordance with one embodiment.

FIG. 9h illustrates completing profile analysis, in accordance with one embodiment.

FIG. 9i illustrates ending profile tracking, in accordance with one embodiment.

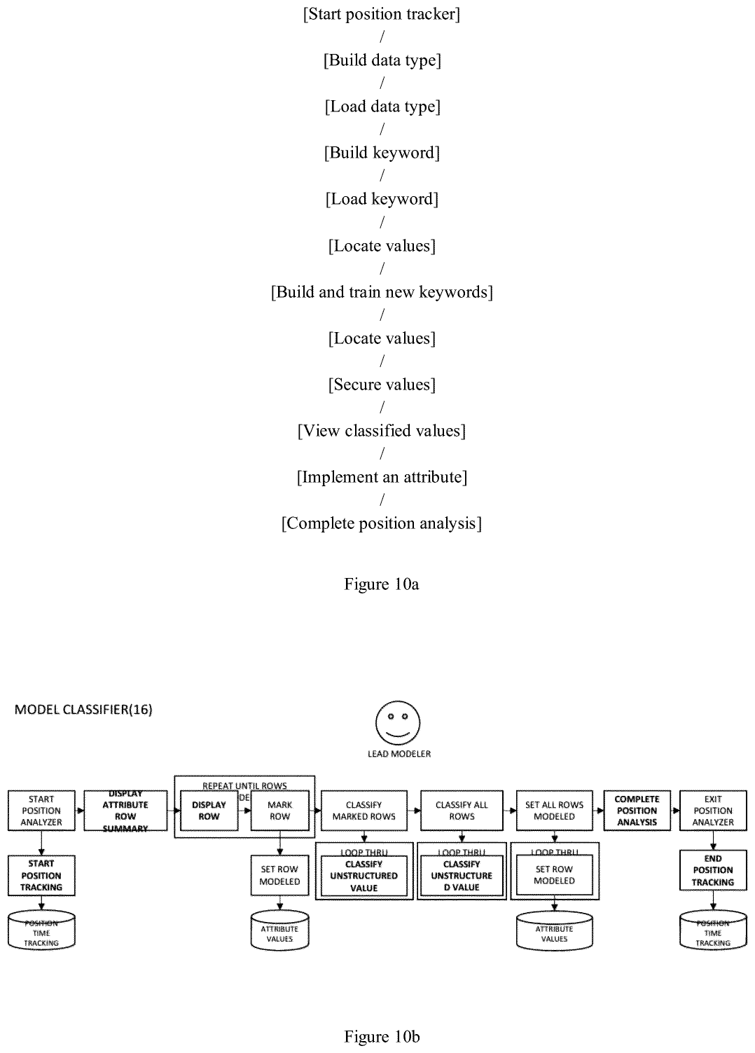

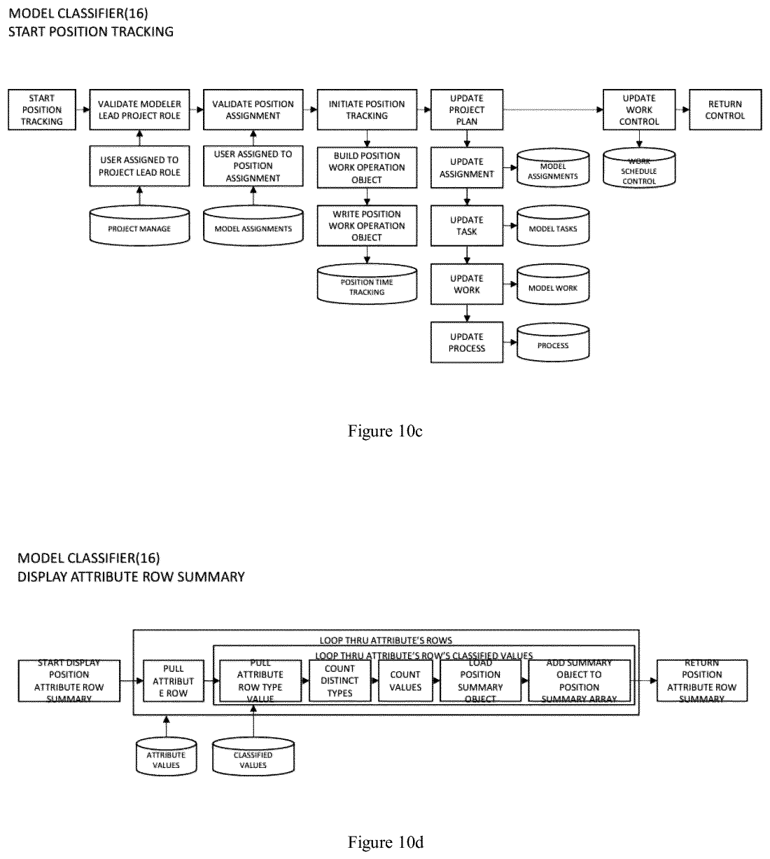

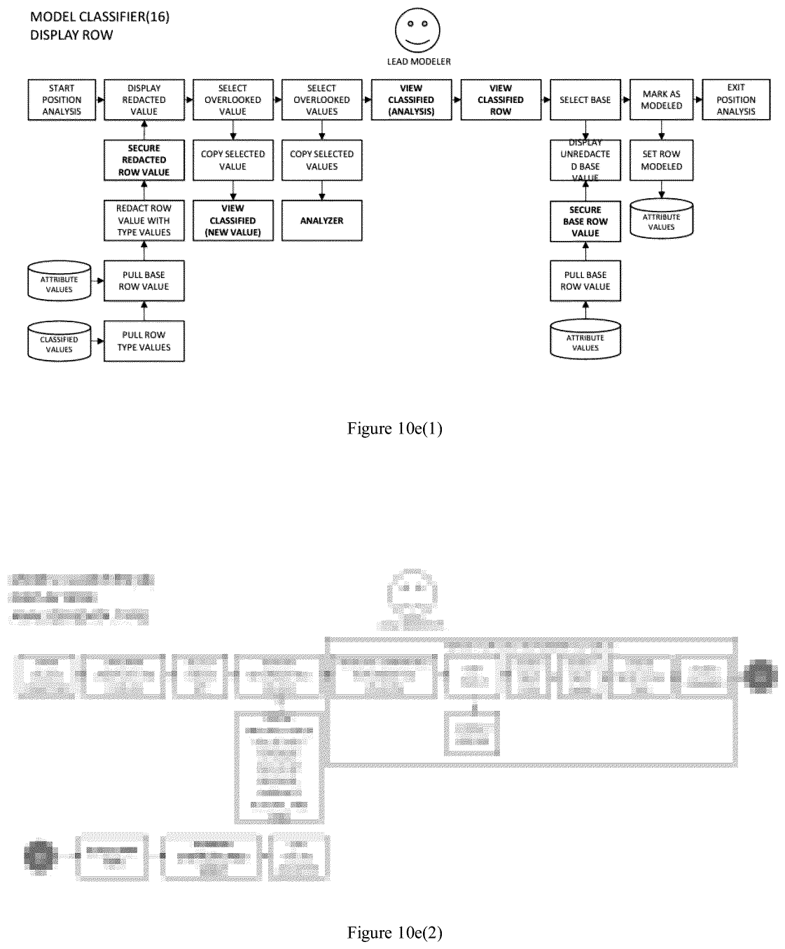

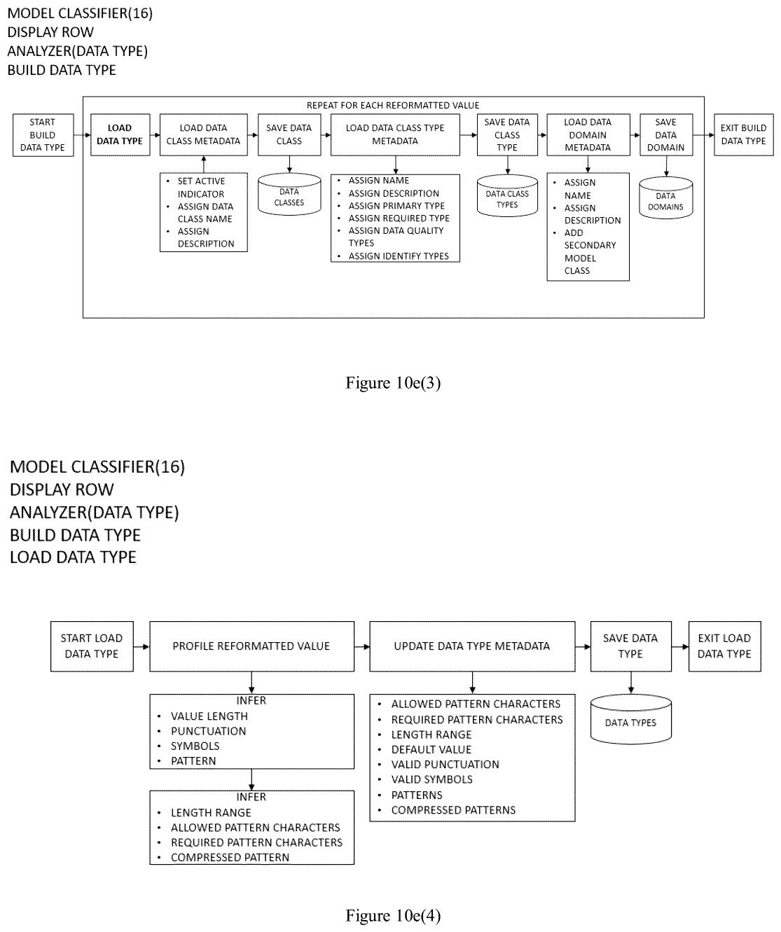

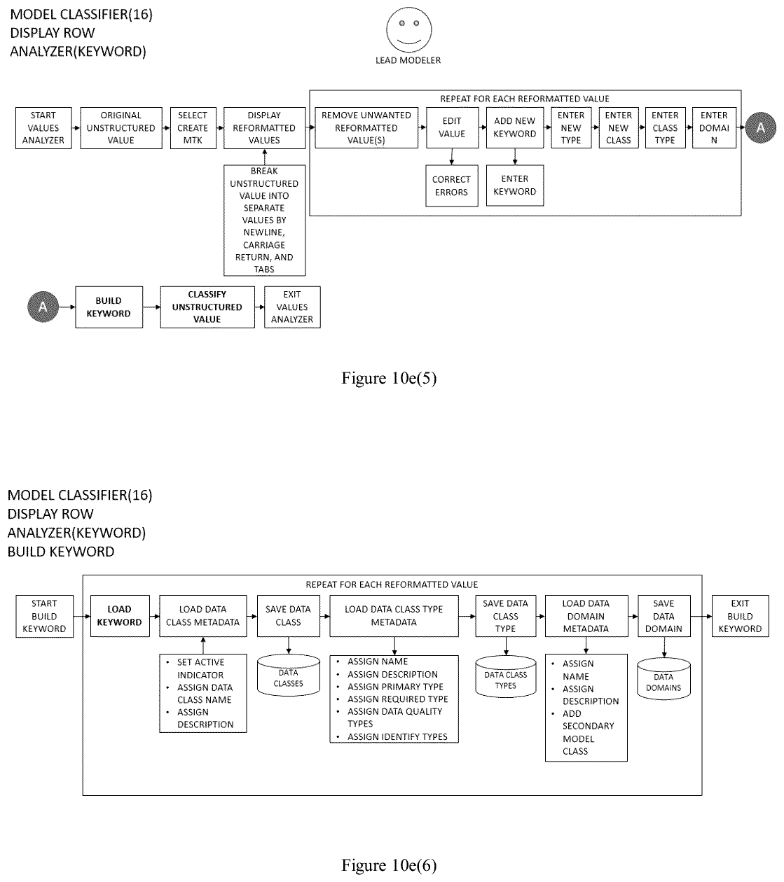

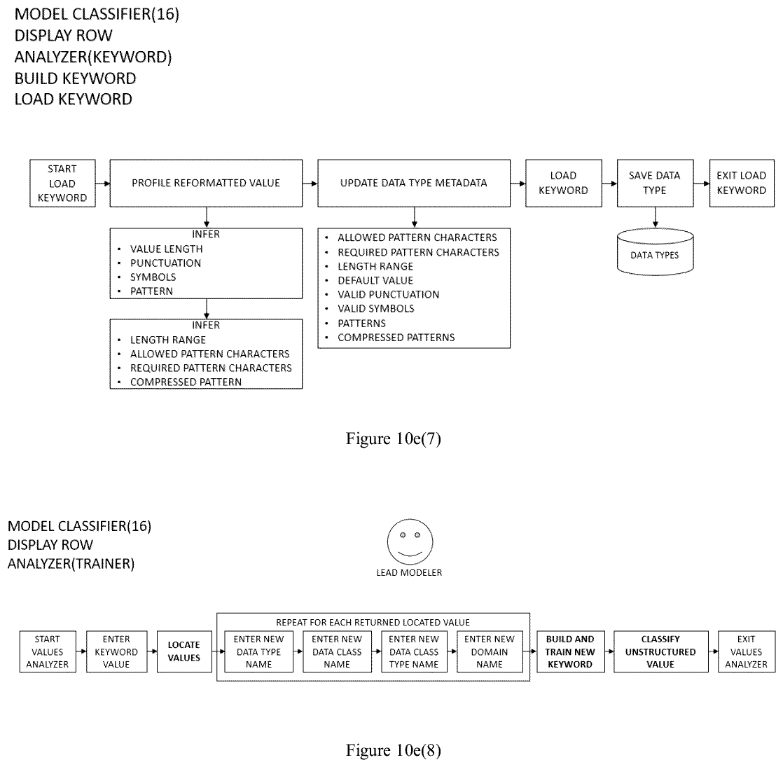

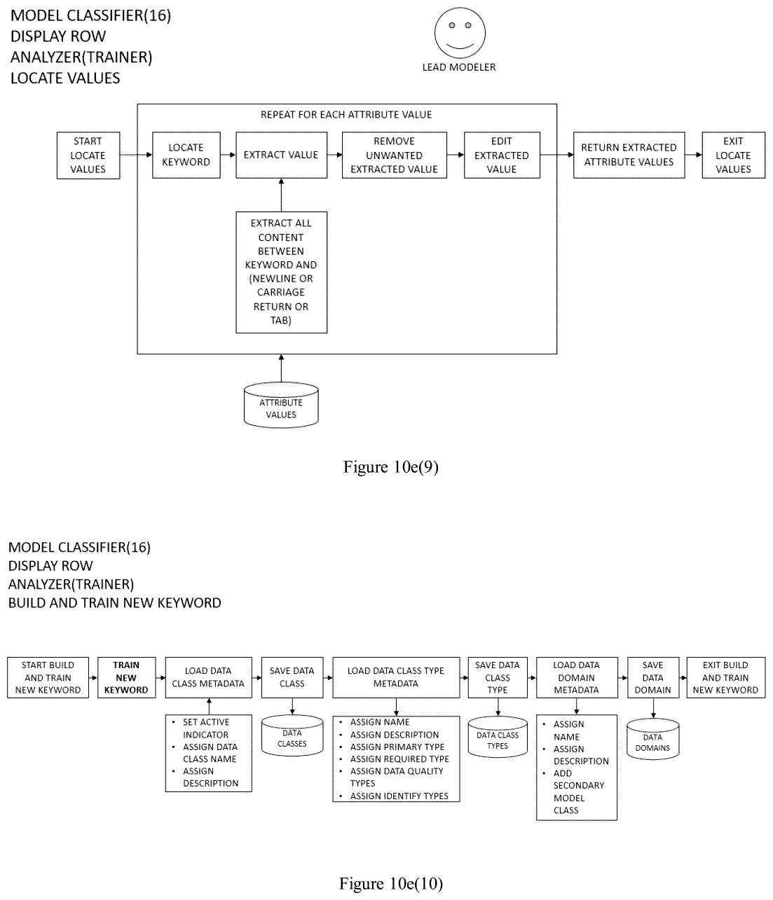

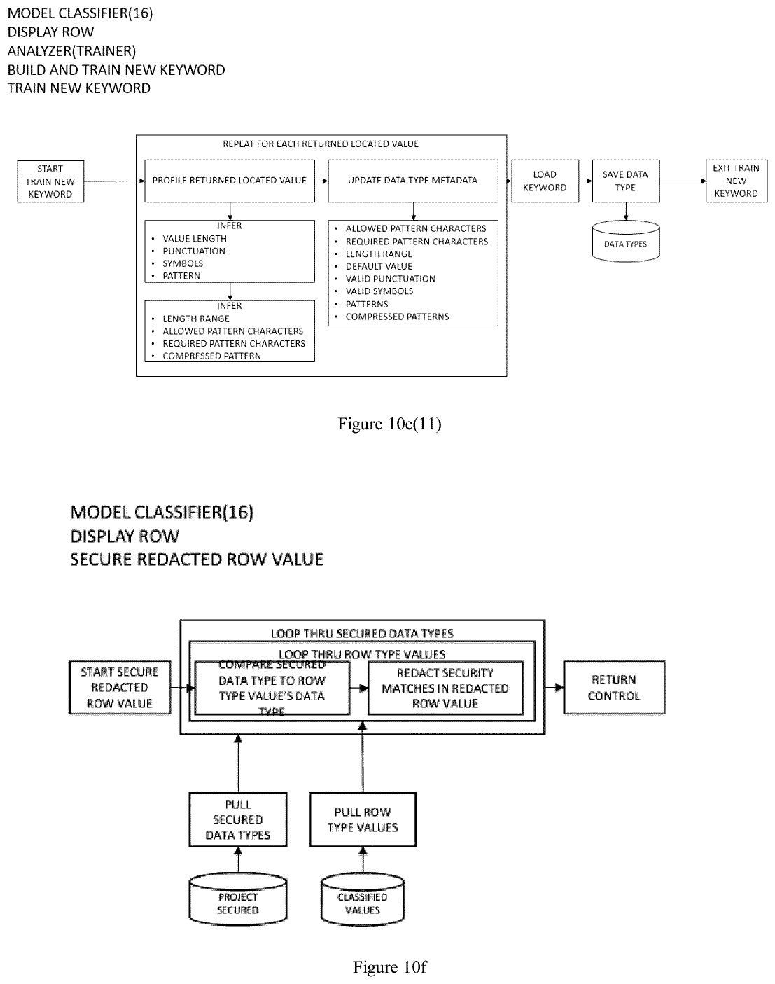

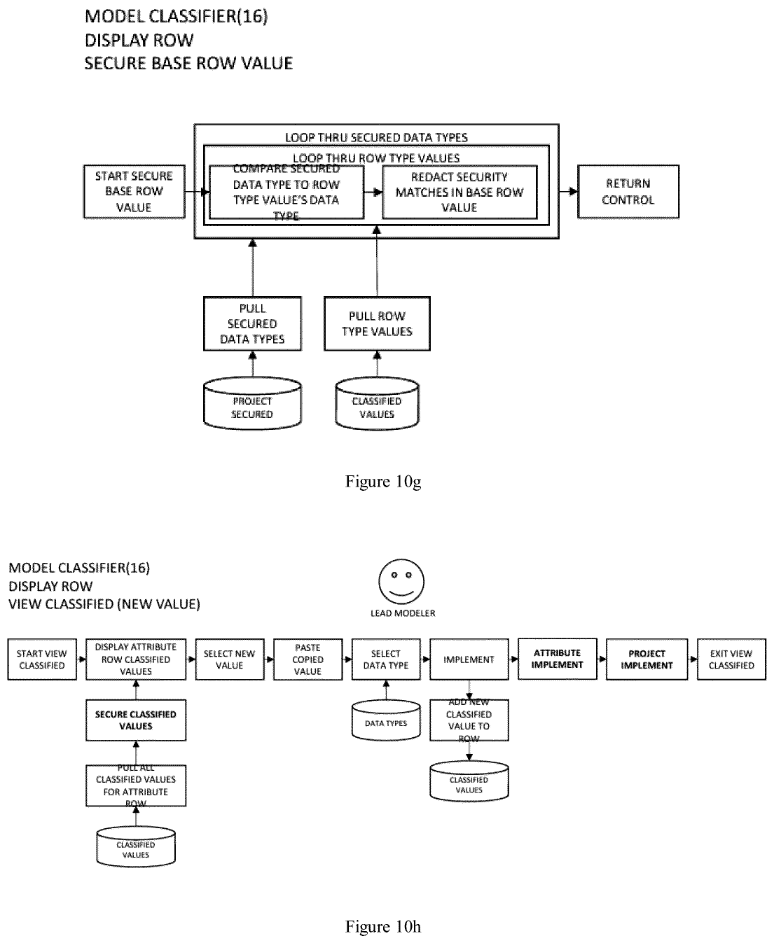

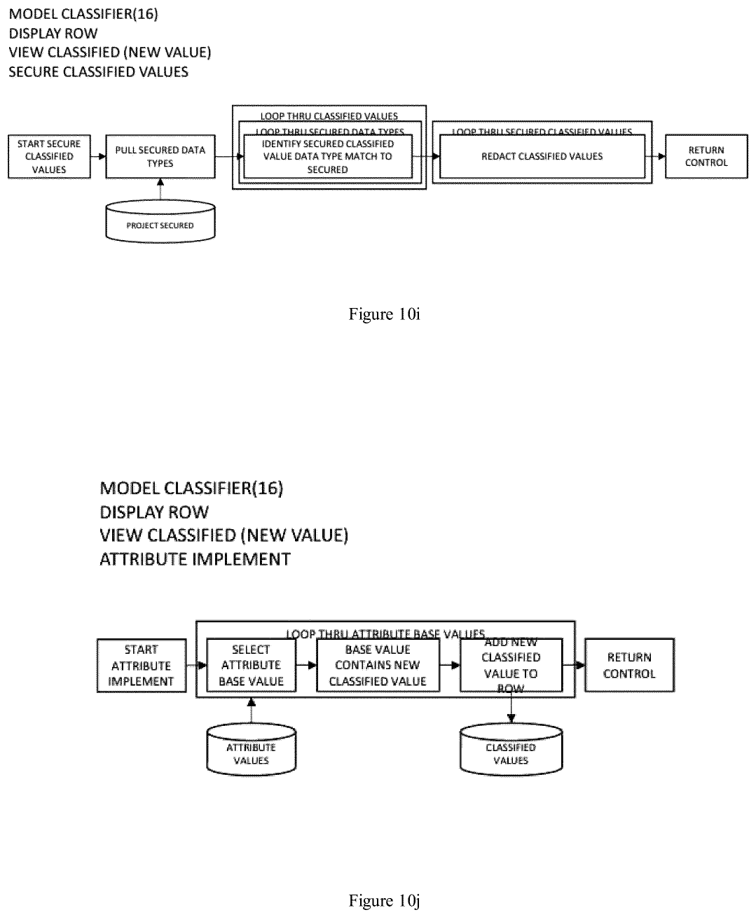

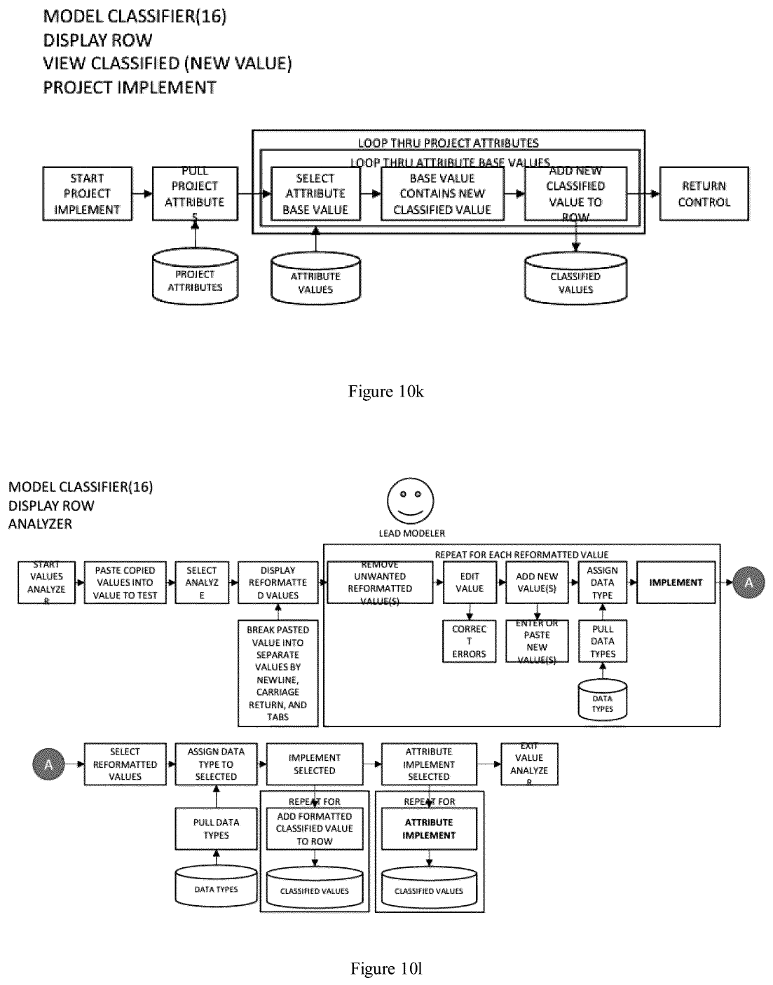

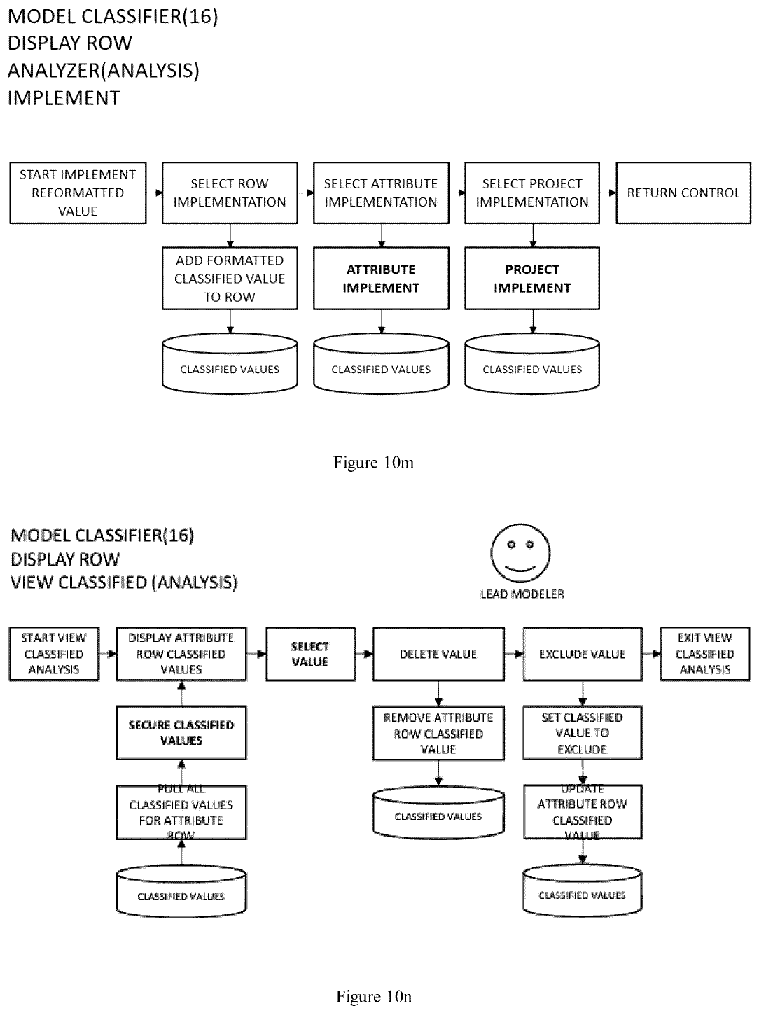

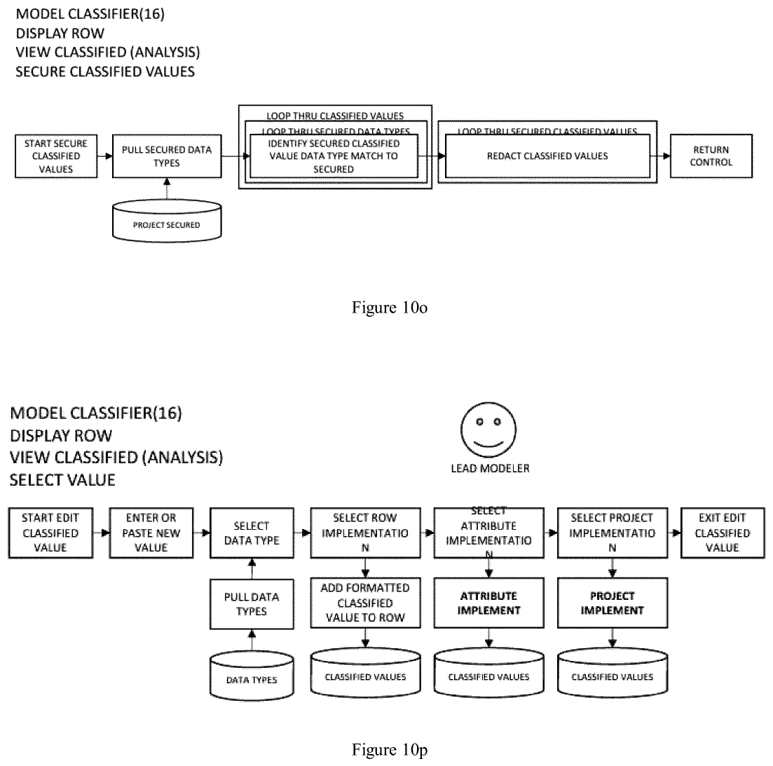

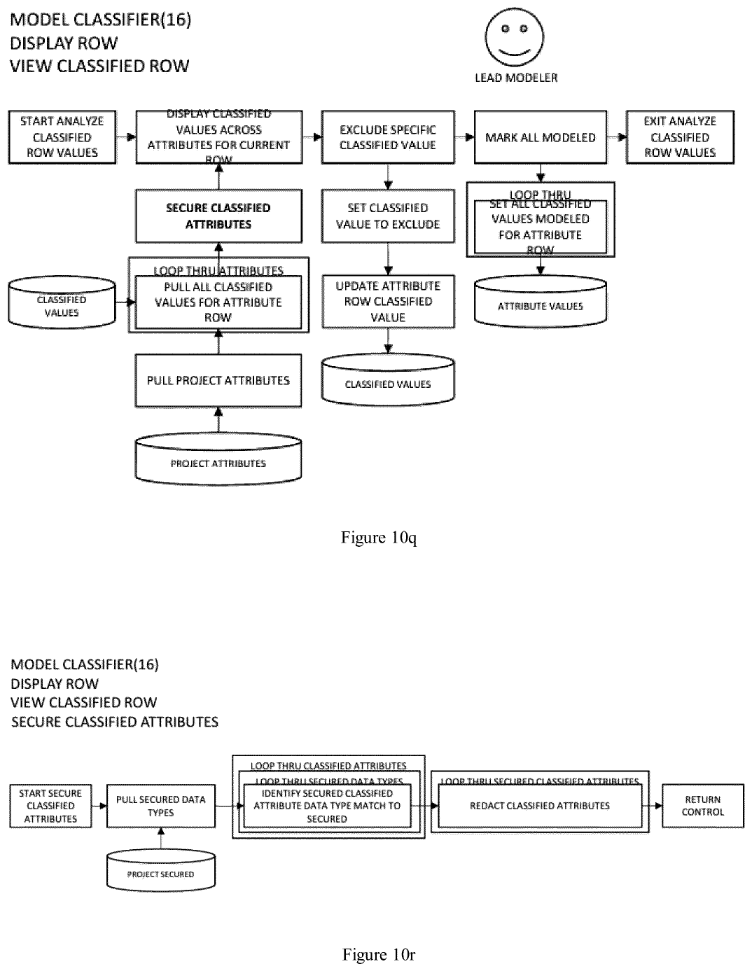

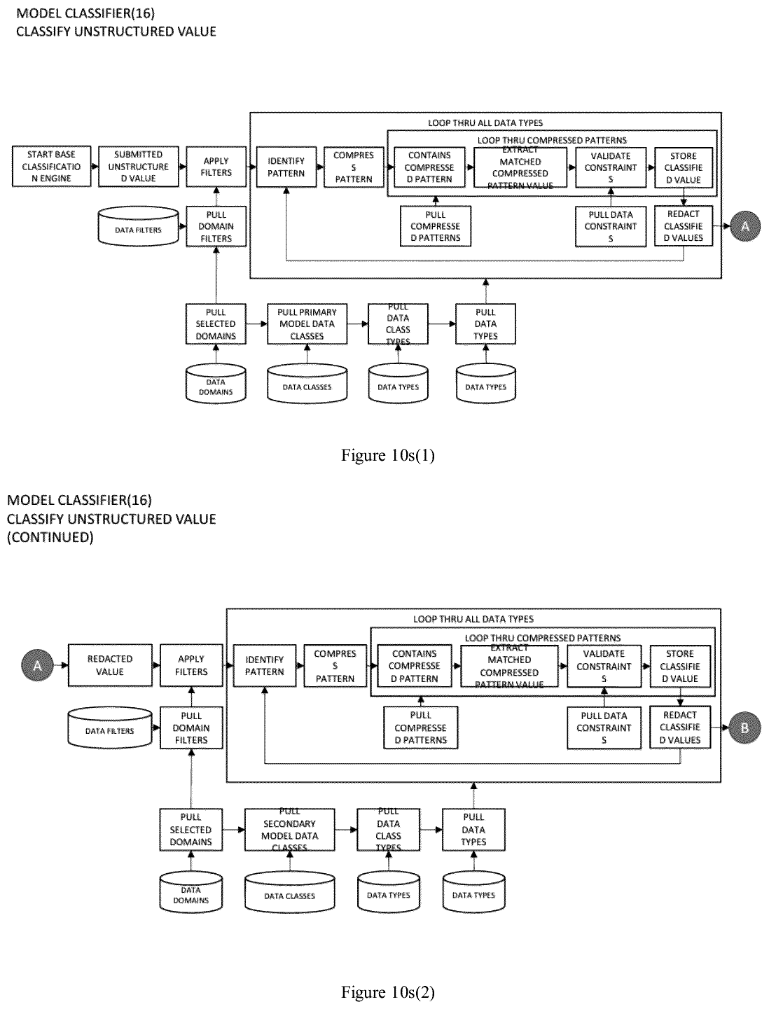

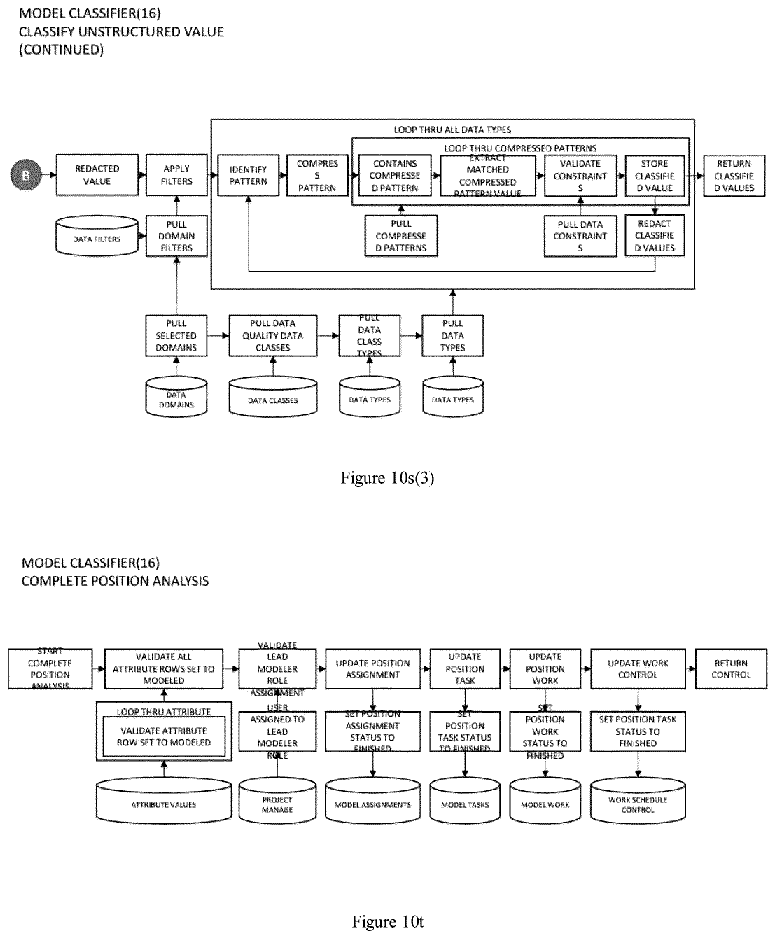

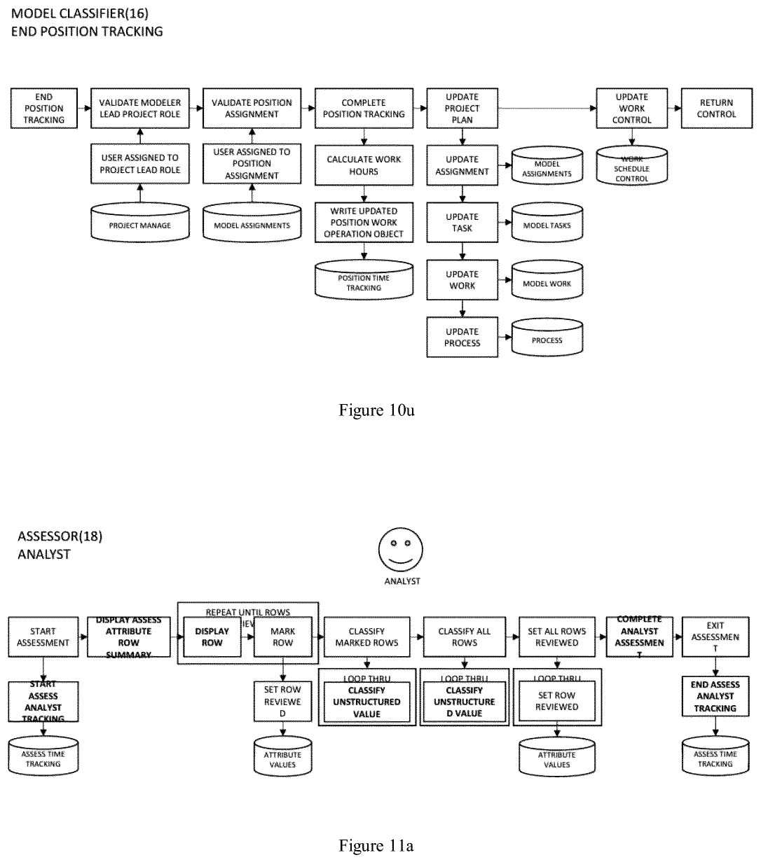

FIG. 10a illustrates a high level process flow for position analysis, in accordance with one embodiment.

FIG. 10b illustrates a model classifier, in accordance with one embodiment.

FIG. 10c illustrates starting position tracking, in accordance with one embodiment.

FIG. 10d illustrates displaying attribute row summary, in accordance with one embodiment.

FIG. 10e(1) diagram identifies the process the data modeler follows to review the unstructured attribute value to identify the business values improperly classified within the unstructured value, in accordance with one embodiment.

FIG. 10e(2) identifies the process the data modeler follows to create a new data type, in accordance with one embodiment.

FIG. 10e(3) illustrates building a data type, in accordance with one embodiment.

FIG. 10e(4) illustrates loading a data type, in accordance with one embodiment.

FIG. 10e(5) illustrates creating a keyword data type, in accordance with one embodiment.

FIG. 10e(6) illustrates creating a new classification keyword, in accordance with one embodiment.

FIG. 10e(7) illustrates creating a new data type, in accordance with one embodiment.

FIG. 10e(8) illustrates creating and training a new keyword data type, in accordance with one embodiment.

FIG. 10e(9) illustrates selecting valid values, in accordance with one embodiment.

FIG. 10e(10) illustrates building and training a new keyword, in accordance with one embodiment.

FIG. 10e(11) illustrates training a new keyword, in accordance with one embodiment.

FIG. 10f illustrates securing redacted row value, in accordance with one embodiment.

FIG. 10g illustrates securing base row value, in accordance with one embodiment.

FIG. 10h illustrates classifying a new value, in accordance with one embodiment.

FIG. 10i illustrates securing a new value, in accordance with one embodiment.

FIG. 10j illustrates implementing an attribute, in accordance with one embodiment.

FIG. 10k illustrates implementing a new classified value, in accordance with one embodiment.

FIG. 10l illustrates analyzing a set of values, in accordance with one embodiment.

FIG. 10m illustrates implementing newly classified values, in accordance with one embodiment.

FIG. 10n illustrates reviewing classified values, in accordance with one embodiment.

FIG. 10o illustrates securing classified values, in accordance with one embodiment.

FIG. 10p illustrates applying values, in accordance with one embodiment.

FIG. 10q illustrates analyzing values, in accordance with one embodiment.

FIG. 10r illustrates securing data, in accordance with one embodiment.

FIG. 10s(1) illustrates aspects of classifying values within an unstructured value, in accordance with one embodiment.

FIG. 10s(2) illustrates aspects of classifying values within an unstructured value, in accordance with one embodiment.

FIG. 10s(3) illustrates aspects of classifying values within an unstructured value, in accordance with one embodiment.

FIG. 10t illustrates completing position analysis, in accordance with one embodiment.

FIG. 10u illustrates ending position tracking, in accordance with one embodiment.

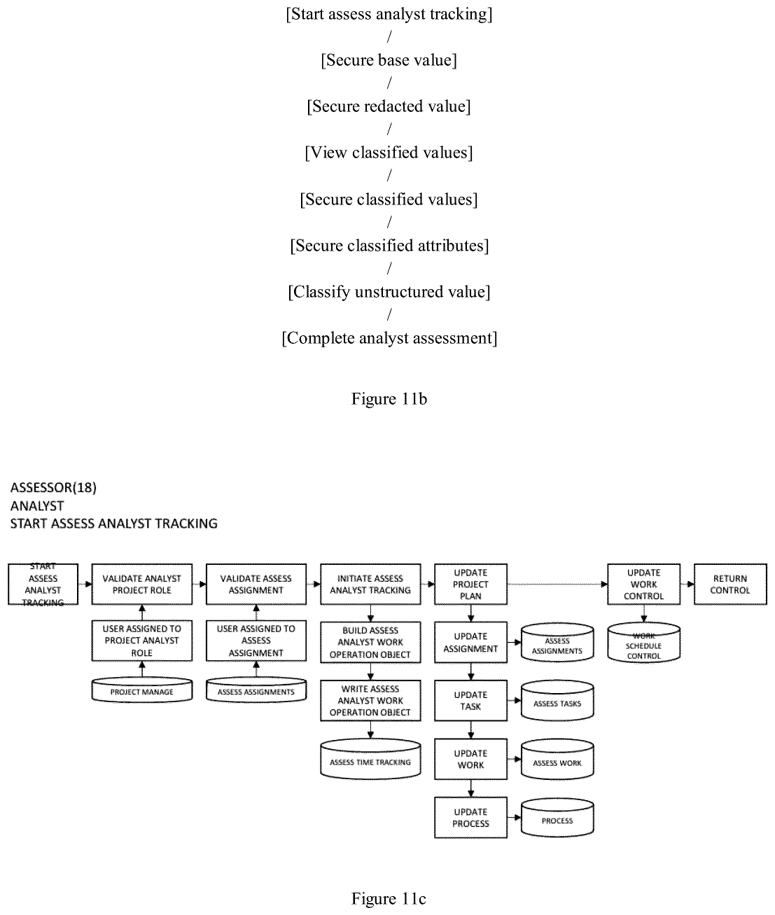

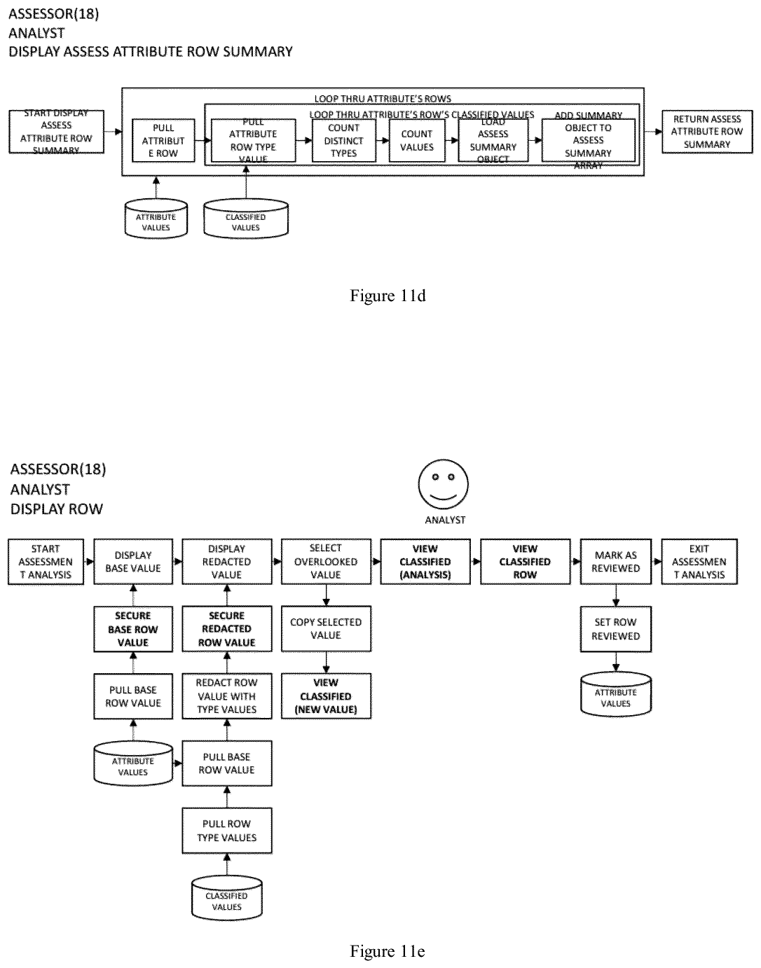

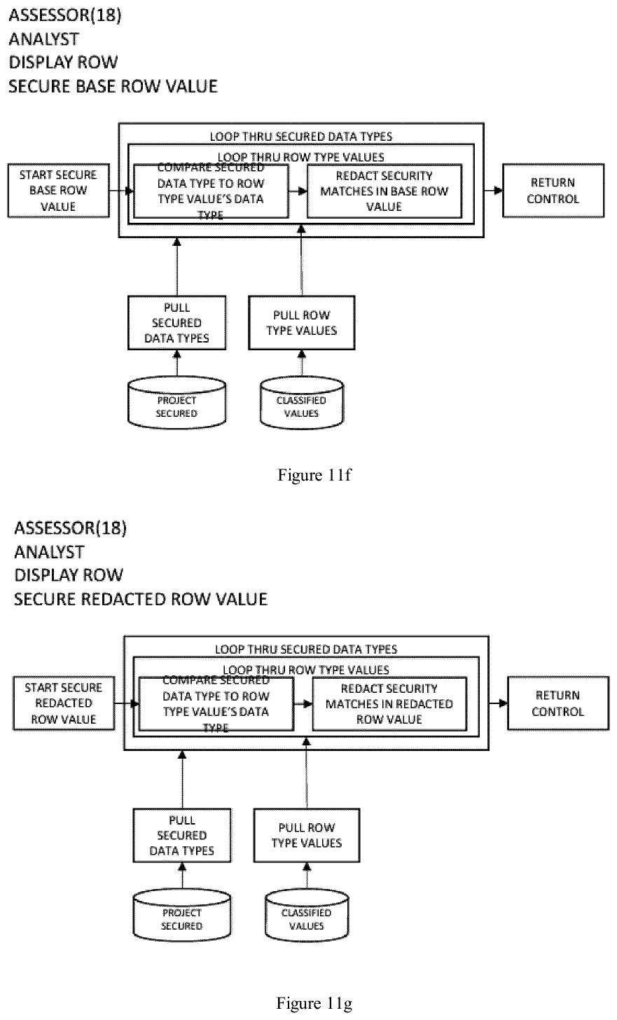

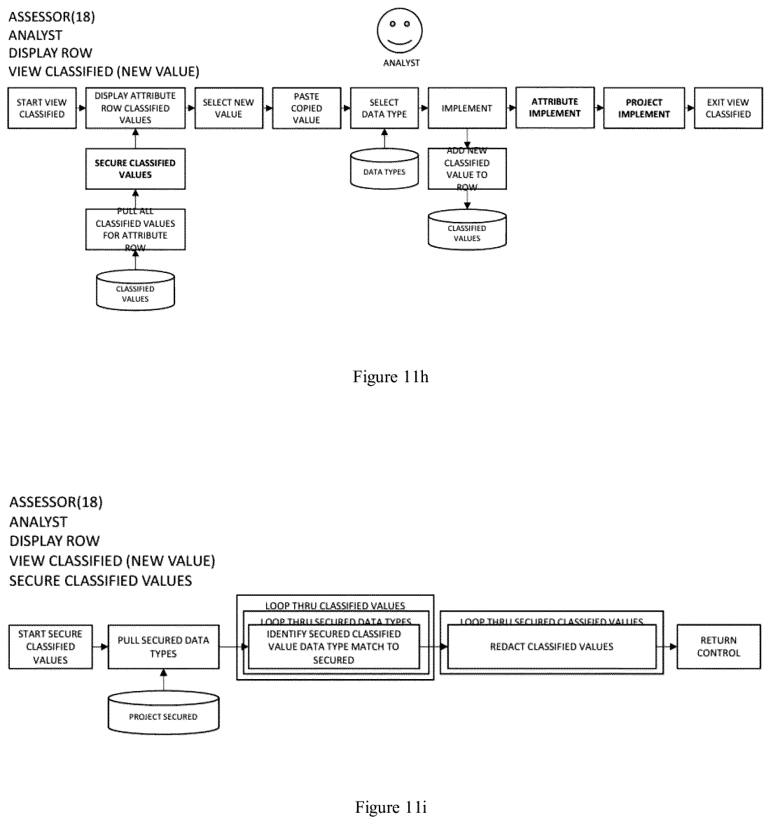

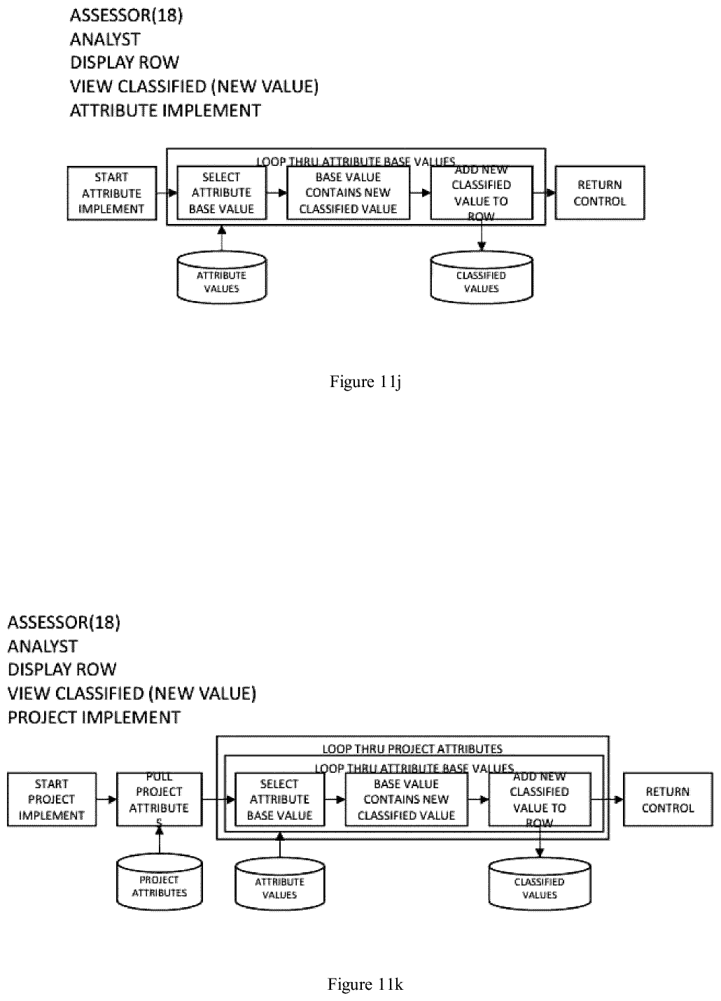

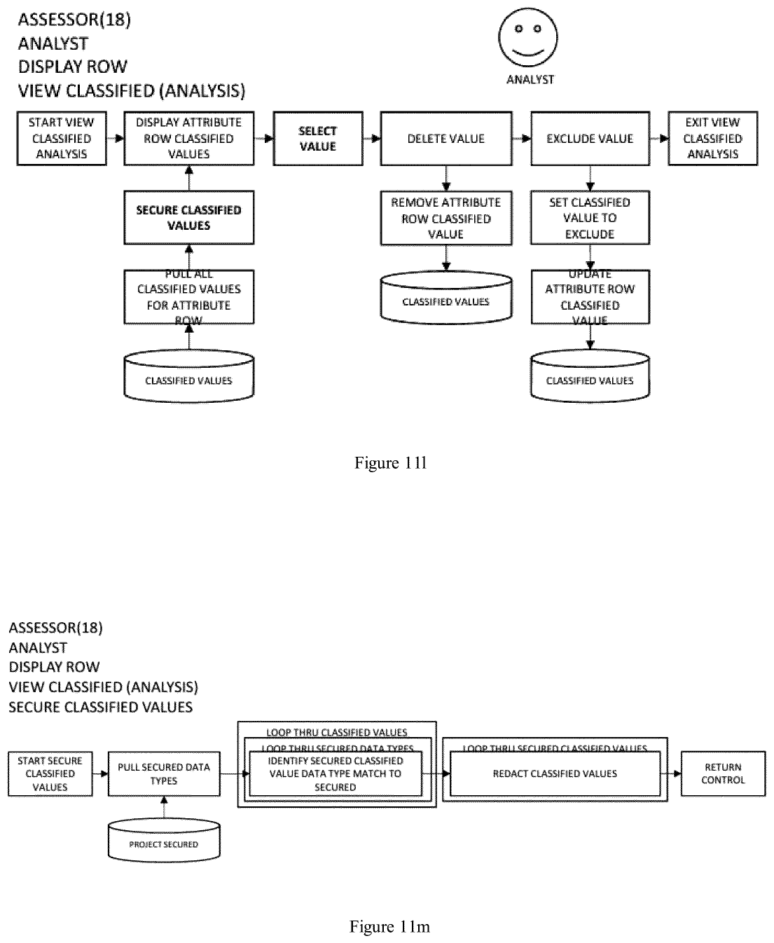

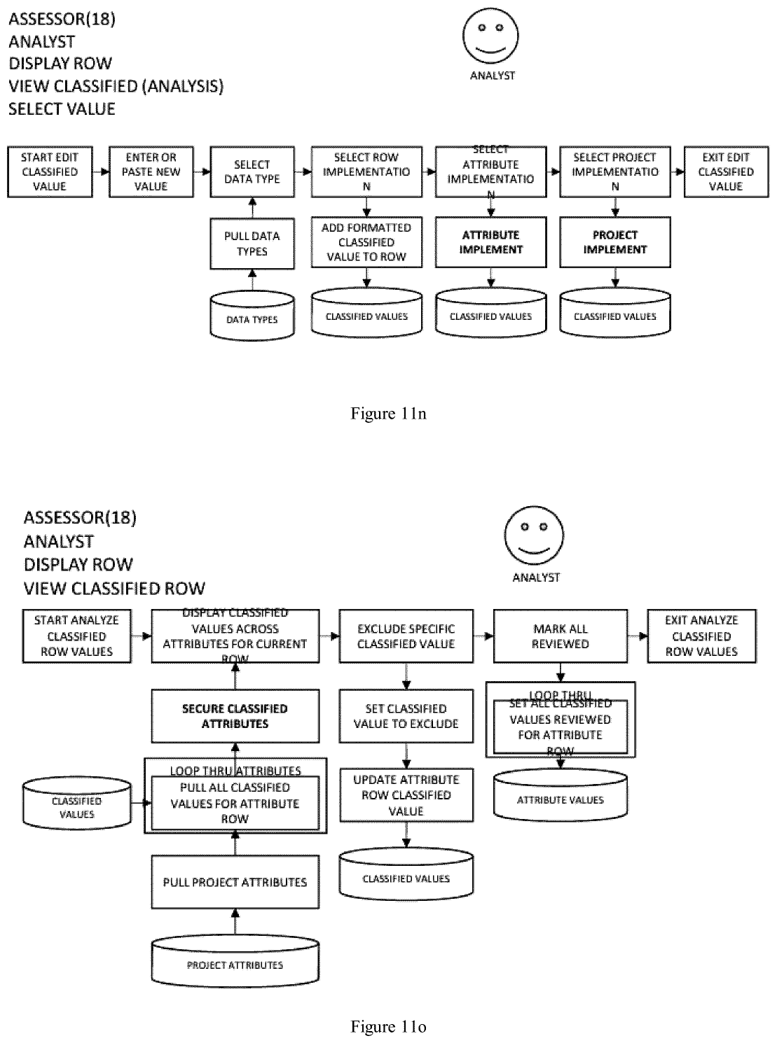

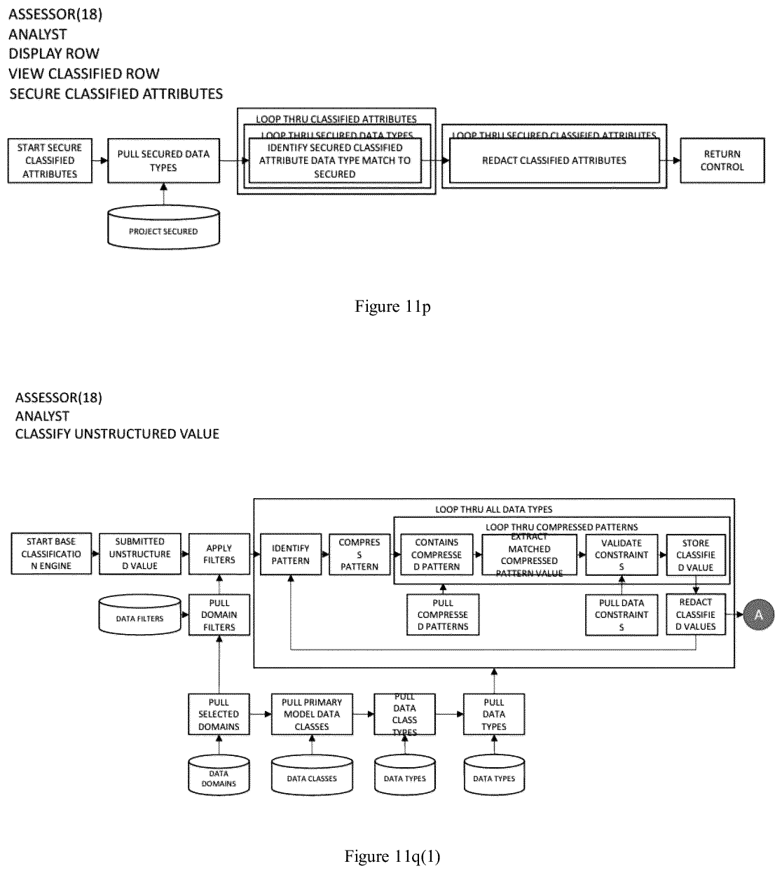

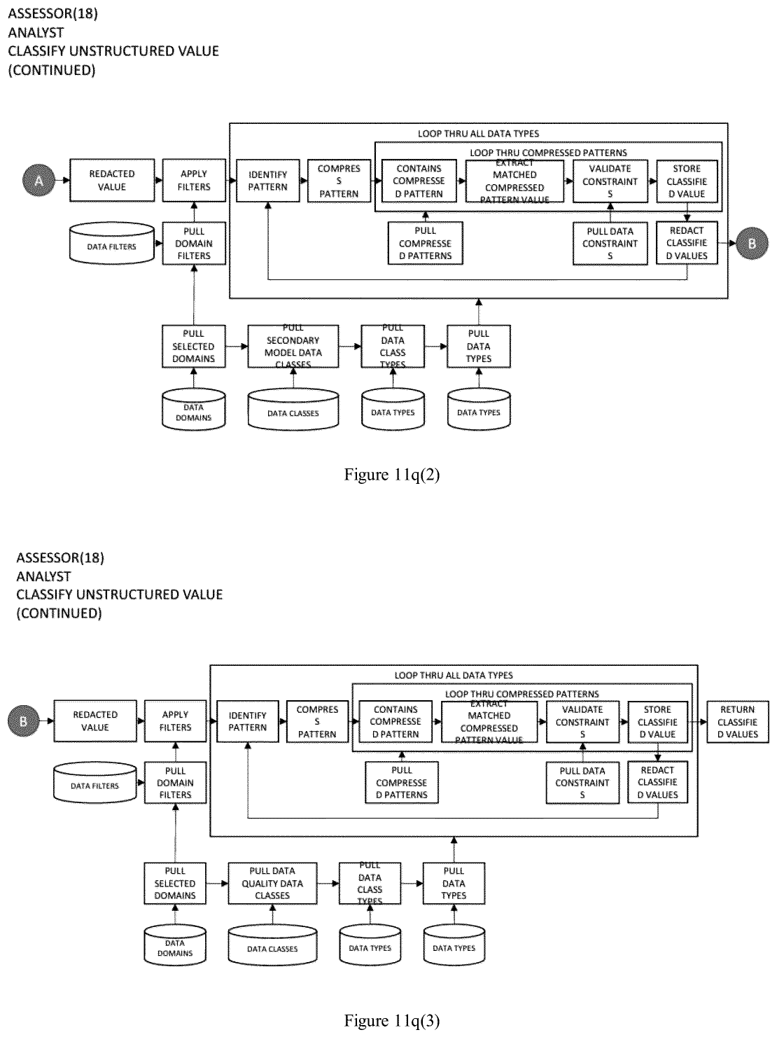

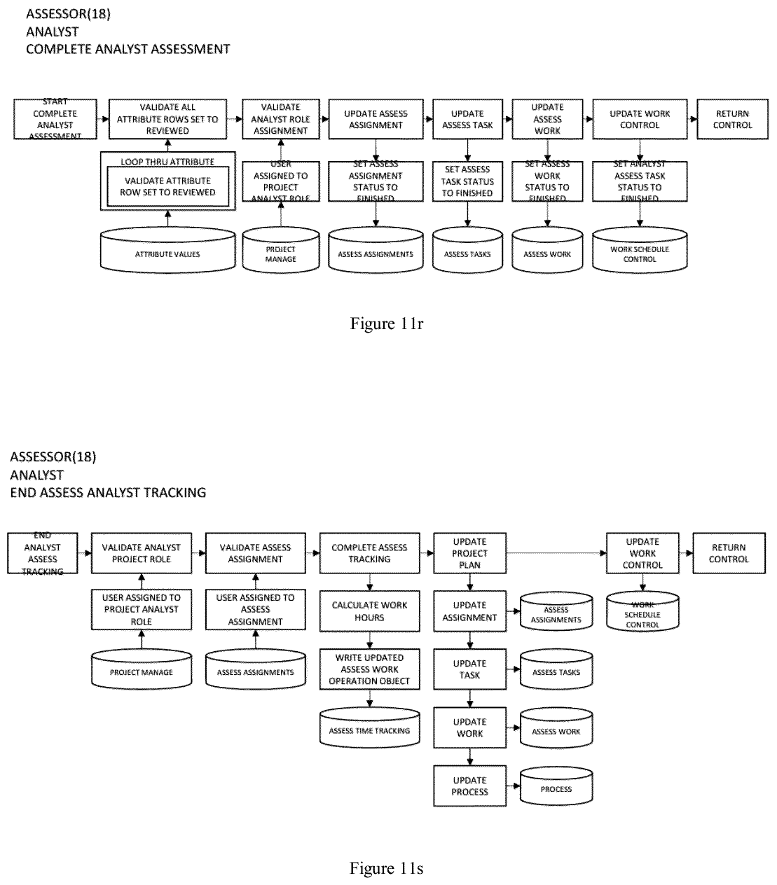

FIG. 11a illustrates aspects of a data quality assessment step, in accordance with one embodiment.

FIG. 11b illustrates a high level process flow for data quality assessment, in accordance with one embodiment.

FIG. 11c illustrates starting analyst tracking, in accordance with one embodiment.

FIG. 11d illustrates creating assessments, in accordance with one embodiment.

FIG. 11e illustrates reviewing unstructured attribute values, in accordance with one embodiment.

FIG. 11f illustrates securing base row values, in accordance with one embodiment.

FIG. 11g illustrates securing redacted row values, in accordance with one embodiment.

FIG. 11h illustrates classifying a new value, in accordance with one embodiment.

FIG. 11i illustrates securing classified values, in accordance with one embodiment.

FIG. 11j illustrates implementing a new classified value, in accordance with one embodiment.

FIG. 11k illustrates implementing a new classified value, in accordance with one embodiment.

FIG. 11l illustrates reviewing classified values, in accordance with one embodiment.

FIG. 11m illustrates securing classified values, in accordance with one embodiment.

FIG. 11n illustrates classifying and applying an individual value, in accordance with one embodiment.

FIG. 11o illustrates analyzing classified values, in accordance with one embodiment.

FIG. 11p illustrates securing classified attributes, in accordance with one embodiment.

FIG. 11q(1) illustrates classifying values within an unstructured value, in accordance with one embodiment.

FIG. 11q(2) illustrates classifying values within an unstructured value, in accordance with one embodiment.

FIG. 11q(3) illustrates classifying values within an unstructured value, in accordance with one embodiment.

FIG. 11r illustrates completing analyst assessment, in accordance with one embodiment.

FIG. 11s illustrates ending analyst tracking, in accordance with one embodiment.

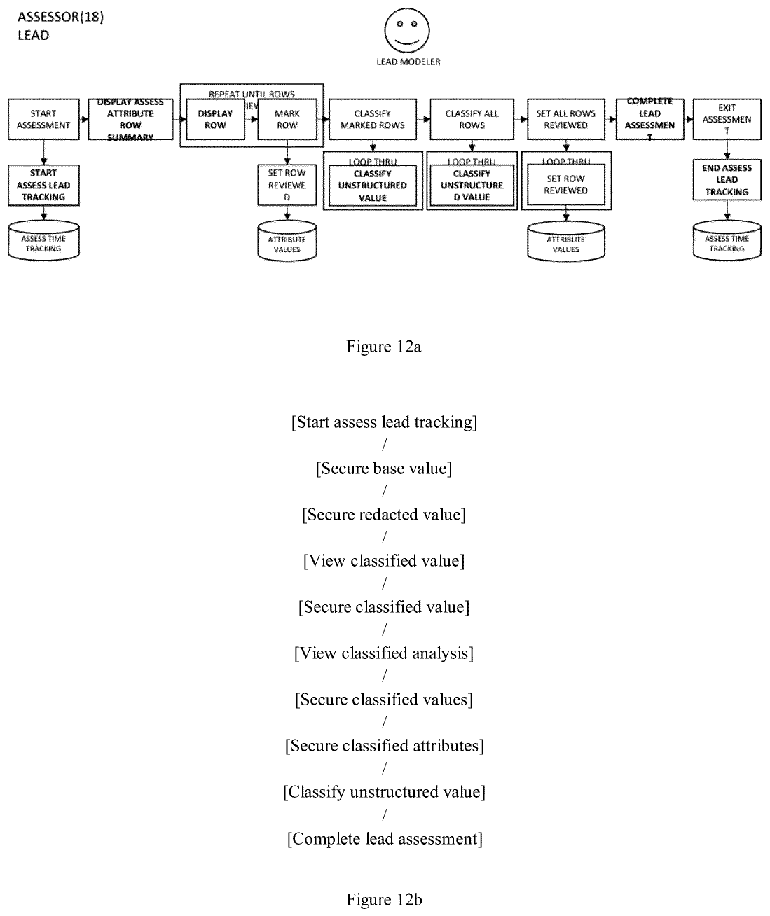

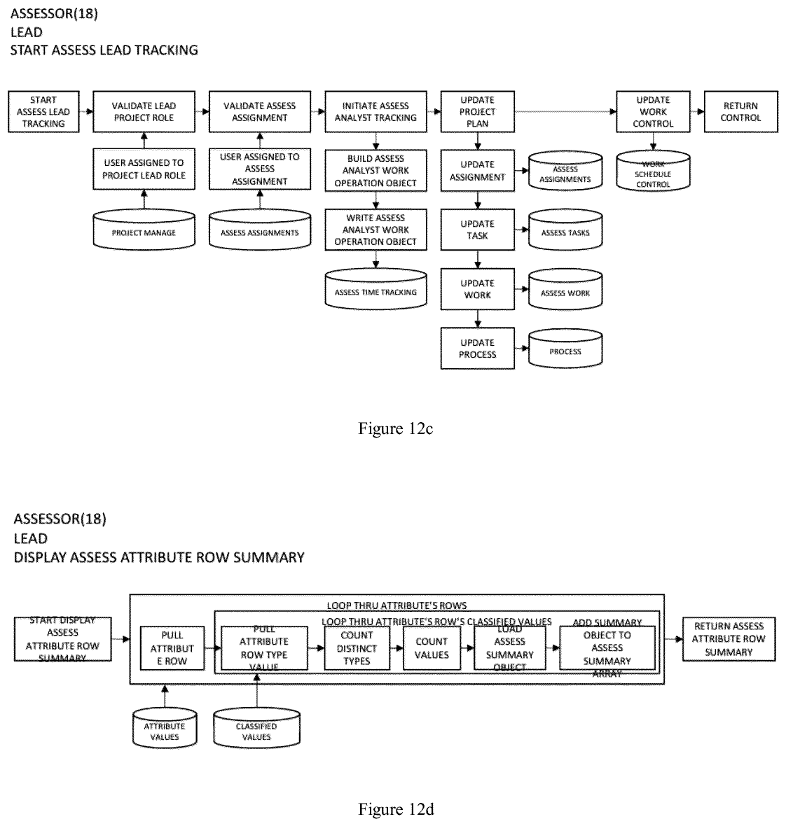

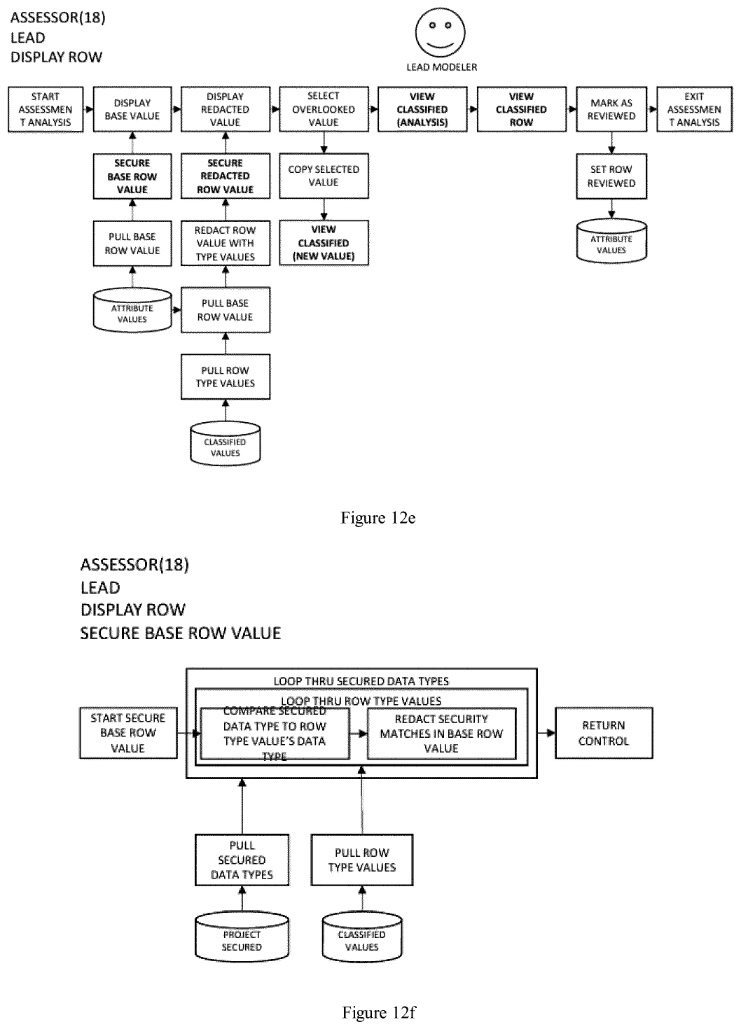

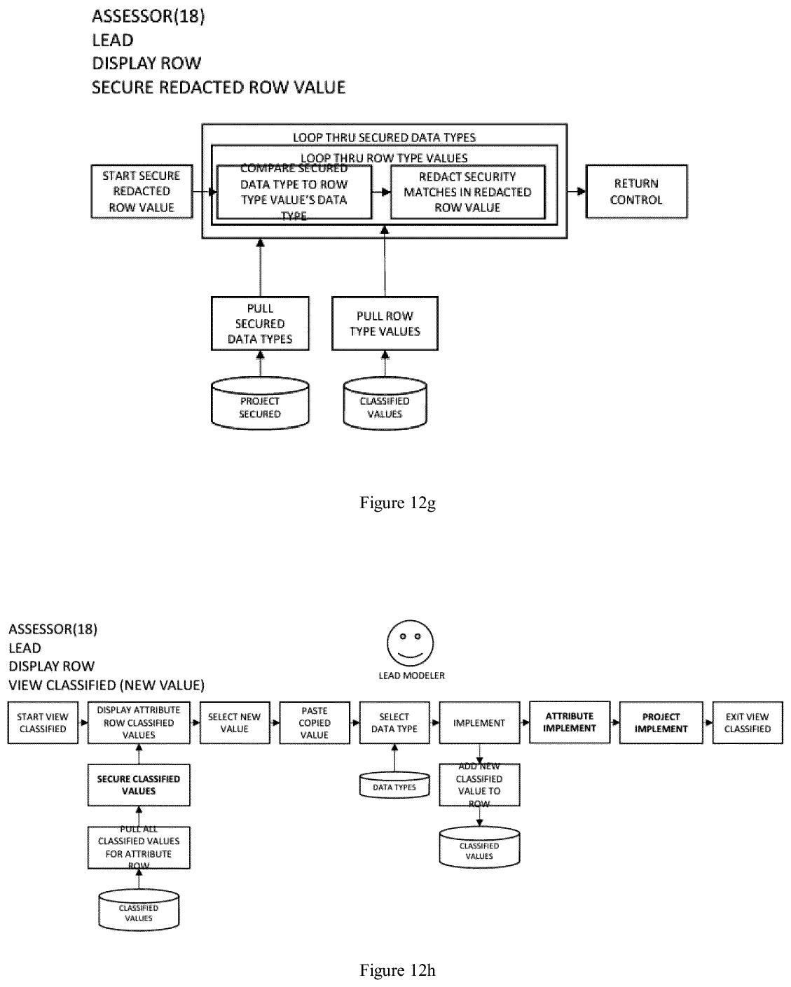

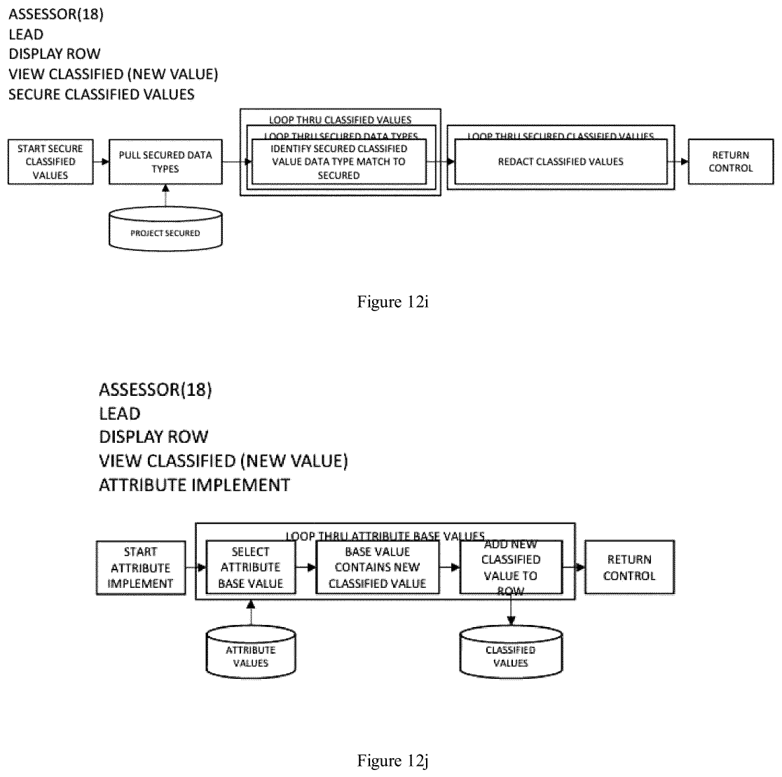

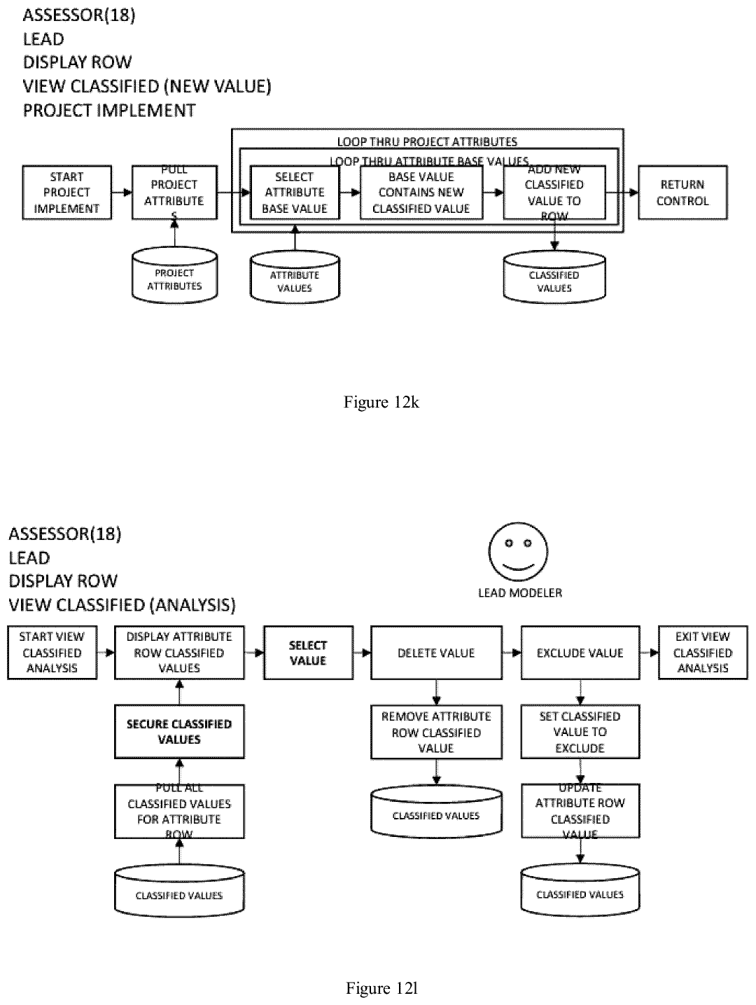

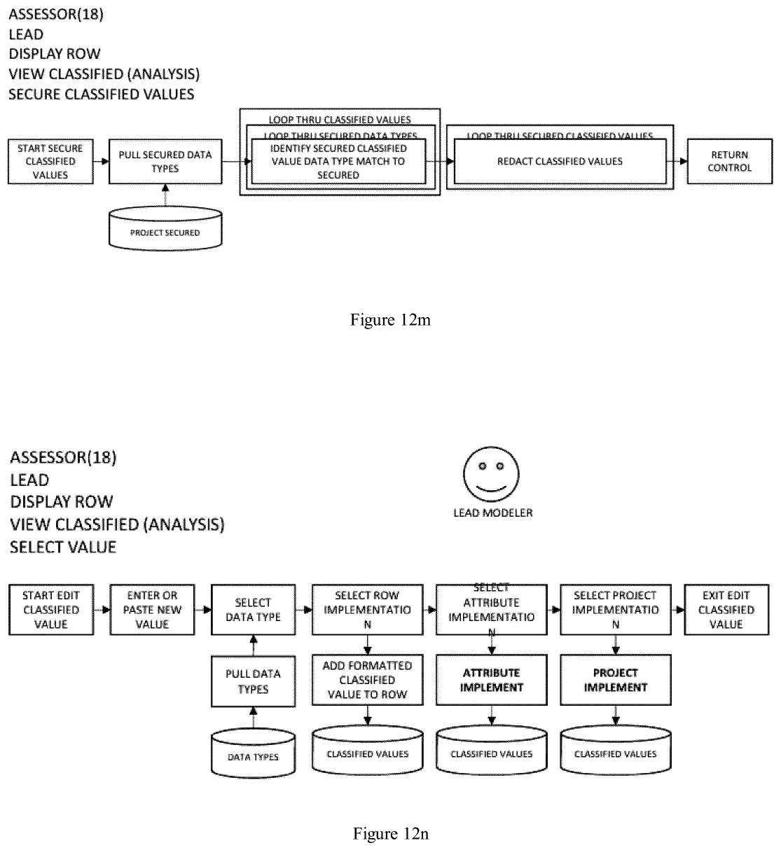

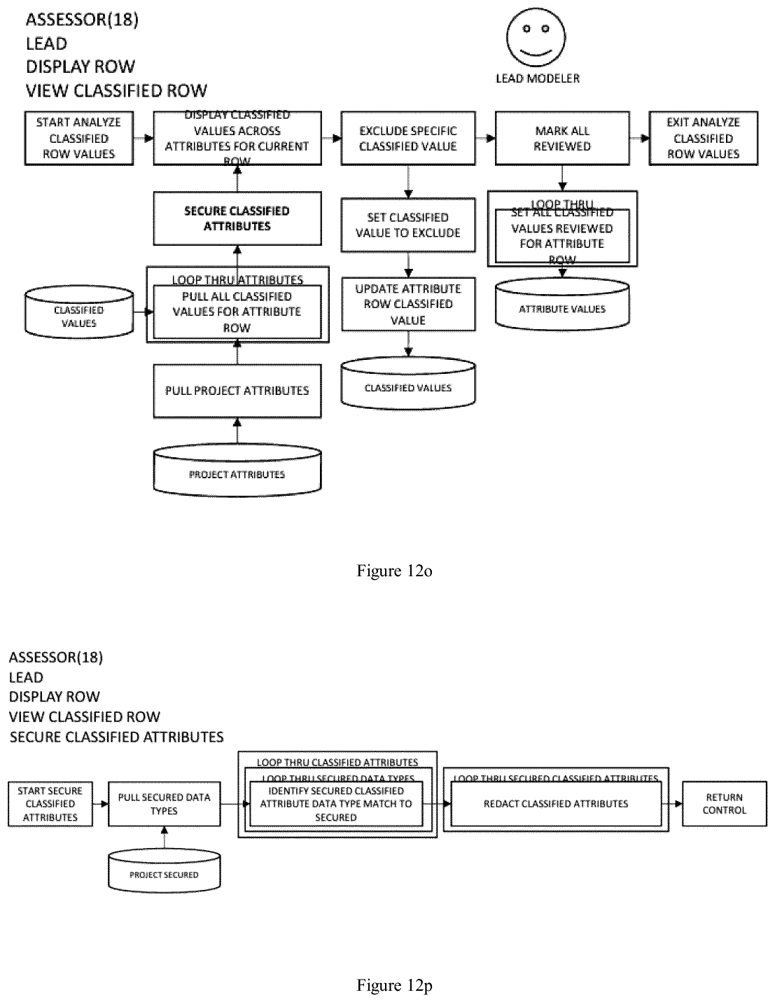

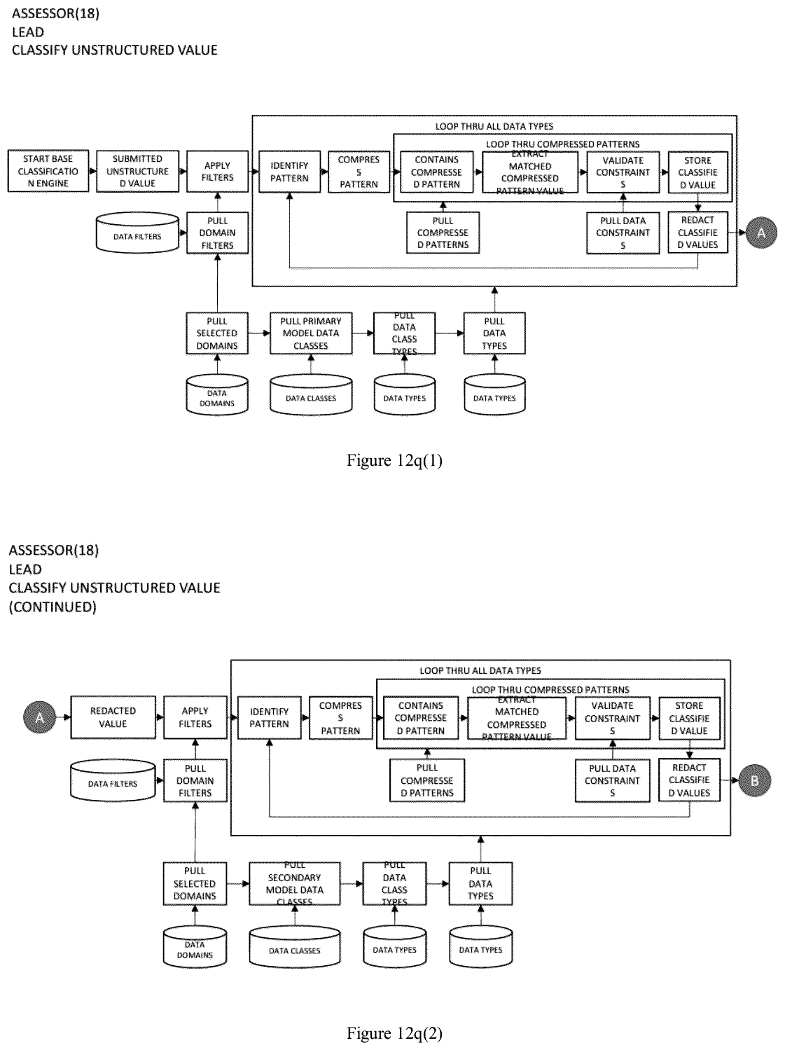

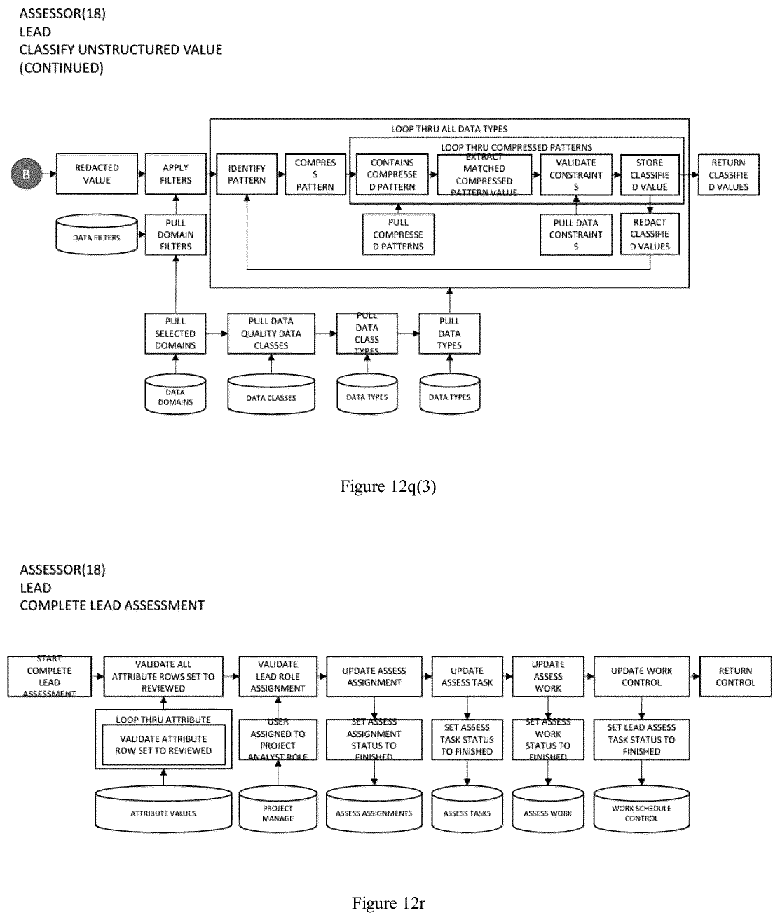

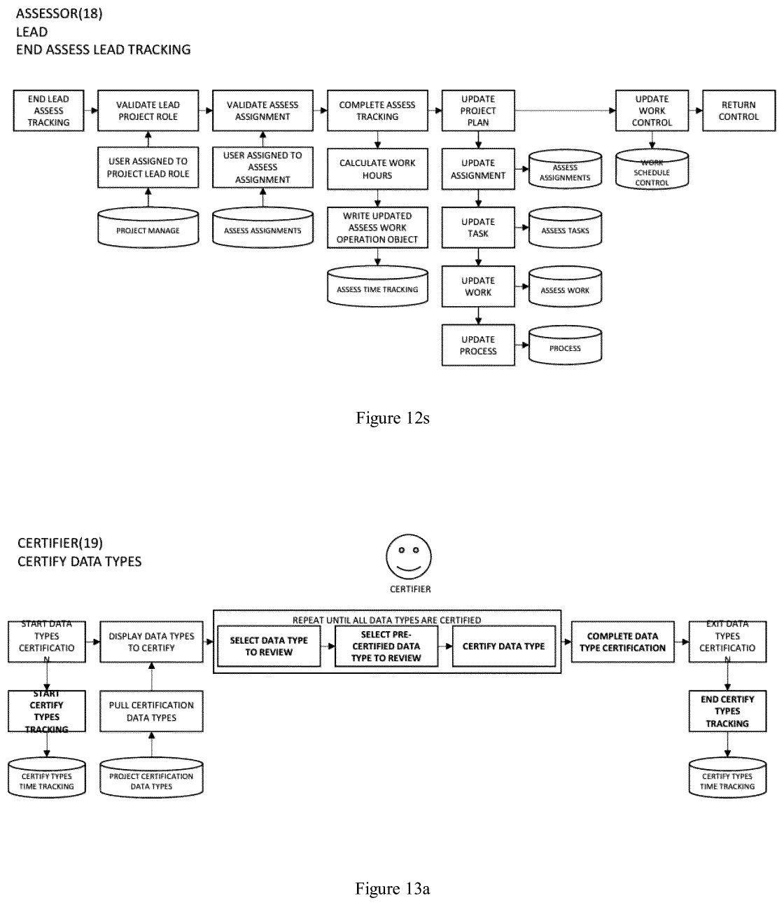

FIG. 12a illustrates aspects of the data quality assessment step, in accordance with one embodiment.

FIG. 12b illustrates a high level process flow for data quality assessment by a data quality lead, in accordance with one embodiment.

FIG. 12c illustrates starting lead tracking, in accordance with one embodiment.

FIG. 12d illustrates creating assessments attribute summary information, in accordance with one embodiment.

FIG. 12e illustrates reviewing unstructured attribute value, in accordance with one embodiment.

FIG. 12f illustrates securing base value, in accordance with one embodiment.

FIG. 12g illustrates securing redacted value, in accordance with one embodiment.

FIG. 12h illustrates classifying a new value, in accordance with one embodiment.

FIG. 12i illustrates securing classified values, in accordance with one embodiment.

FIG. 12j illustrates implementing a new classified value, in accordance with one embodiment.

FIG. 12k illustrates implementing a new classified value, in accordance with one embodiment.

FIG. 12l illustrates reviewing classified values, in accordance with one embodiment.

FIG. 12m illustrates securing classified values, in accordance with one embodiment.

FIG. 12n illustrates applying a classified value, in accordance with one embodiment.

FIG. 12o illustrates analyzing classified values, in accordance with one embodiment.

FIG. 12p illustrates securing classified attributes, in accordance with one embodiment.

FIG. 12q(1), illustrates classifying values within an unstructured value, in accordance with one embodiment.

FIG. 12q(2), illustrates classifying values within an unstructured value, in accordance with one embodiment.

FIG. 12q(3), illustrates classifying values within an unstructured value, in accordance with one embodiment.

FIG. 12r illustrates completing lead assessment, in accordance with one embodiment.

FIG. 12s illustrates ending analyst tracking, in accordance with one embodiment.

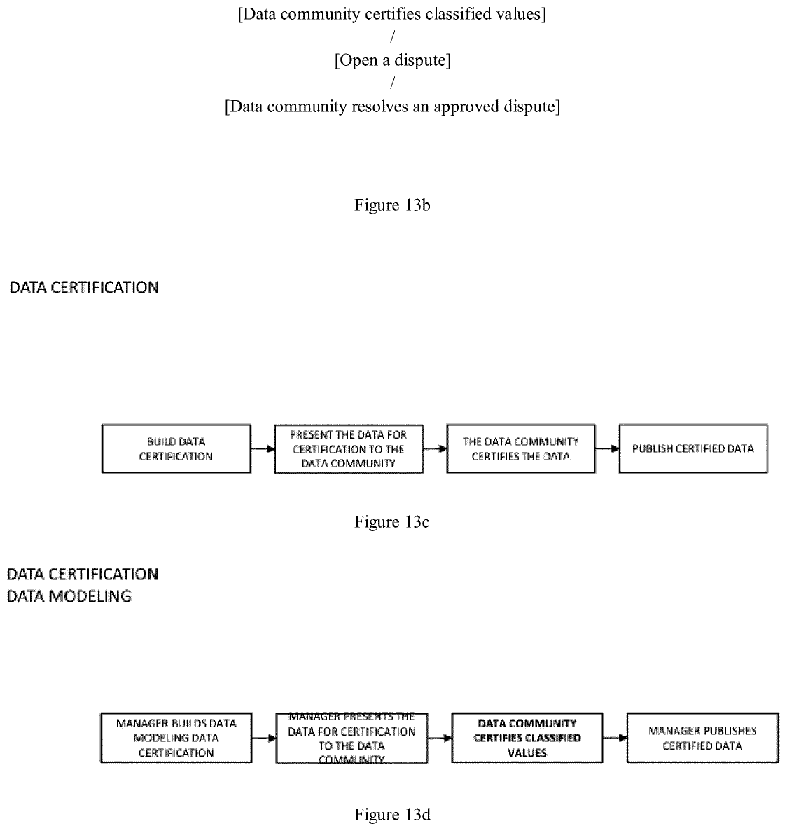

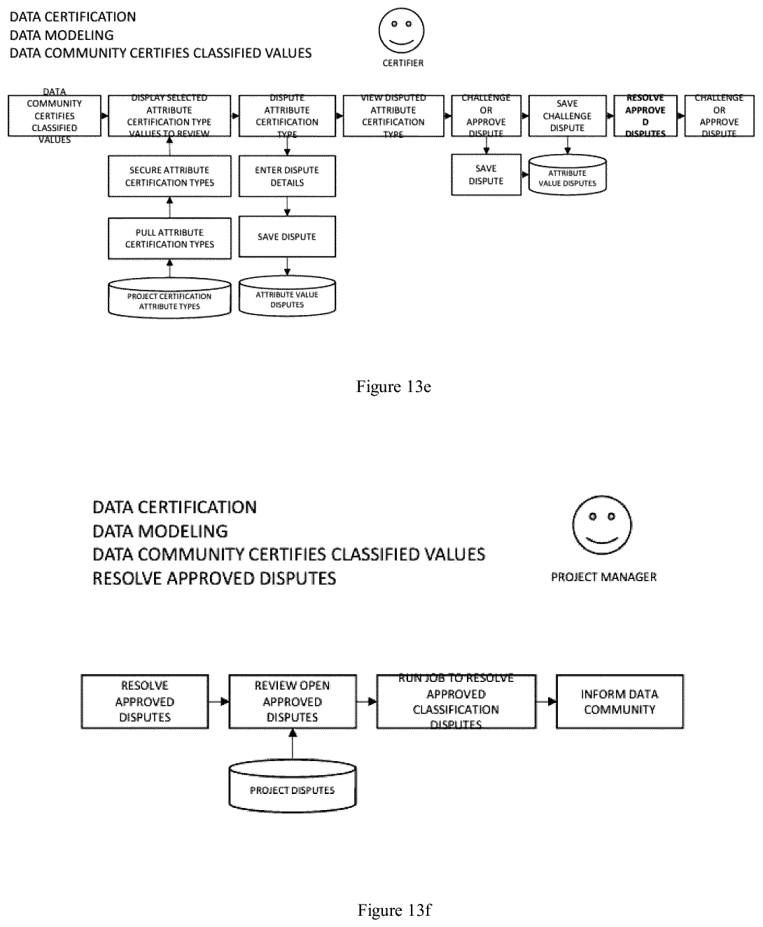

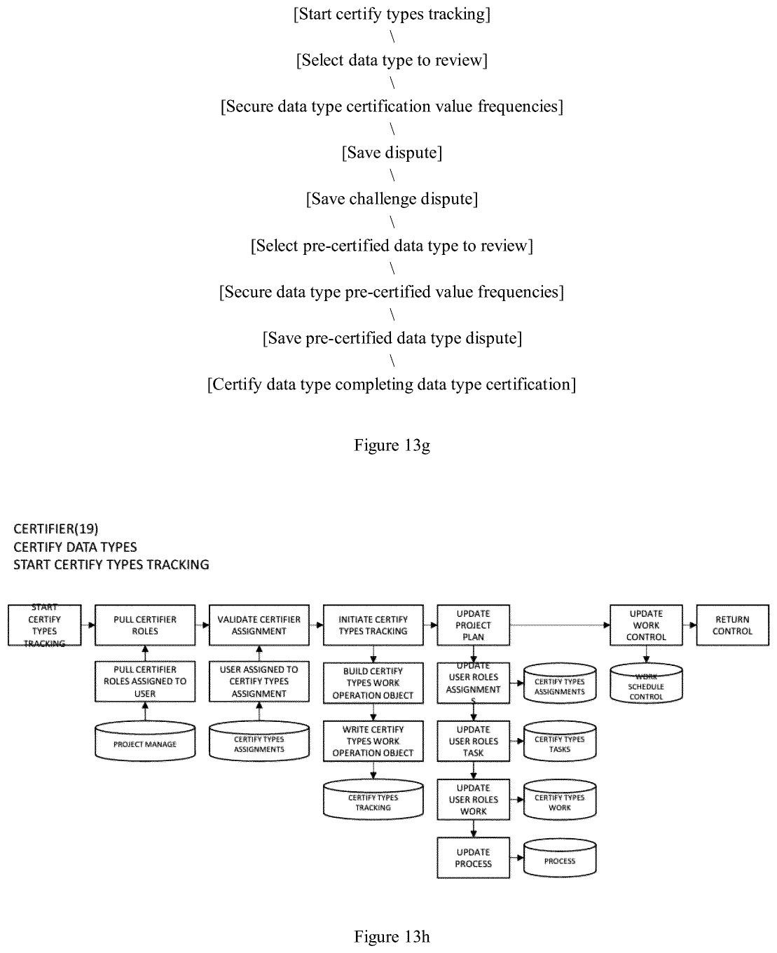

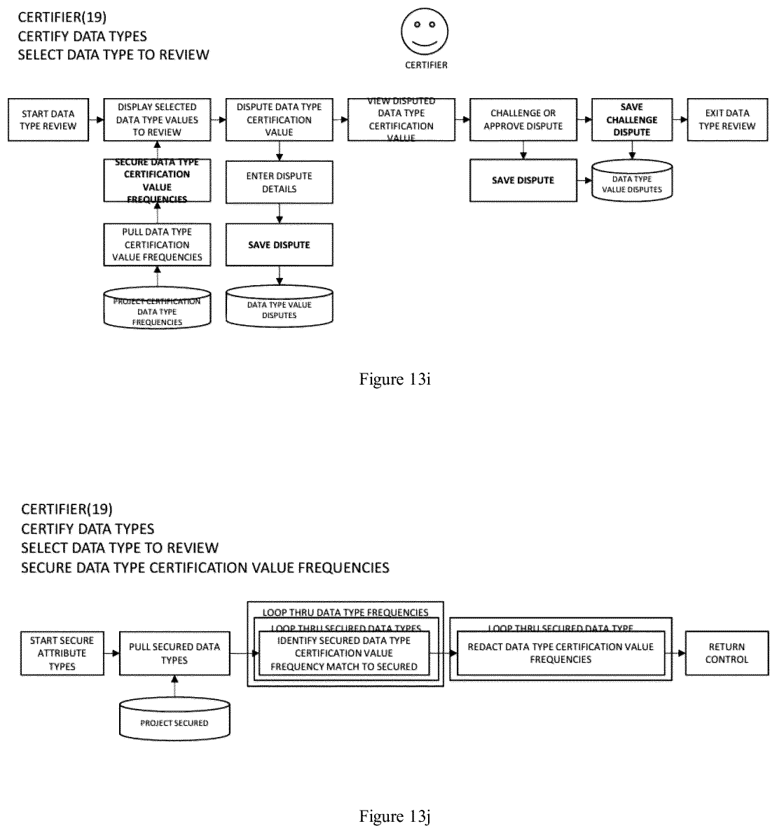

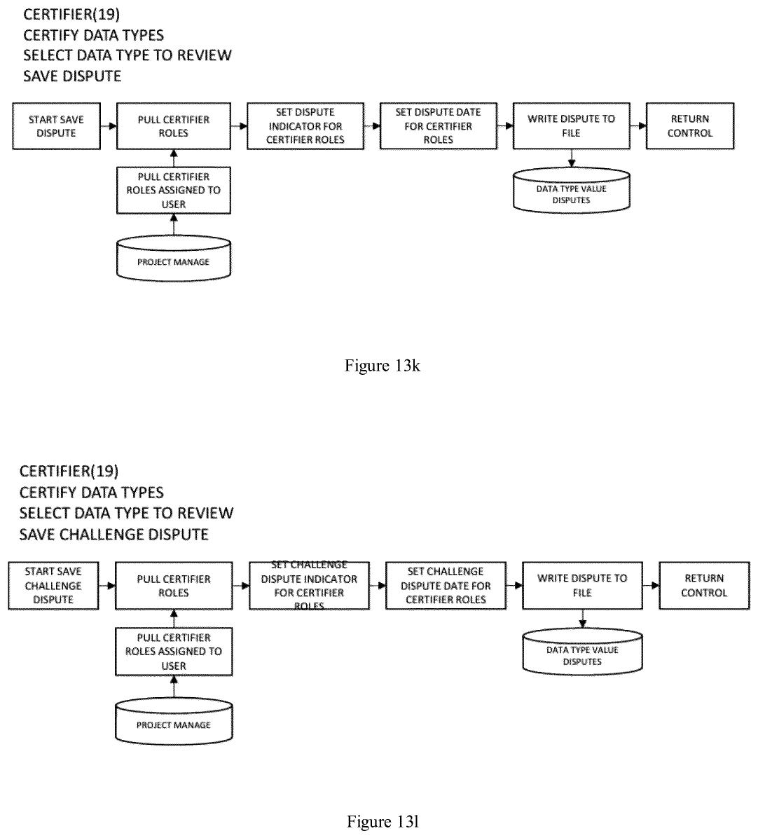

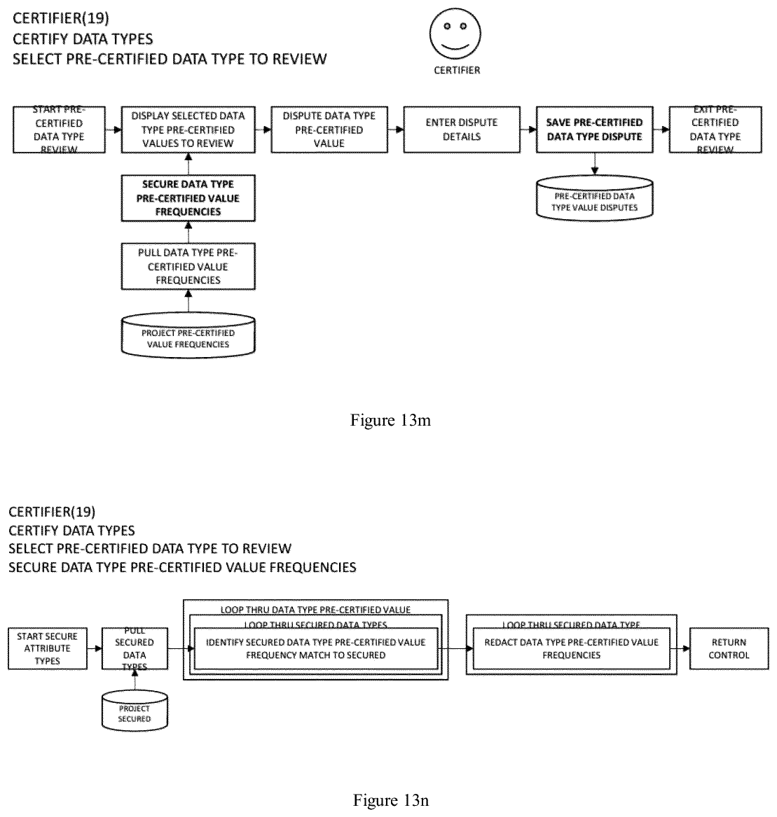

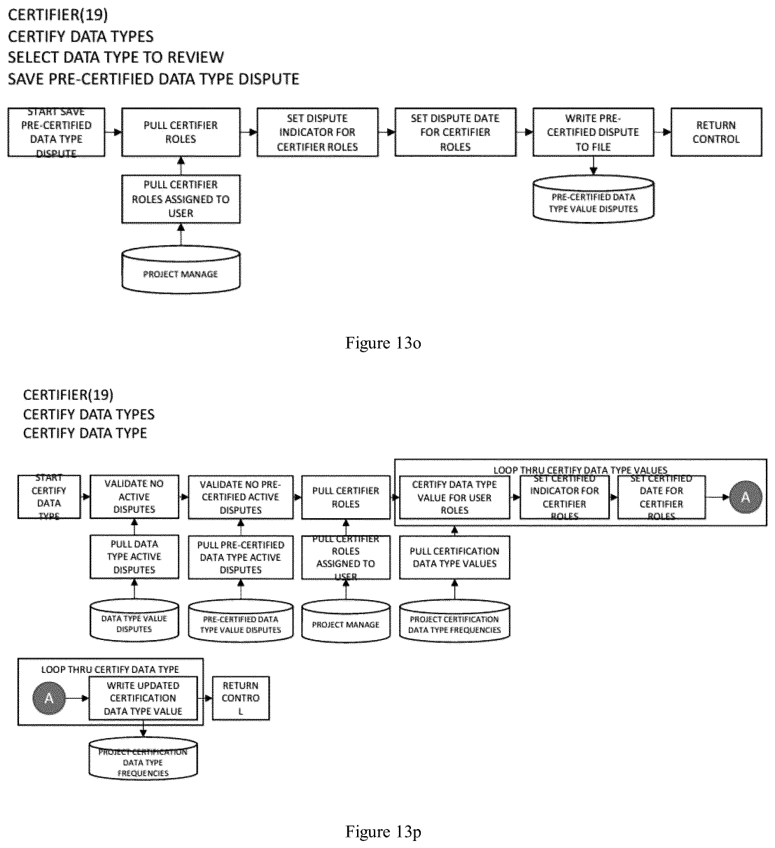

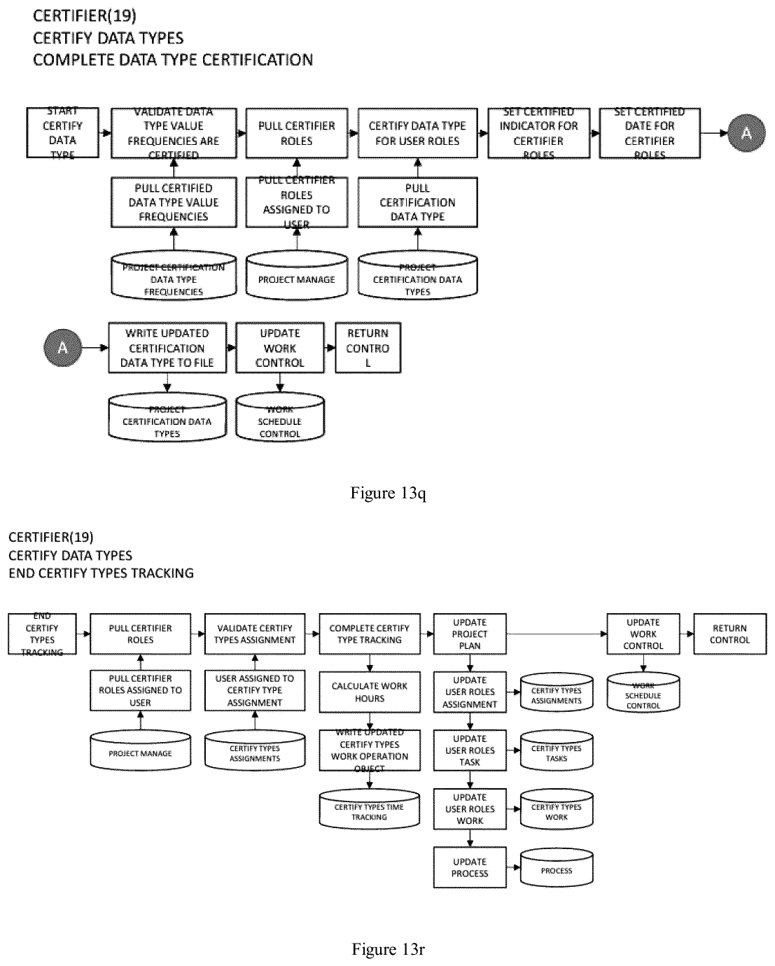

FIG. 13a illustrates aspects of certifying data types, in accordance with one embodiment.

FIG. 13b illustrates a high level process of certifying data, in accordance with one embodiment.

FIG. 13c illustrates aspects of data certification, in accordance with one embodiment.

FIG. 13d illustrates publishing certified results for data modeling, in accordance with one embodiment.

FIG. 13e illustrates certifying classified values, in accordance with one embodiment.

FIG. 13f illustrates resolving approved disputes, in accordance with one embodiment.

FIG. 13g illustrates a high level process flow for data type certification, in accordance with one embodiment.

FIG. 13h illustrates starting certifying tracking, in accordance with one embodiment.

FIG. 13i illustrates selecting data types to review, in accordance with one embodiment.

FIG. 13j illustrates securing data types values, in accordance with one embodiment.

FIG. 13k illustrates saving a dispute, in accordance with one embodiment.

FIG. 13l illustrates saving a dispute challenge, in accordance with one embodiment.

FIG. 13m illustrates the certification process for pre-certified values, in accordance with one embodiment.

FIG. 13n illustrates securing data types, in accordance with one embodiment.

FIG. 13o illustrates saving a dispute for a pre-certified value, in accordance with one embodiment.

FIG. 13p illustrates aspects of certifying a data type, in accordance with one embodiment.

FIG. 13q illustrates completing data type certification, in accordance with one embodiment.

FIG. 13r illustrates ending certifying of data types, in accordance with one embodiment.

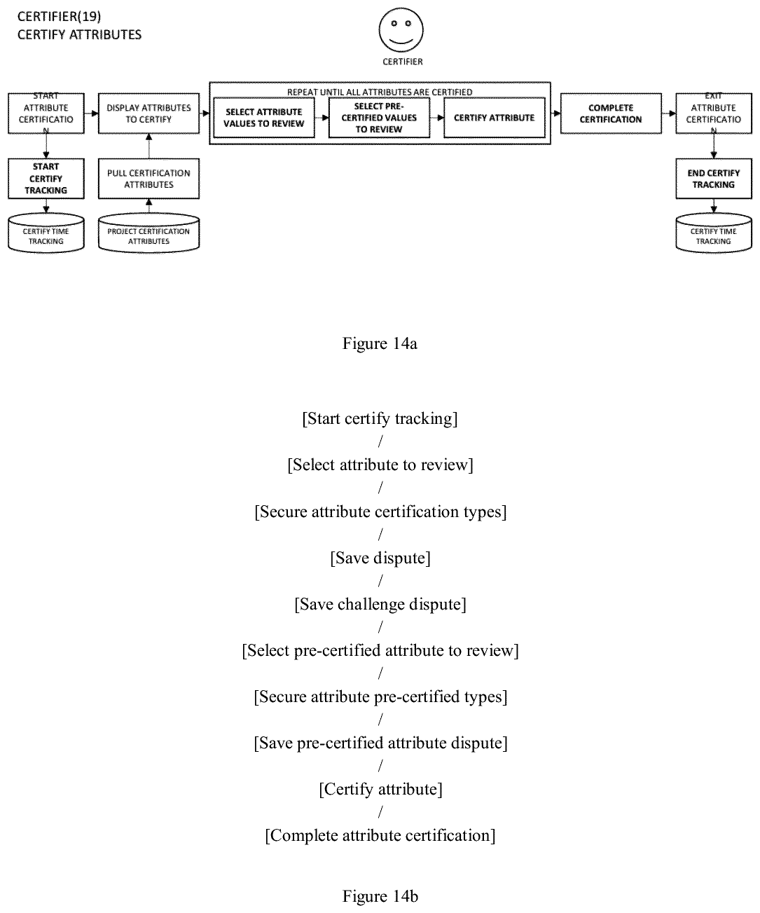

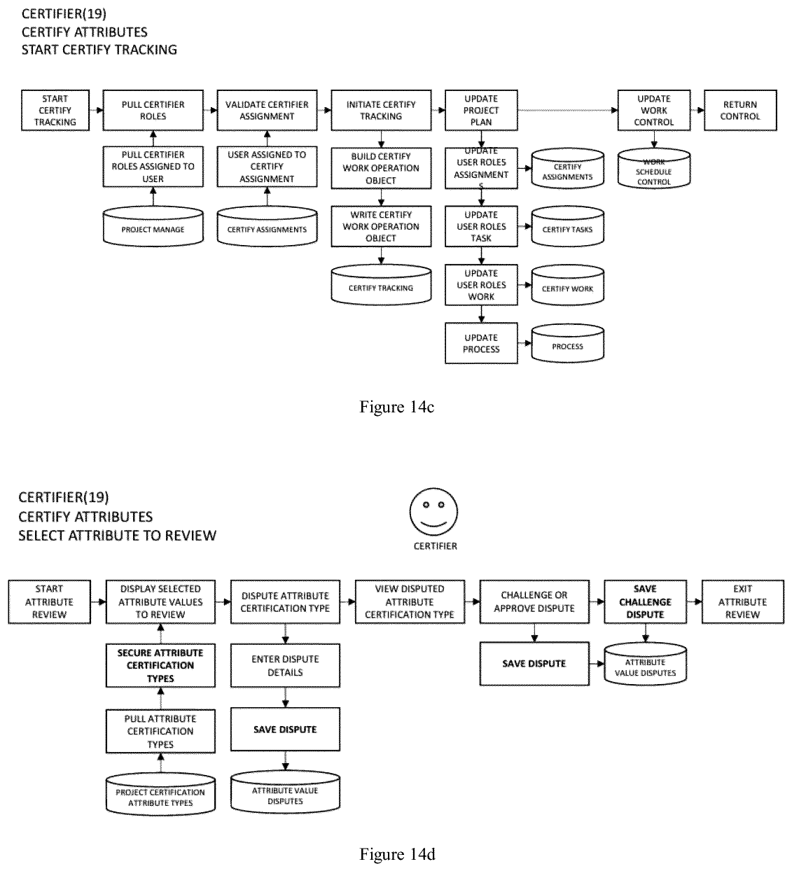

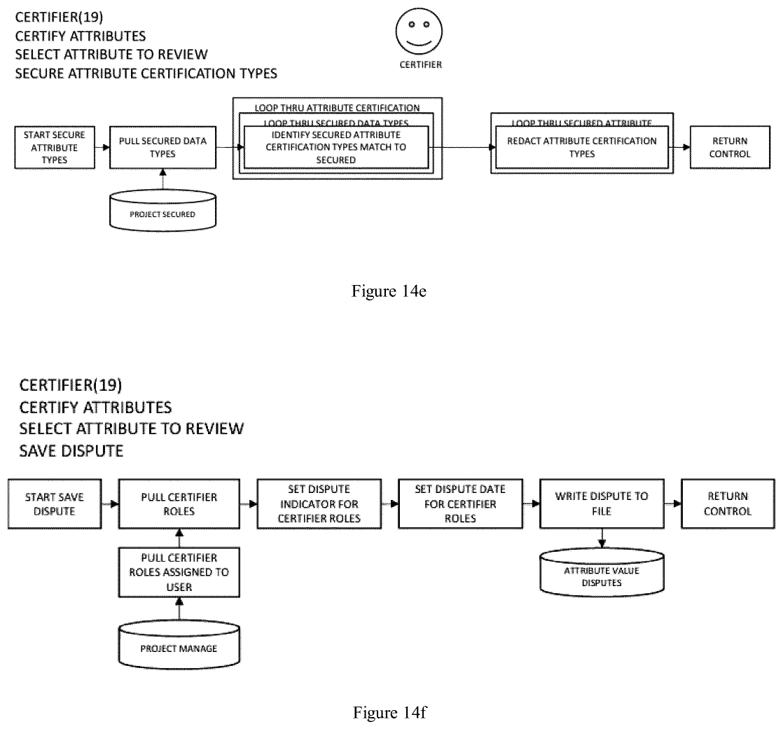

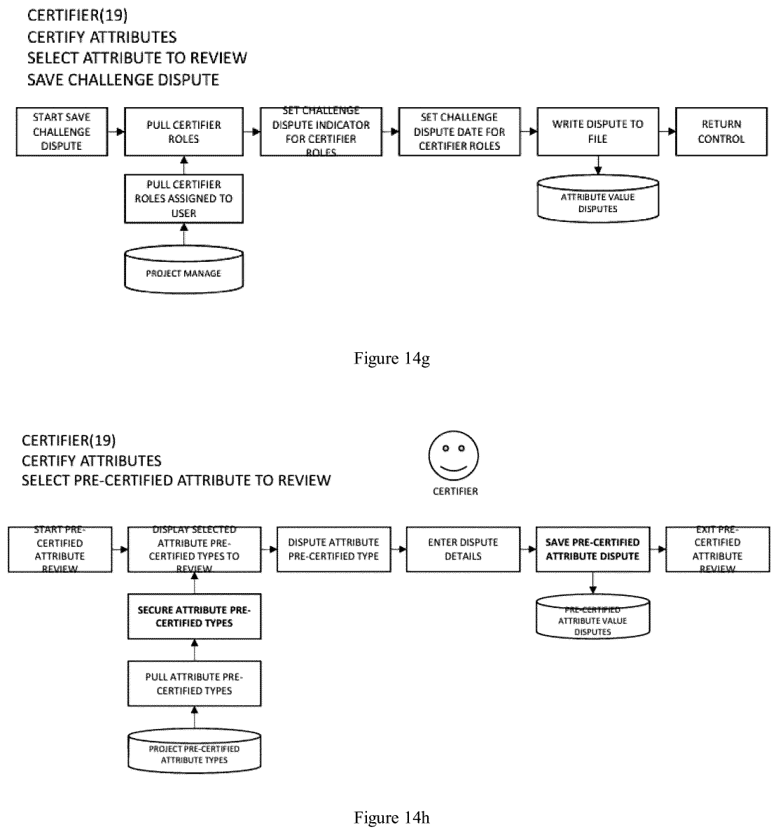

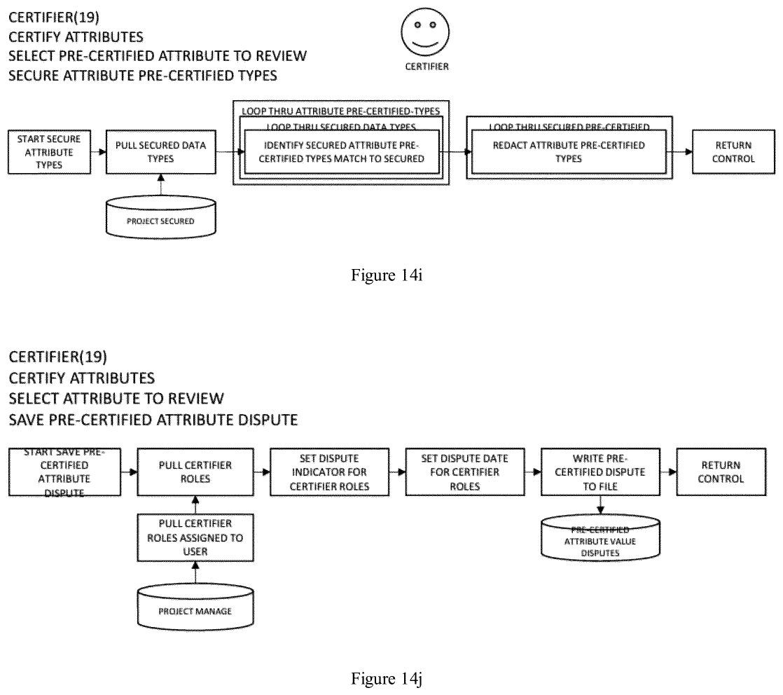

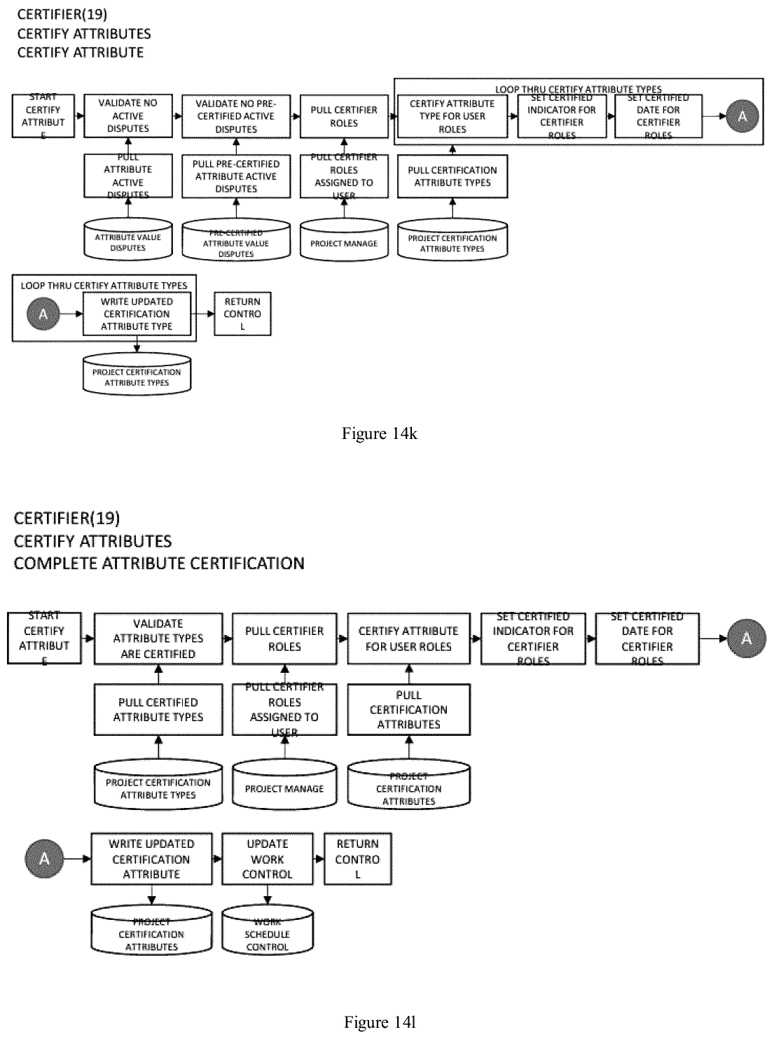

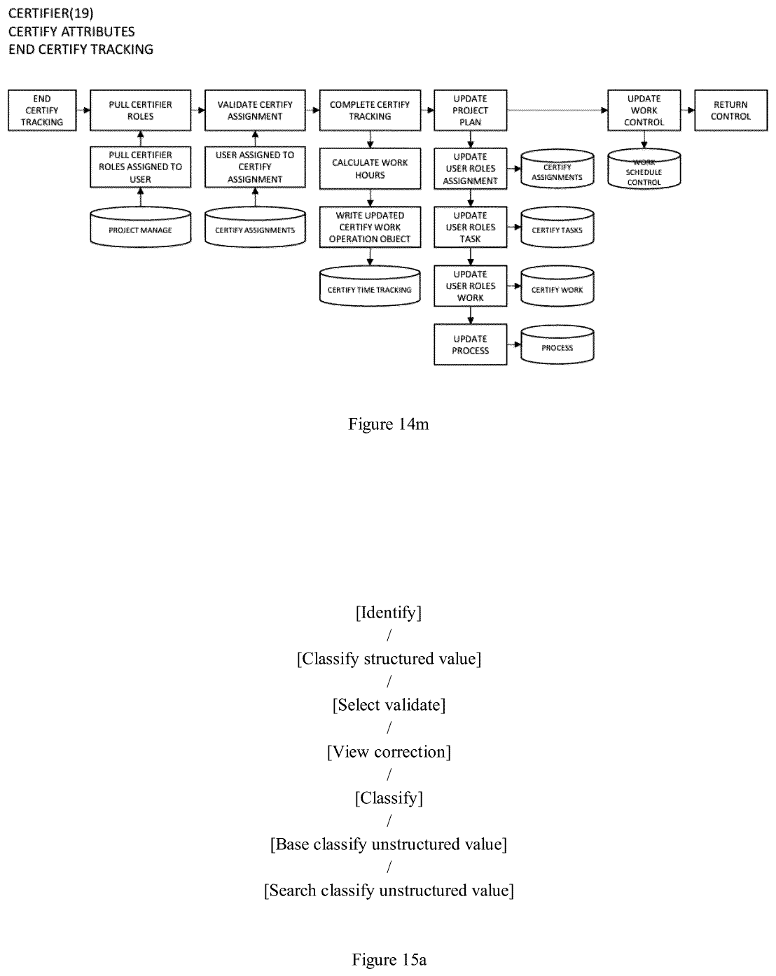

FIG. 14a illustrates aspects of certifying attributes, in accordance with one embodiment.

FIG. 14b illustrates a high level process flow for attribute certification, in accordance with one embodiment.

FIG. 14c illustrates starting certify tracking, in accordance with one embodiment.

FIG. 14d illustrates aspects of certifying attributes, in accordance with one embodiment.

FIG. 14e illustrates aspects of securing attributes, in accordance with one embodiment.

FIG. 14f illustrates saving a dispute, in accordance with one embodiment.

FIG. 14g illustrates saving a dispute challenge, in accordance with one embodiment.

FIG. 14h illustrates reviewing pre-certified values, in accordance with one embodiment.

FIG. 14i illustrates securing data types values, in accordance with one embodiment.

FIG. 14j illustrates saving disputes for pre-certified attribute values, in accordance with one embodiment.

FIG. 14k illustrates aspects of certifying an attribute, in accordance with one embodiment.

FIG. 14l illustrates completing attribute certification, in accordance with one embodiment.

FIG. 14m illustrates ending certify tracking, in accordance with one embodiment.

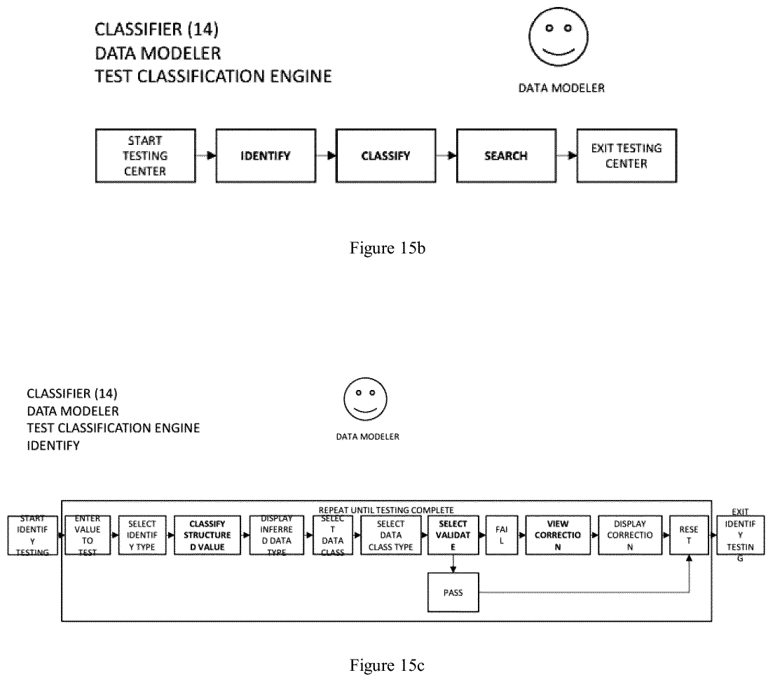

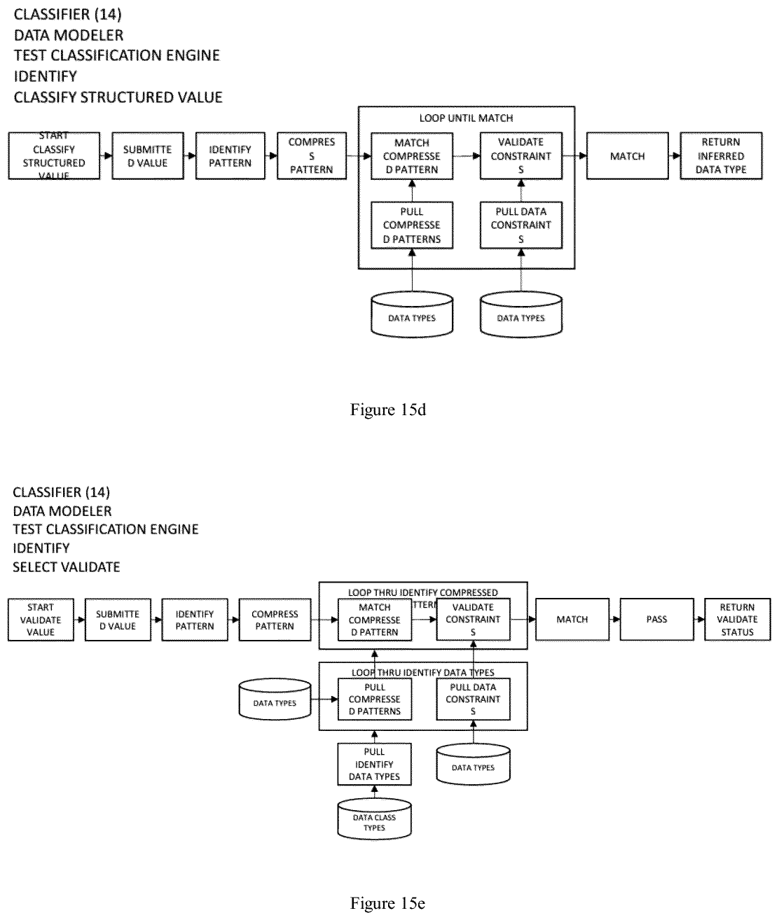

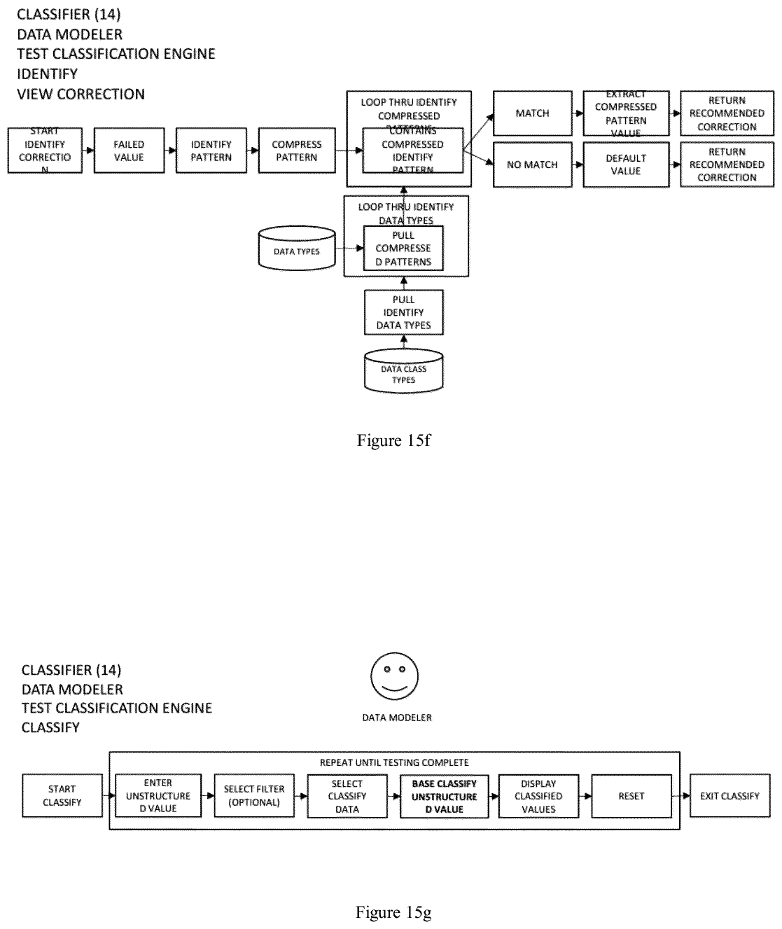

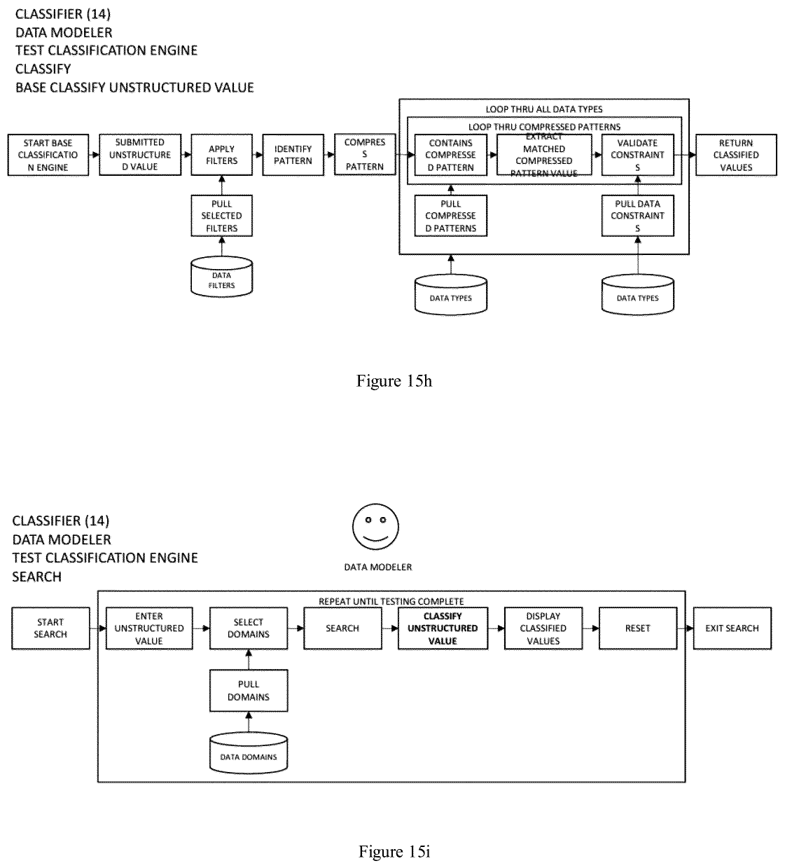

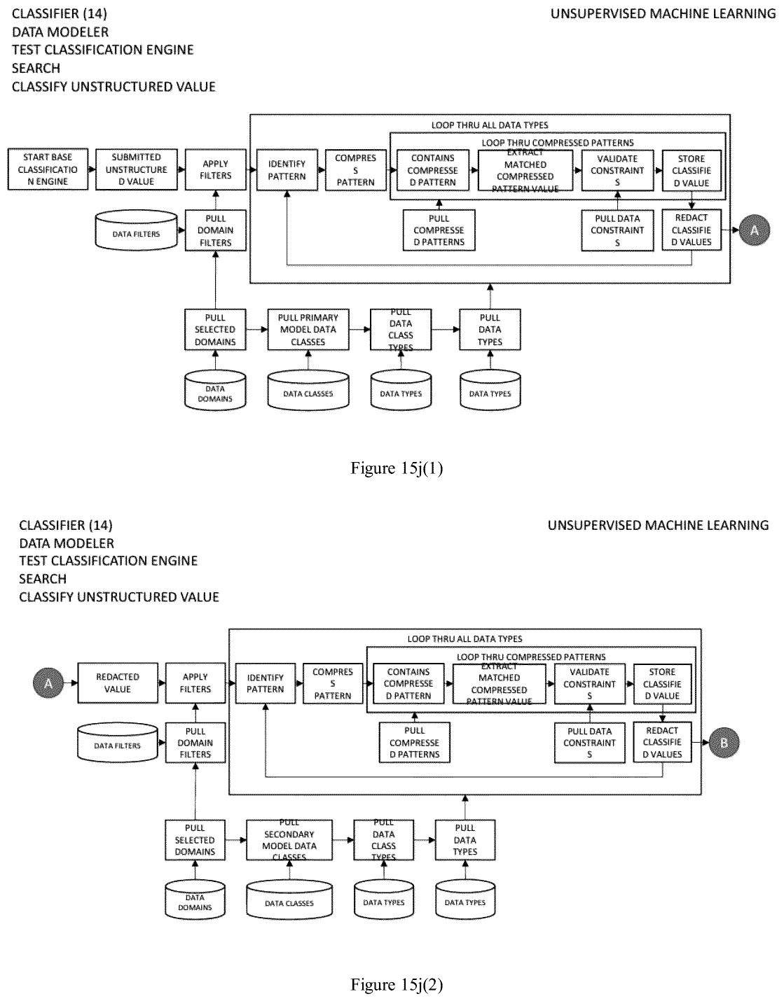

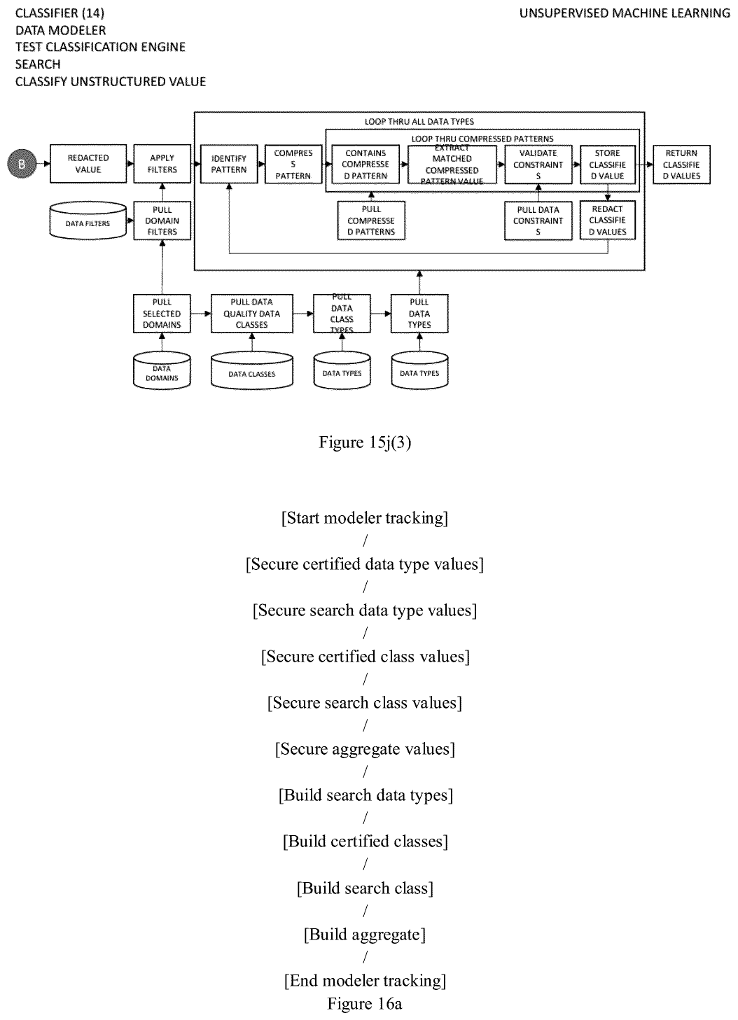

FIG. 15a illustrates a high level process flow of the classification engine, in accordance with one embodiment.

FIG. 15b illustrates an aspect of the classification system, in accordance with one embodiment.

FIG. 15c illustrates a process used to identify types, in accordance with one embodiment.

FIG. 15d illustrates a classifying structured value, in accordance with one embodiment.

FIG. 15e illustrates validating a value, in accordance with one embodiment.

FIG. 15f illustrates identifying a correction, in accordance with one embodiment.

FIG. 15g illustrates testing modeling data types, in accordance with one embodiment.

FIG. 15h illustrates classifying values within an unstructured value, in accordance with one embodiment.

FIG. 15i illustrates testing data domains, in accordance with one embodiment.

FIG. 15j(1) illustrate classifying values within a submitted unstructured value, in accordance with one embodiment.

FIG. 15j(2) illustrate classifying values within a submitted unstructured value, in accordance with one embodiment.

FIG. 15j(3) illustrate classifying values within a submitted unstructured value, in accordance with one embodiment.

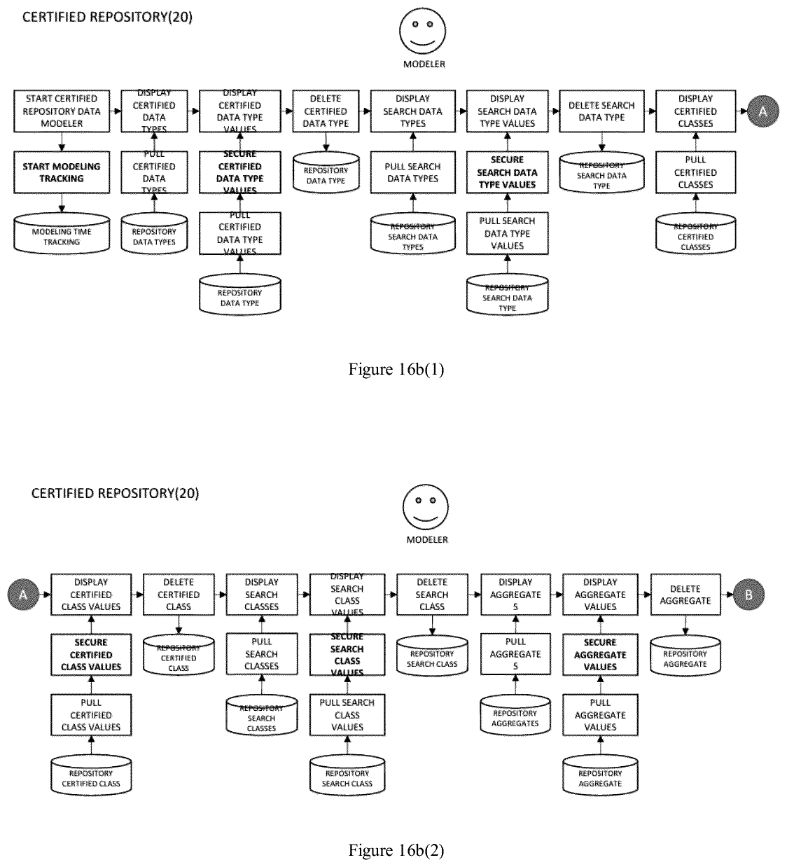

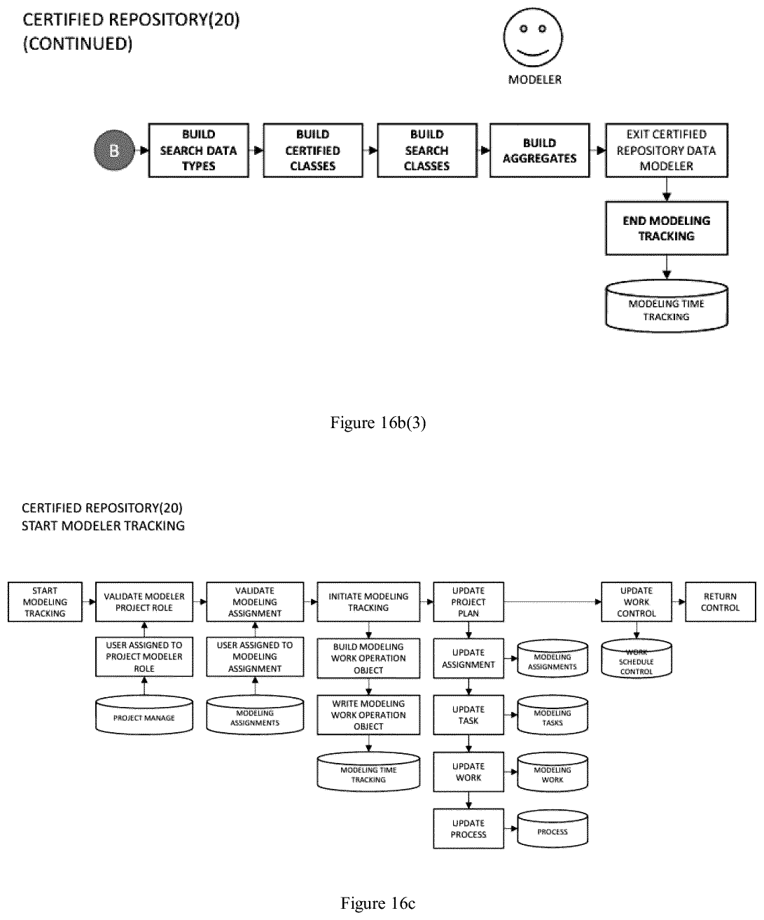

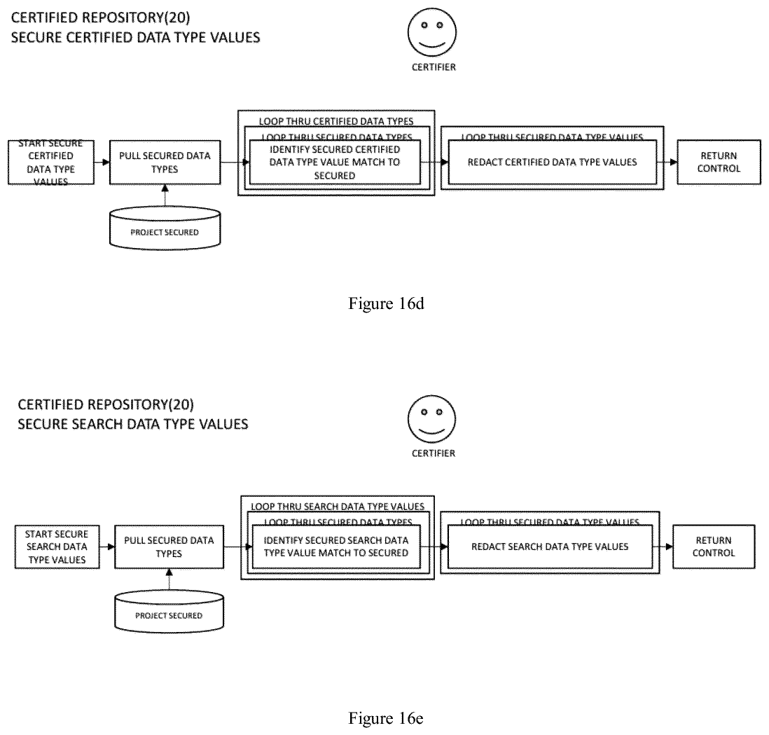

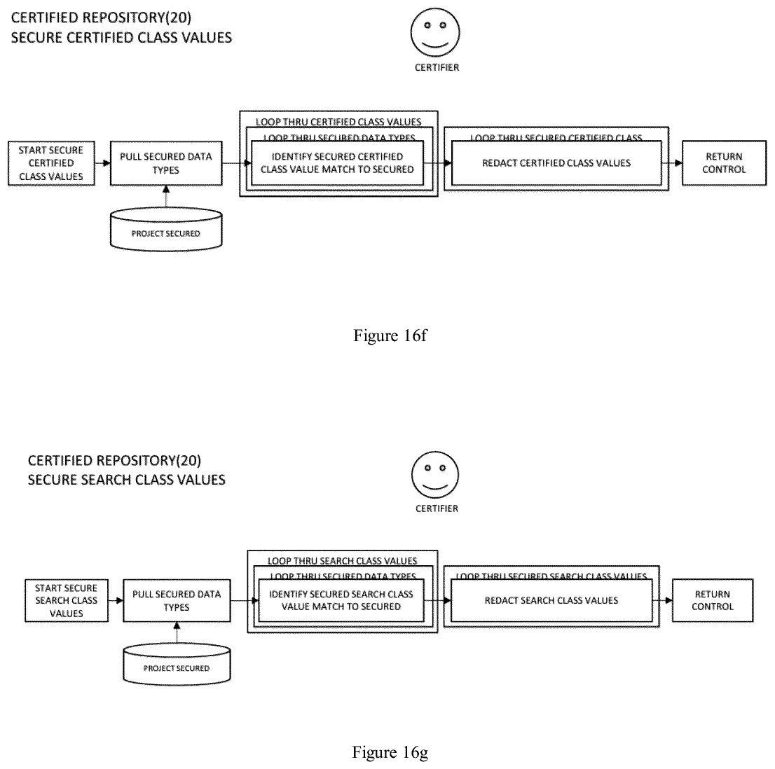

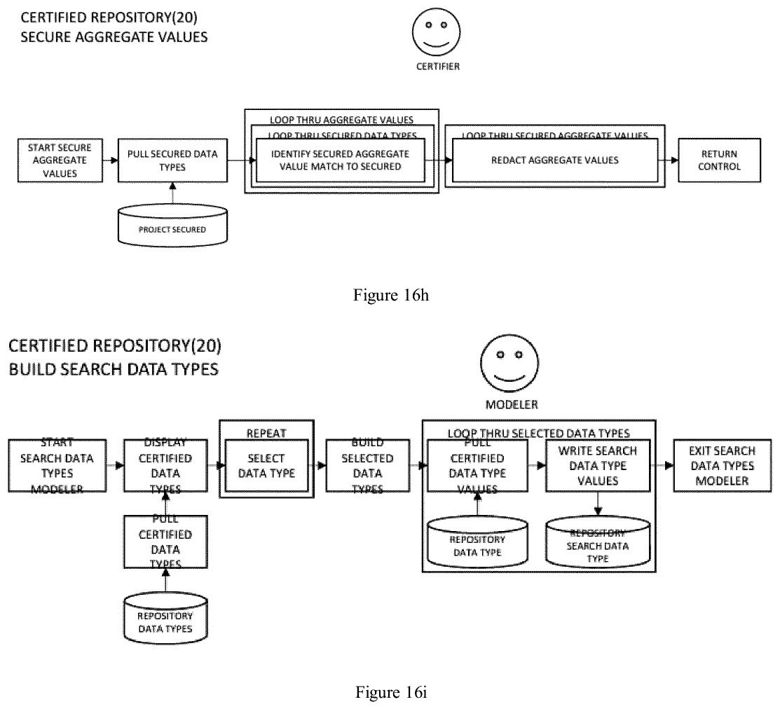

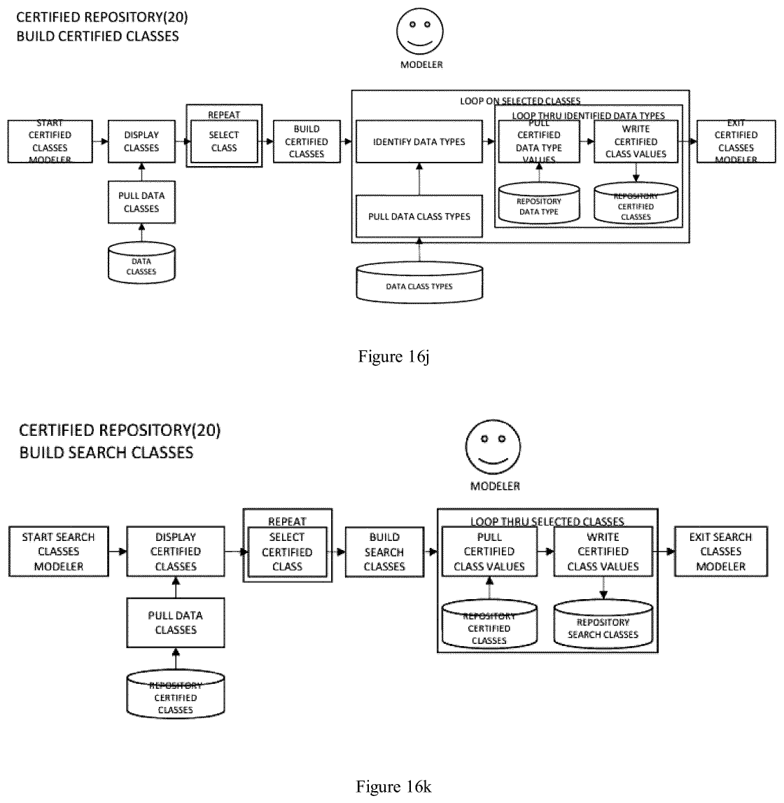

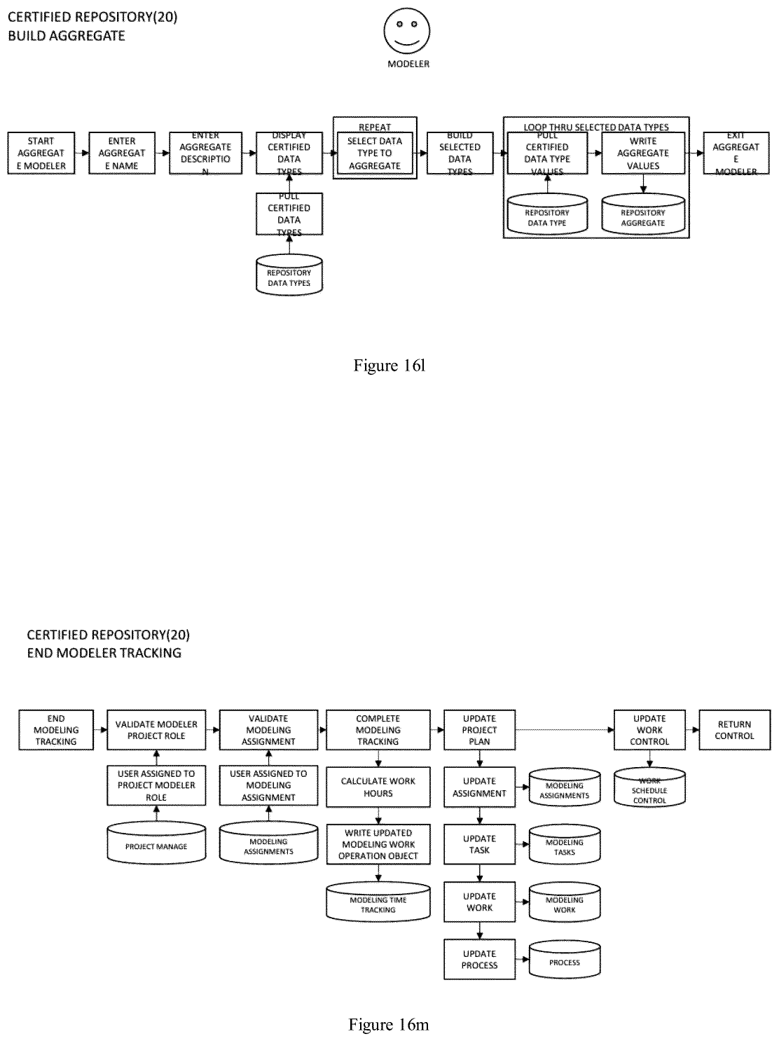

FIG. 16a illustrates a high level process flow of modeling, building, and maintaining a certified repository, in accordance with one embodiment.

FIG. 16b(1) illustrates aspects of building a certified repository, in accordance with one embodiment.

FIG. 16b(2) illustrates aspects of building a certified repository, in accordance with one embodiment.

FIG. 16b(3) illustrates aspects of building a certified repository, in accordance with one embodiment.

FIG. 16c illustrates starting modeler tracking, in accordance with one embodiment.

FIG. 16d illustrates securing certified data types, in accordance with one embodiment.

FIG. 16e illustrates securing search data types, in accordance with one embodiment.

FIG. 16f illustrates securing certified class values, in accordance with one embodiment.

FIG. 16g illustrates securing search class values, in accordance with one embodiment.

FIG. 16h illustrates securing aggregate values, in accordance with one embodiment.

FIG. 16i illustrates building search data types, in accordance with one embodiment.

FIG. 16j illustrates building certified classes, in accordance with one embodiment.

FIG. 16k illustrates building search classes, in accordance with one embodiment.

FIG. 16l illustrates building aggregates, in accordance with one embodiment.

FIG. 16m illustrates ending modeler tracking, in accordance with one embodiment.

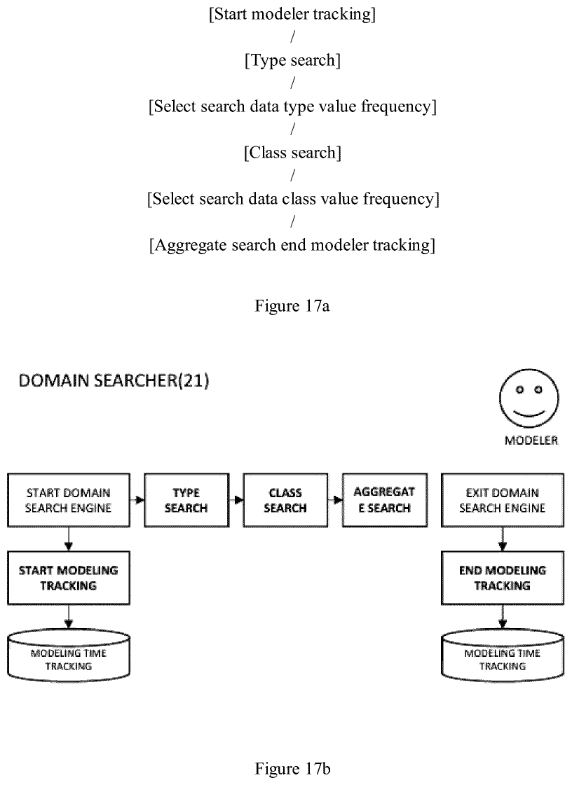

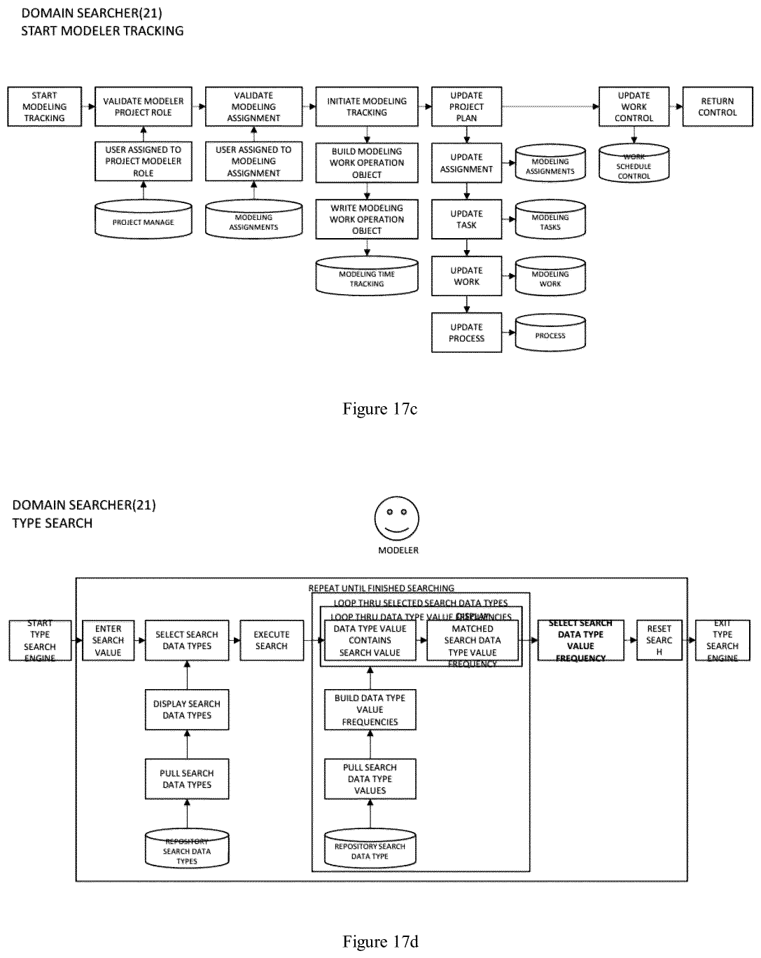

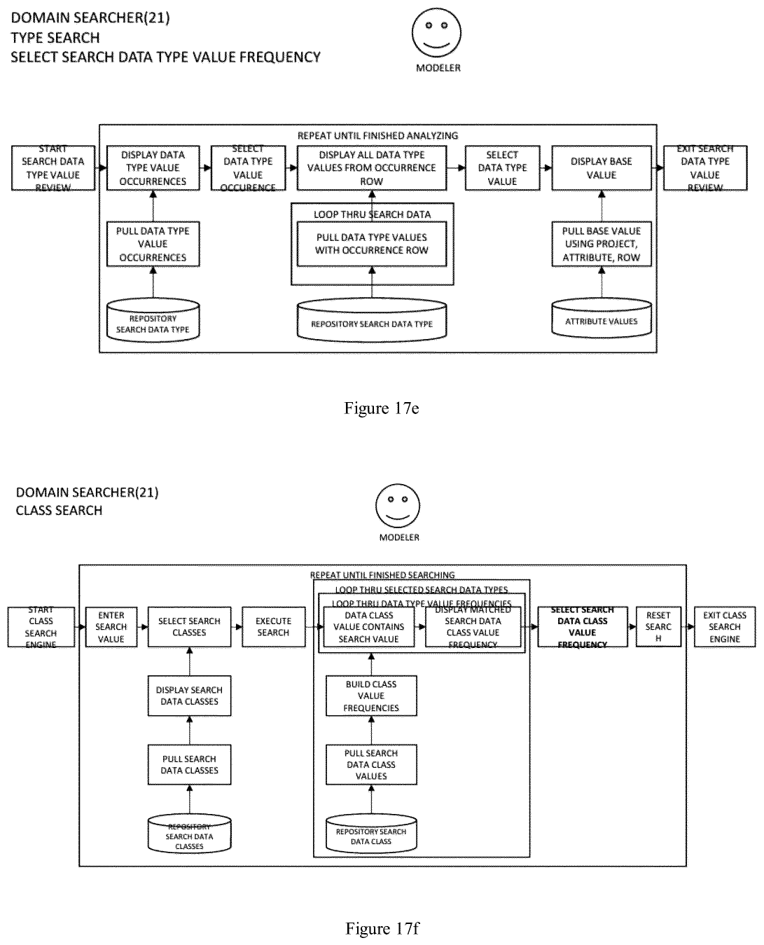

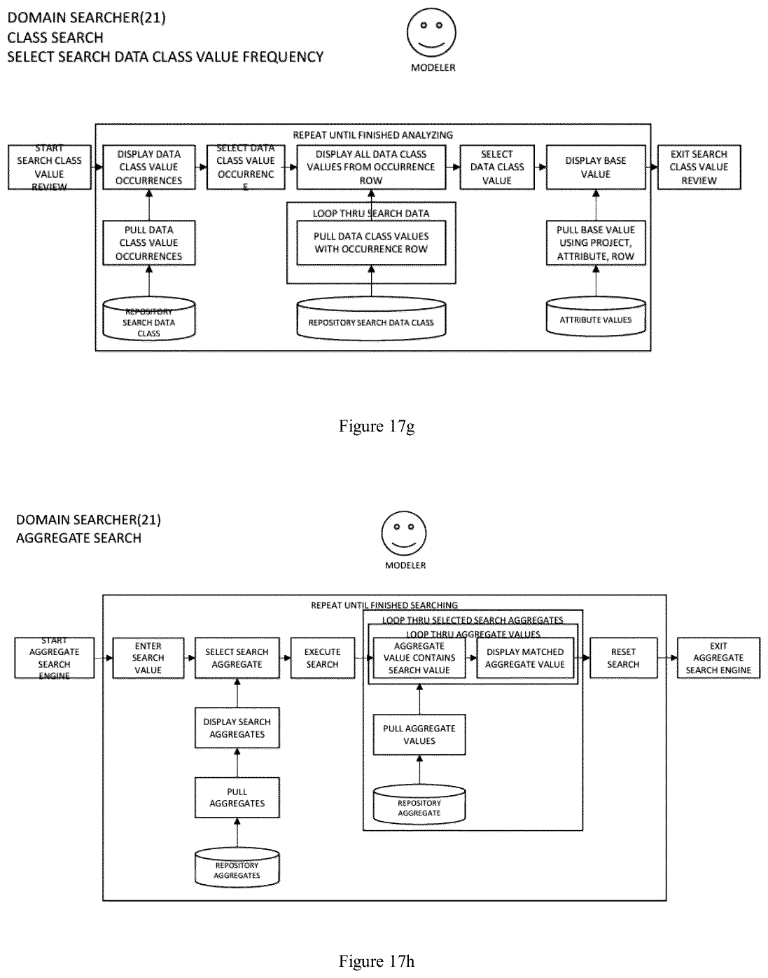

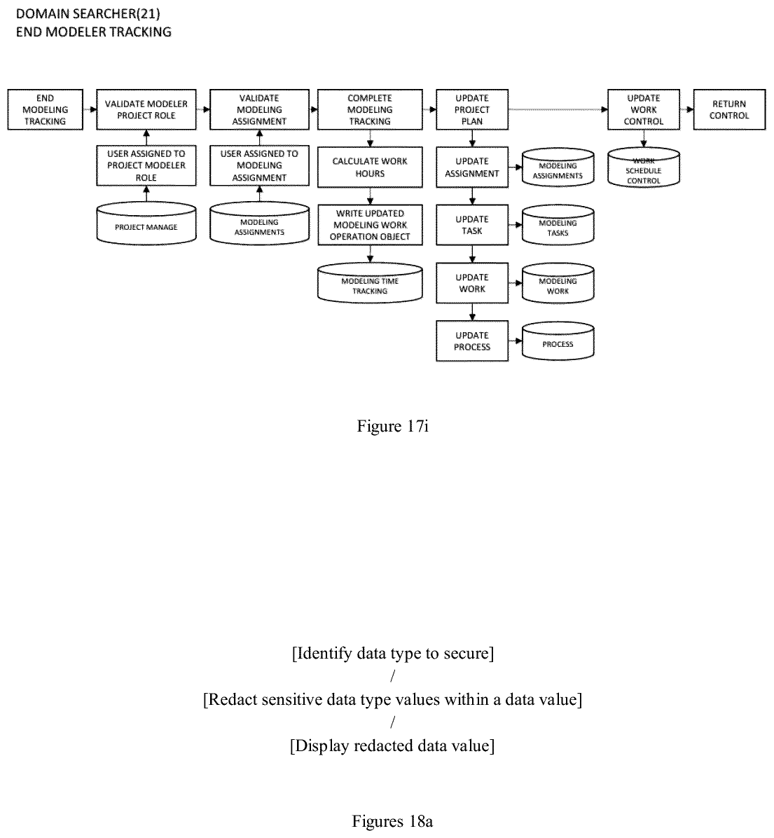

FIG. 17a illustrates aspects of such a process, in accordance with one embodiment.

FIG. 17b illustrates aspects of performing analysis against values in the certified repository, in accordance with one embodiment.

FIG. 17c illustrates starting modeling tracking, in accordance with one embodiment.

FIG. 17d illustrates entering a search value, in accordance with one embodiment.

FIG. 17e illustrates selecting search type value frequency, in accordance with one embodiment.

FIG. 17f illustrates class searching, in accordance with one embodiment.

FIG. 17g illustrates reviewing the selected data class value frequency, in accordance with one embodiment.

FIG. 17h illustrates aggregate searching, in accordance with one embodiment.

FIG. 17i illustrates ending modeler tracking, in accordance with one embodiment.

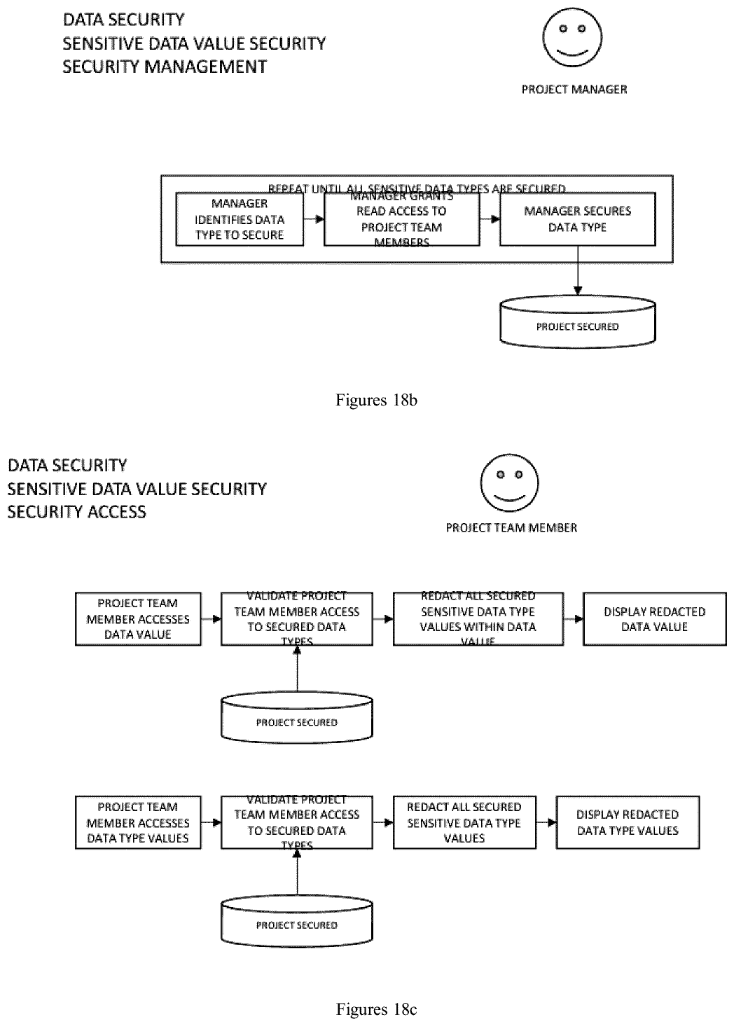

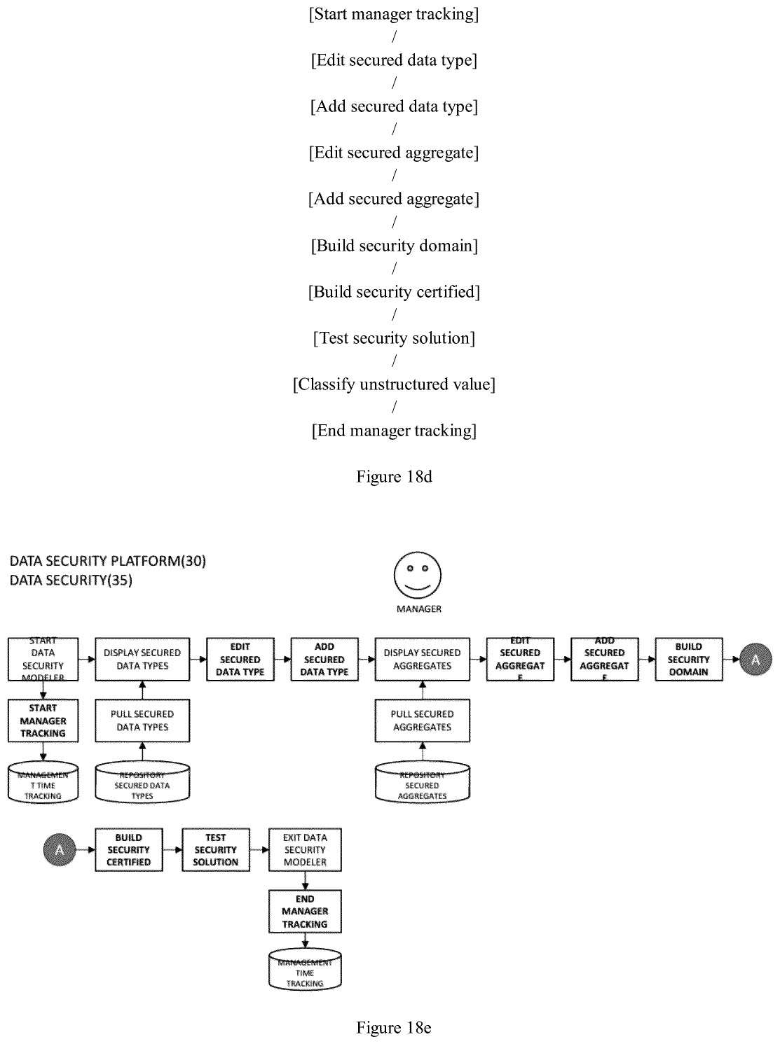

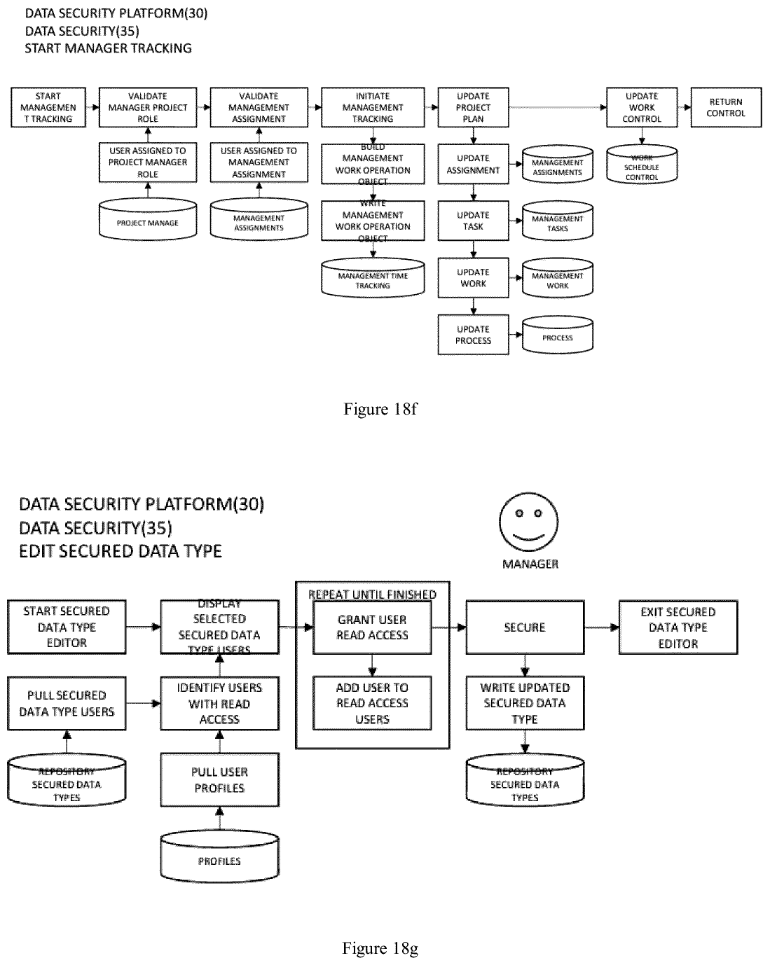

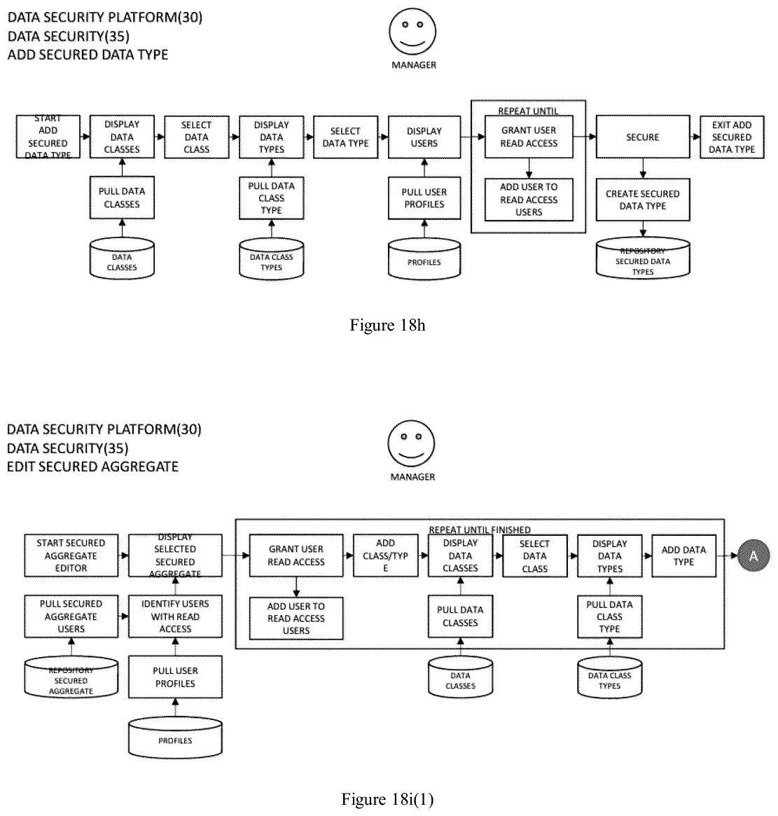

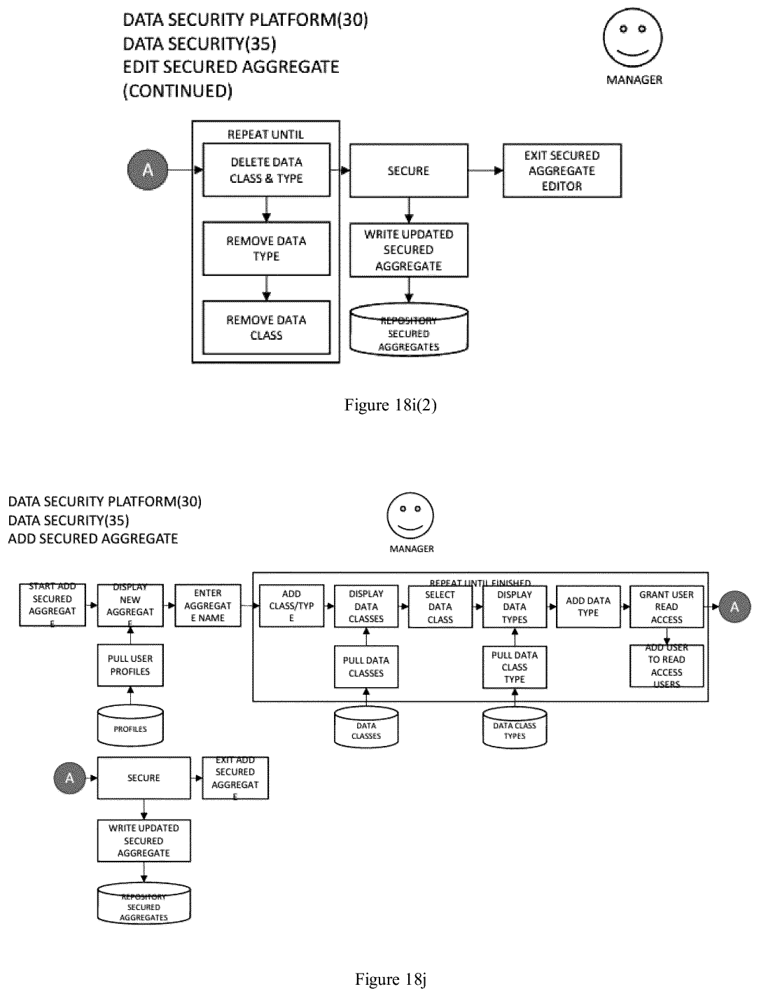

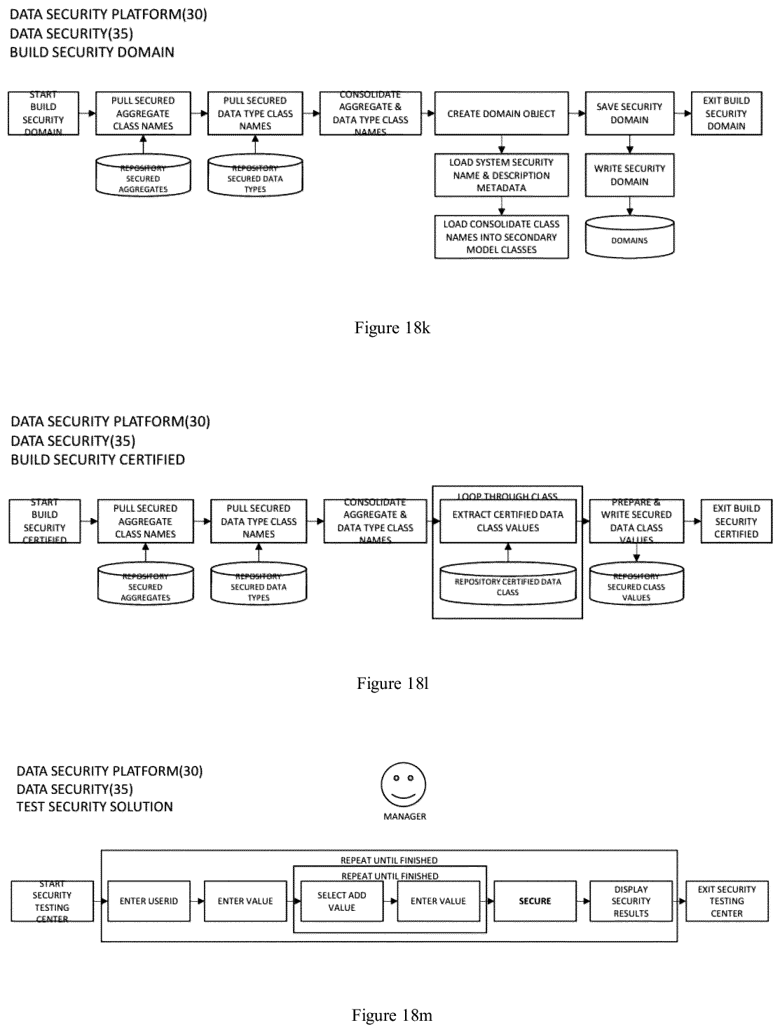

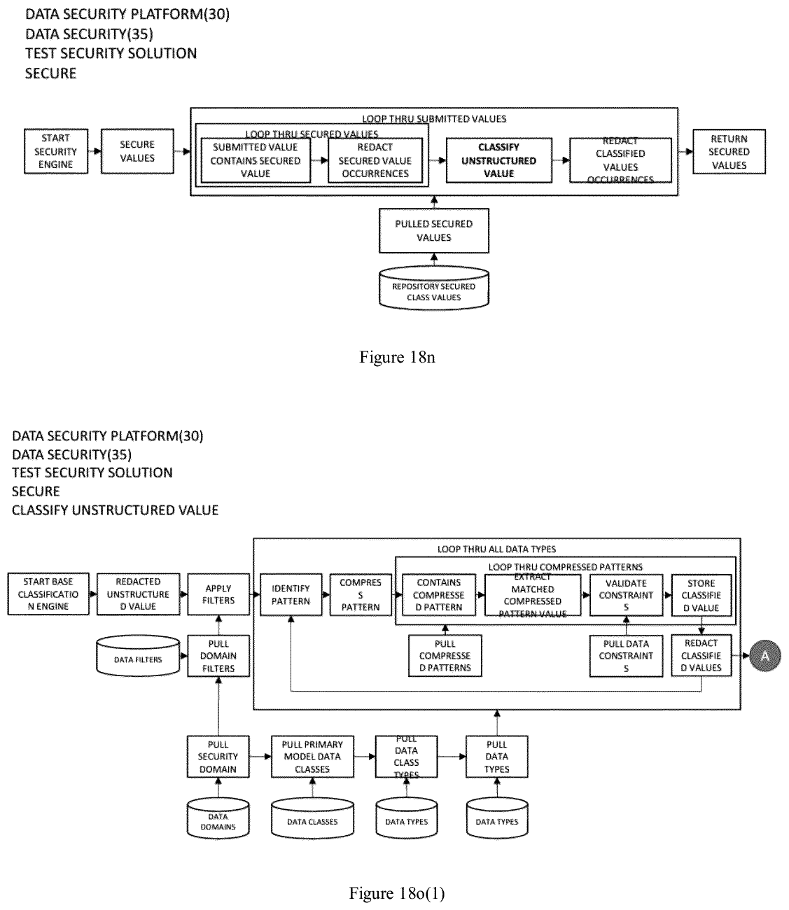

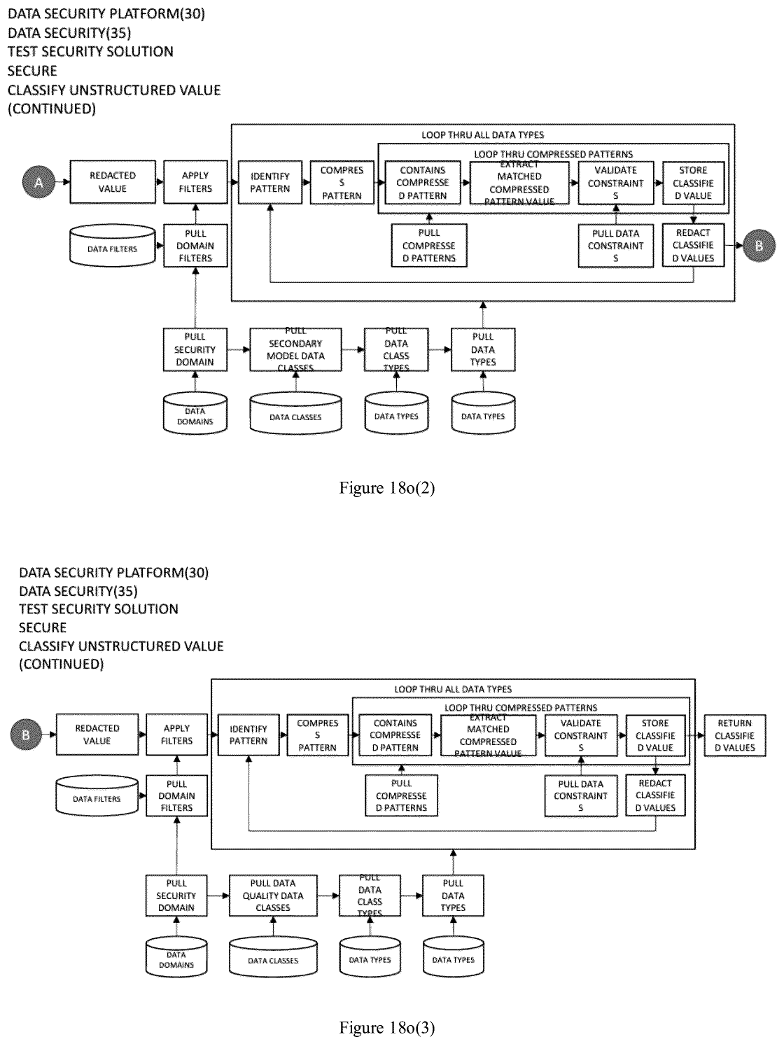

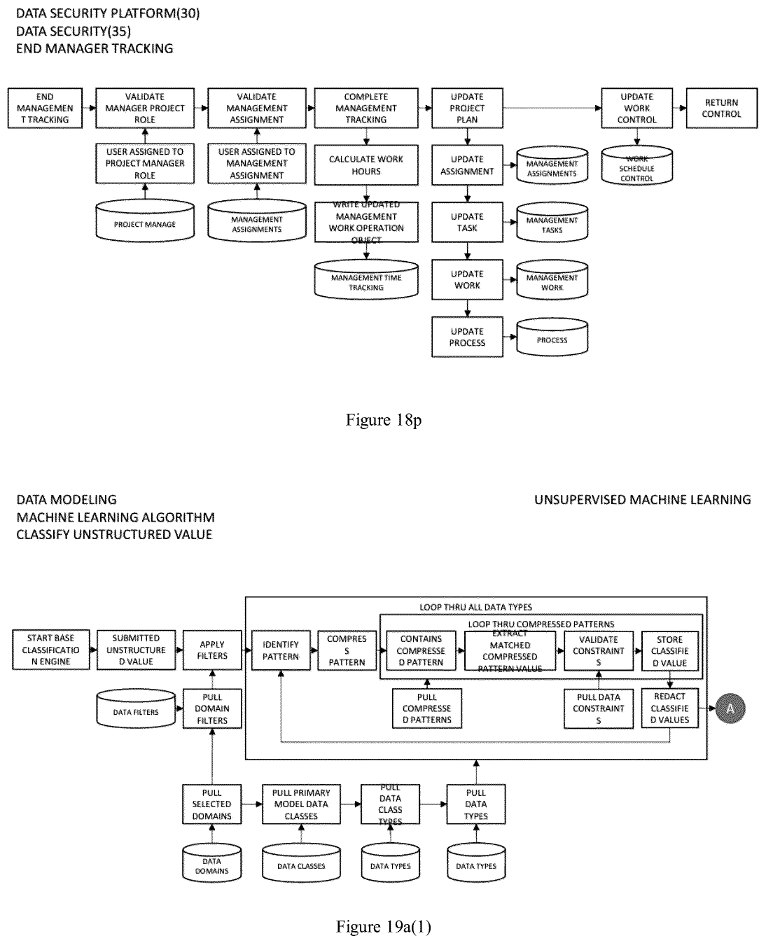

FIG. 18a illustrates a high level overview of securing data types containing sensitive information, in accordance with one embodiment.

FIG. 18b illustrates aspects of securing data types containing sensitive information, in accordance with one embodiment.

FIG. 18c illustrates aspects of security access, in accordance with one embodiment.

FIG. 18d illustrates aspects of a data security platform, in accordance with one embodiment.

FIG. 18e illustrates aspects of securing sensitive data types, in accordance with one embodiment.

FIG. 18f illustrates start manager tracking, in accordance with one embodiment.

FIG. 18g illustrates securing sensitive data types, in accordance with one embodiment.

FIG. 18h illustrates adding secured data types, in accordance with one embodiment.

FIG. 18i(1) illustrates editing secured aggregates, in accordance with one embodiment.

FIG. 18i(2) illustrates editing secured aggregates, in accordance with one embodiment.

FIG. 18j illustrates adding secured aggregates, in accordance with one embodiment.

FIG. 18k illustrates building a secure domain, in accordance with one embodiment.

FIG. 18l illustrates certifying build security, in accordance with one embodiment.

FIG. 18m illustrates testing the security solution, in accordance with one embodiment.

FIG. 18n illustrates securing sensitive information, in accordance with one embodiment.

FIG. 18o(1) illustrates classifying an unstructured value, in accordance with one embodiment.

FIG. 18o(2) illustrates classifying an unstructured value, in accordance with one embodiment.

FIG. 18o(3) illustrates classifying an unstructured value, in accordance with one embodiment.

FIG. 18p illustrates ending manager tracking, in accordance with one embodiment.

FIG. 19a(1) illustrates aspects of classifying unstructured values using the machine learning algorithm, in accordance with one embodiment.

FIG. 19a(2) illustrates aspects of classifying unstructured values using the machine learning algorithm, in accordance with one embodiment.

FIG. 19a(3) illustrates aspects of classifying unstructured values using the machine learning algorithm, in accordance with one embodiment.

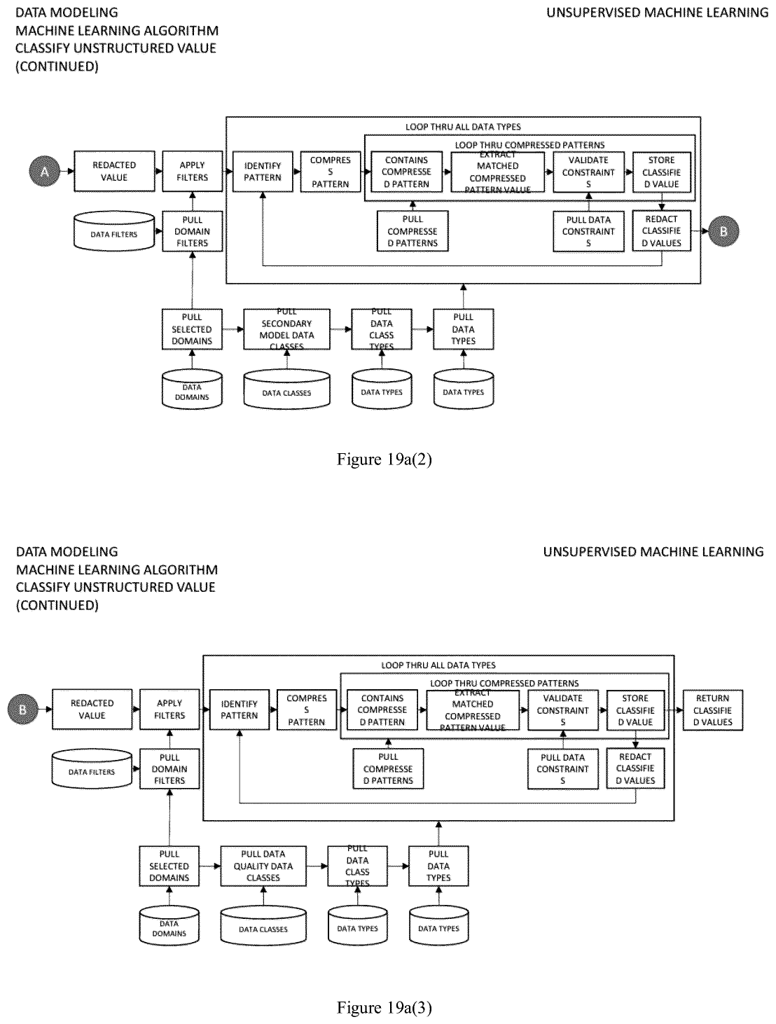

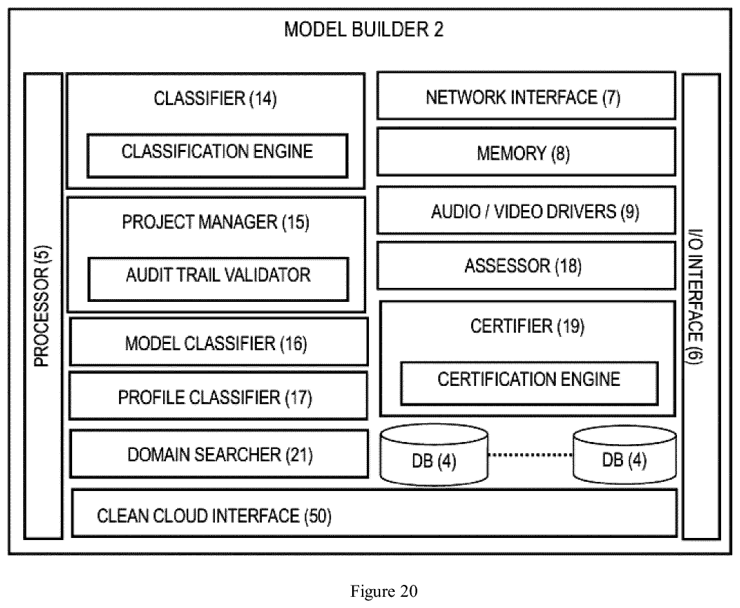

FIG. 20 illustrates an application view of a data modeling solution, in accordance with one embodiment.

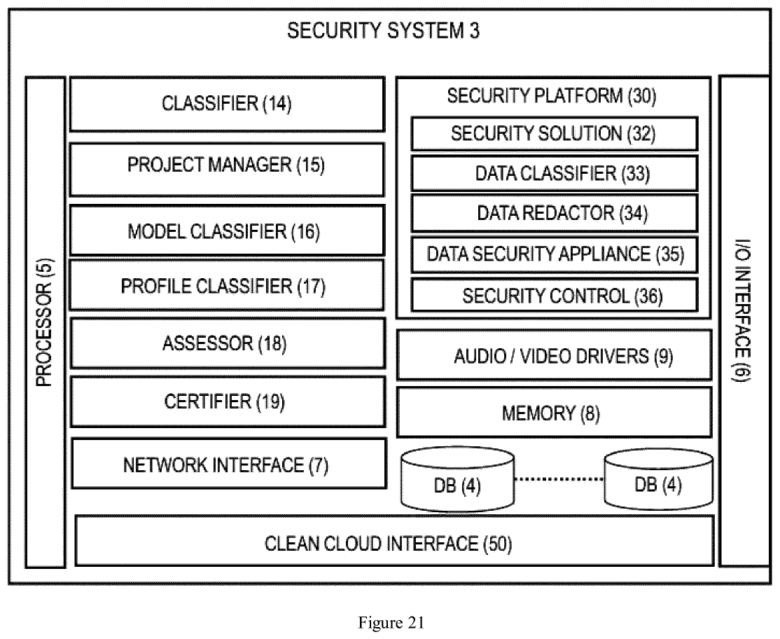

FIG. 21 illustrates an application view of a security module, in accordance with one embodiment.

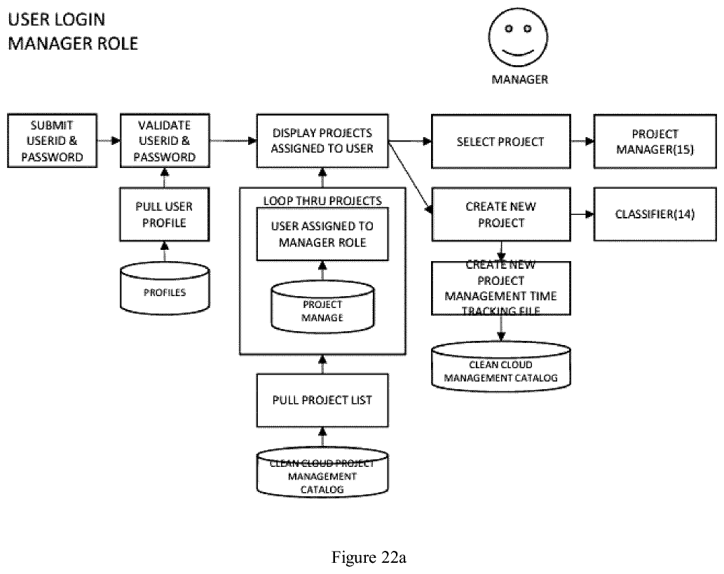

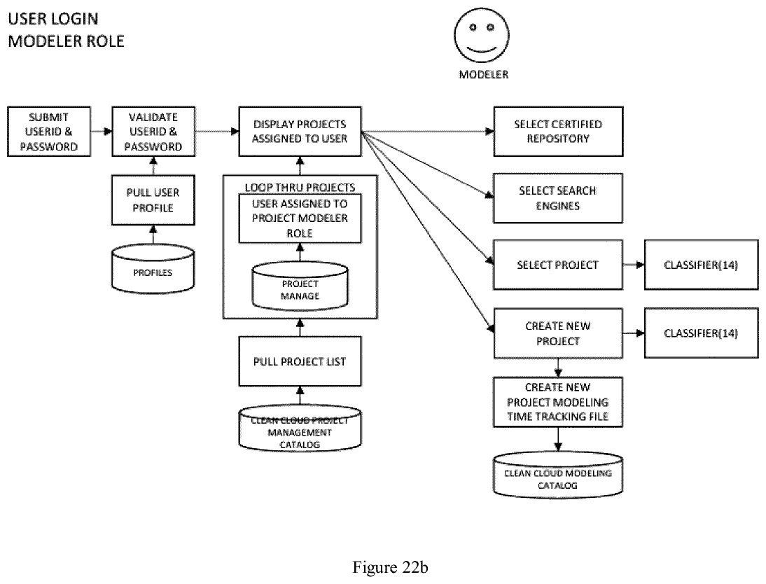

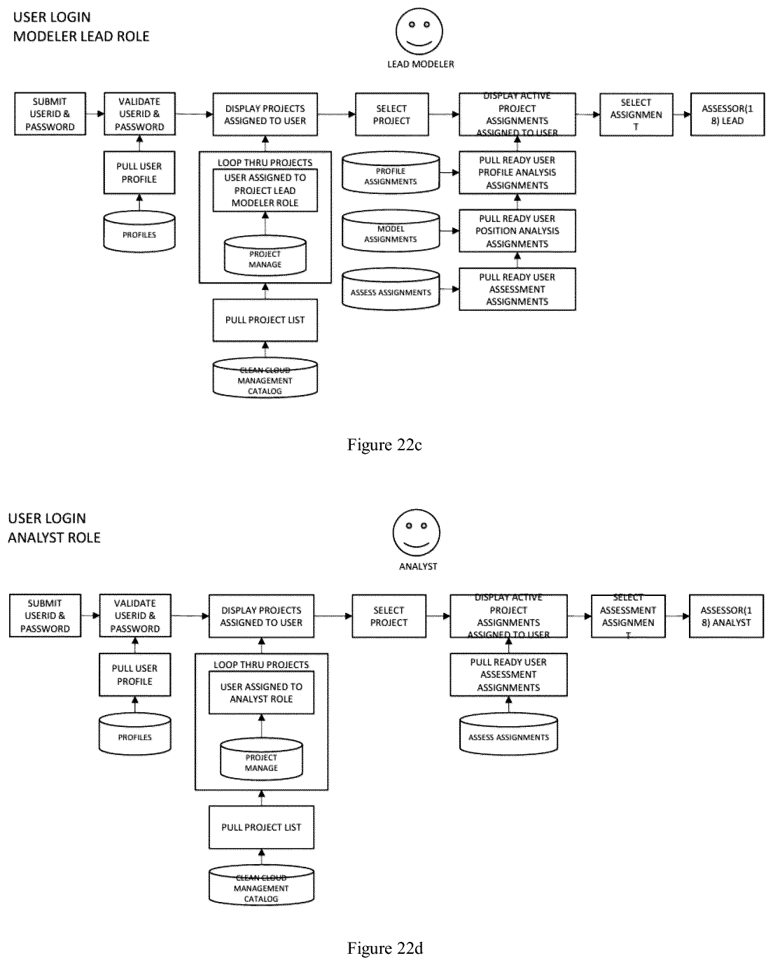

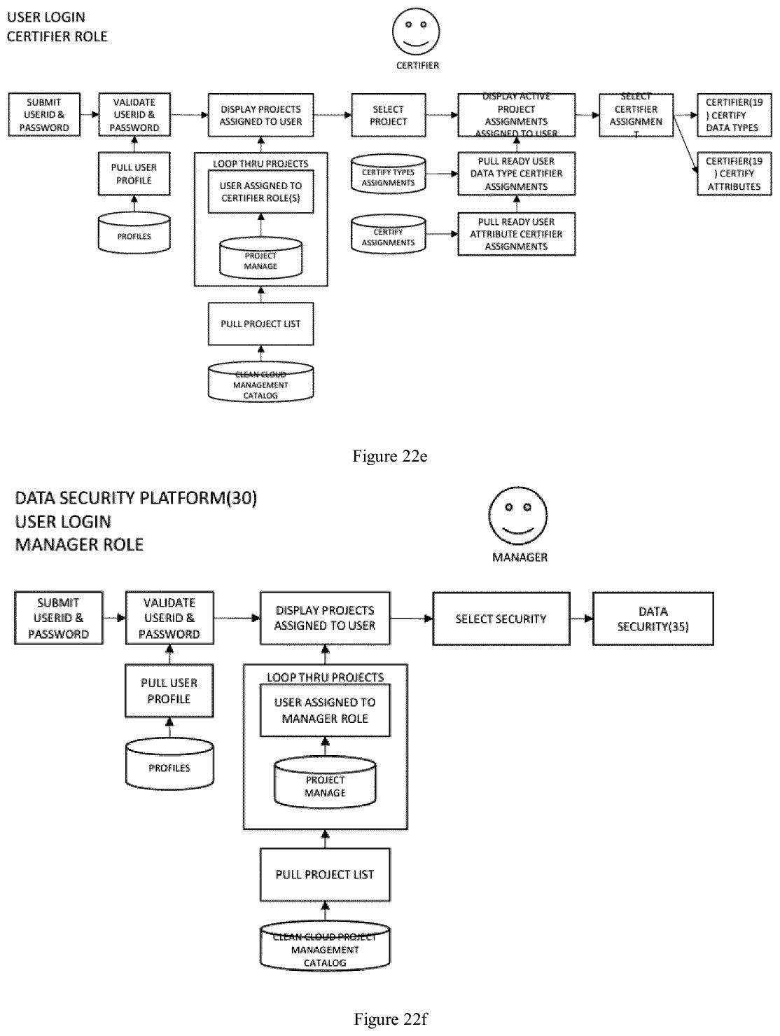

FIG. 22a illustrates the project manager login and how the manager creates new projects and accesses existing projects, in accordance with one embodiment.

FIG. 22b illustrates a data modeler login, in accordance with one embodiment.

FIG. 22c illustrates a lead modeler login, in accordance with one embodiment.

FIG. 22d illustrates an analyst login, in accordance with one embodiment.

FIG. 22e illustrates the certifier role, in accordance with one embodiment.

FIG. 22f illustrates manager login for a data security program, in accordance with one embodiment.

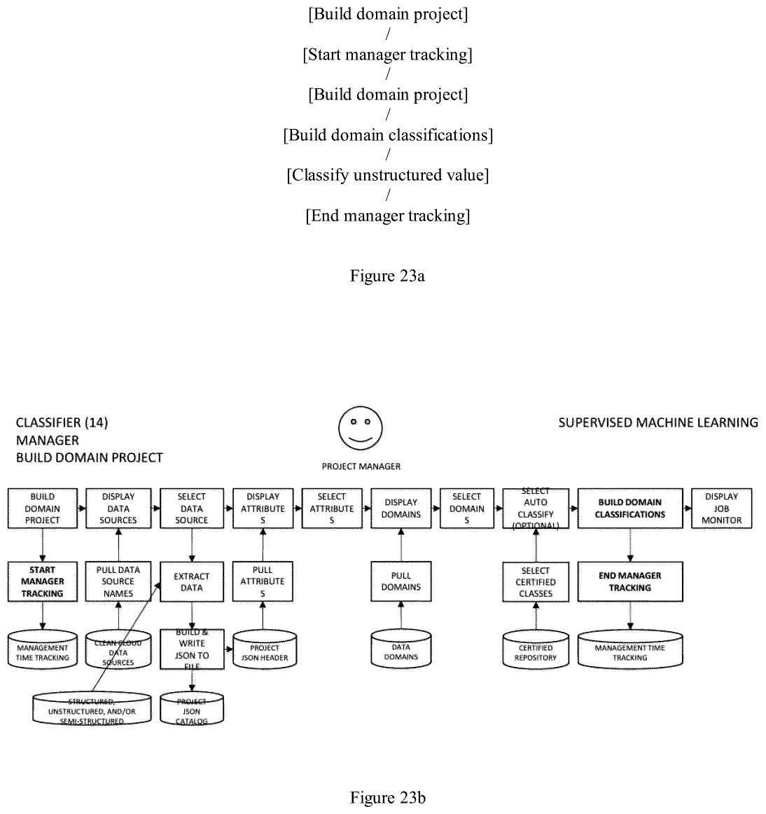

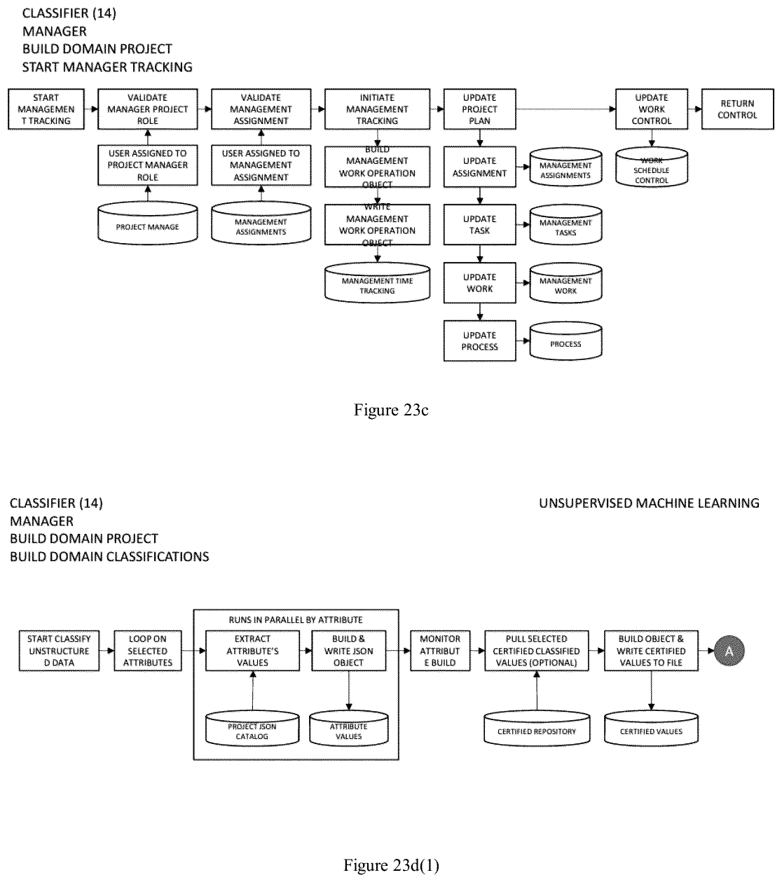

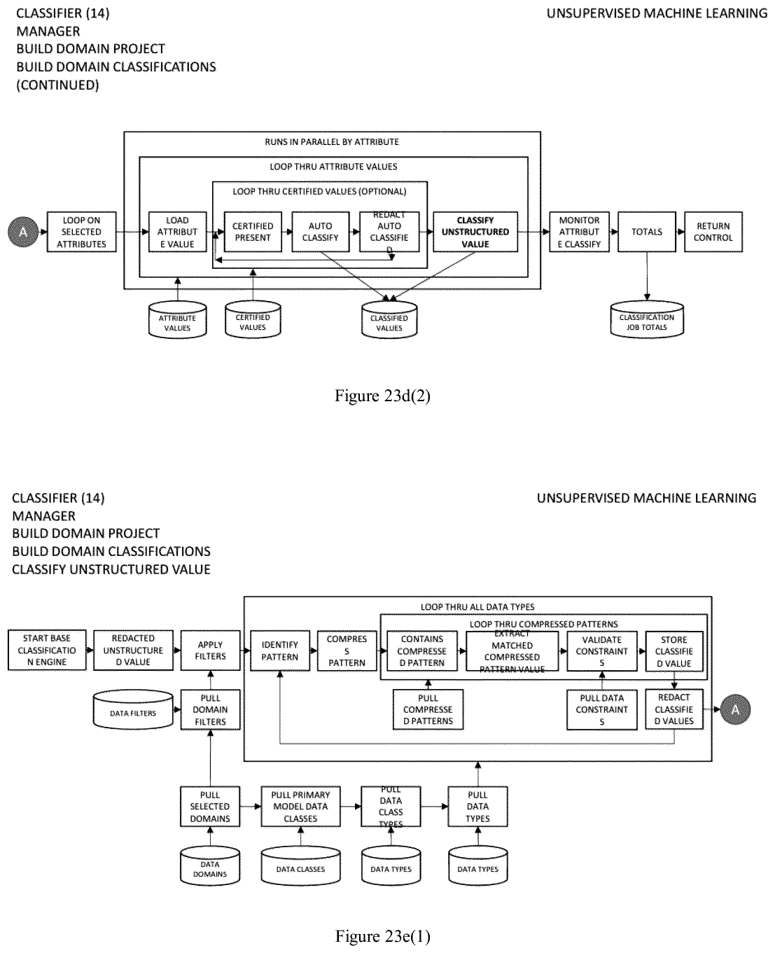

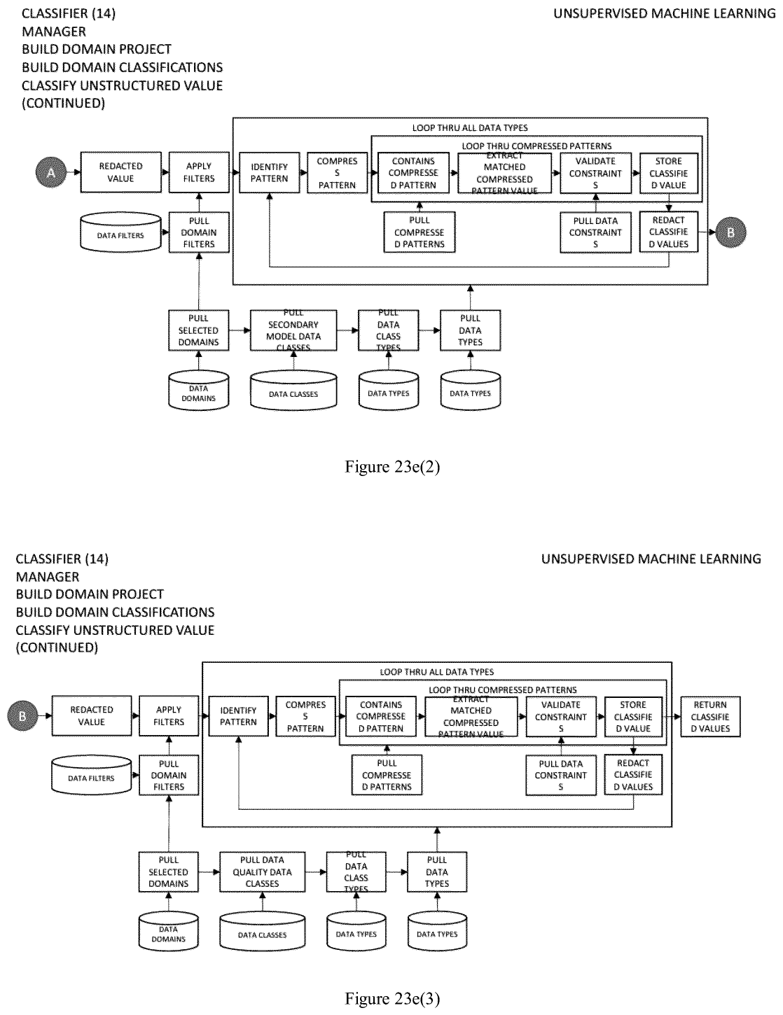

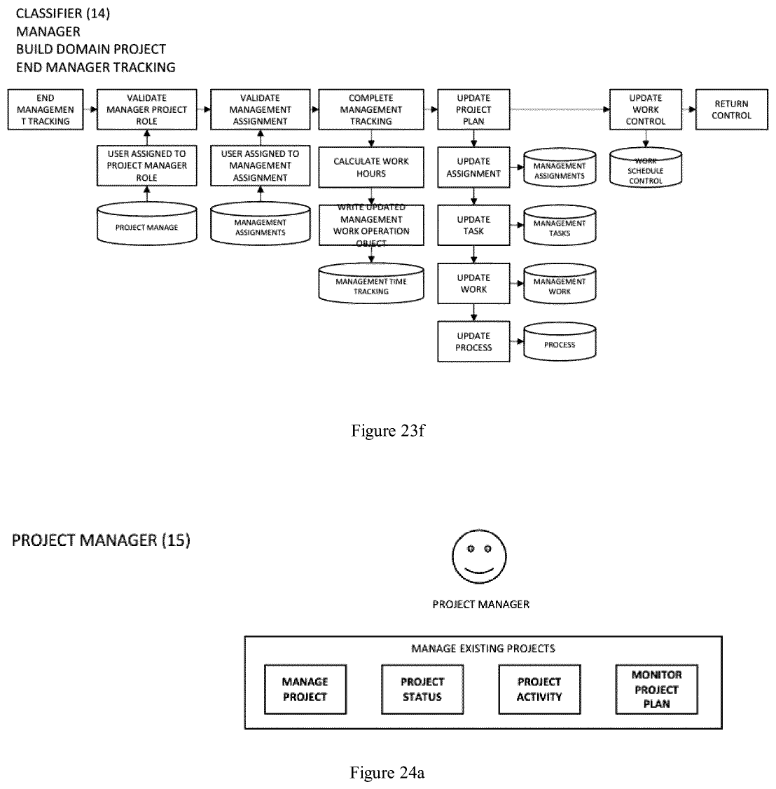

FIG. 23a illustrates a high level process view of running a project using a data modeling solution, in accordance with one embodiment.

FIG. 23b illustrates aspects of running a project using a data modeling solution, in accordance with one embodiment.

FIG. 23c illustrates starting a manager tracker, in accordance with one embodiment.

FIG. 23d(1) illustrates building domain classification, in accordance with one embodiment.

FIG. 23d(2) illustrates building domain classification, in accordance with one embodiment.

FIG. 23e(1) illustrates classifying unstructured values, in accordance with one embodiment.

FIG. 23e(2) illustrates classifying unstructured values, in accordance with one embodiment.

FIG. 23e(3) illustrates classifying unstructured values, in accordance with one embodiment.

FIG. 23f illustrates ending manager tracking, in accordance with one embodiment.

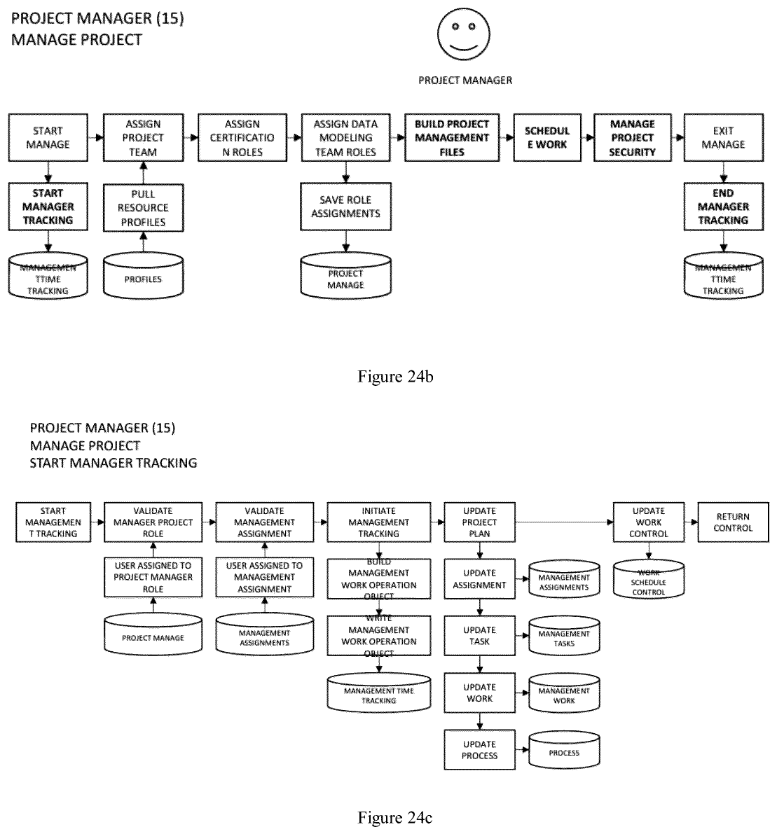

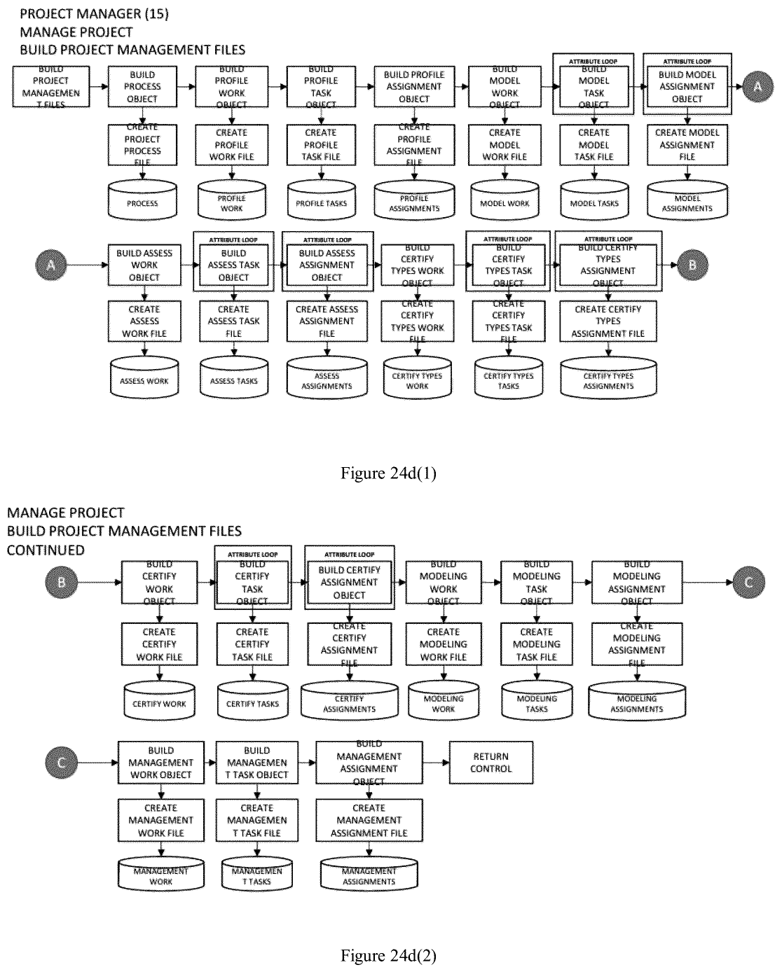

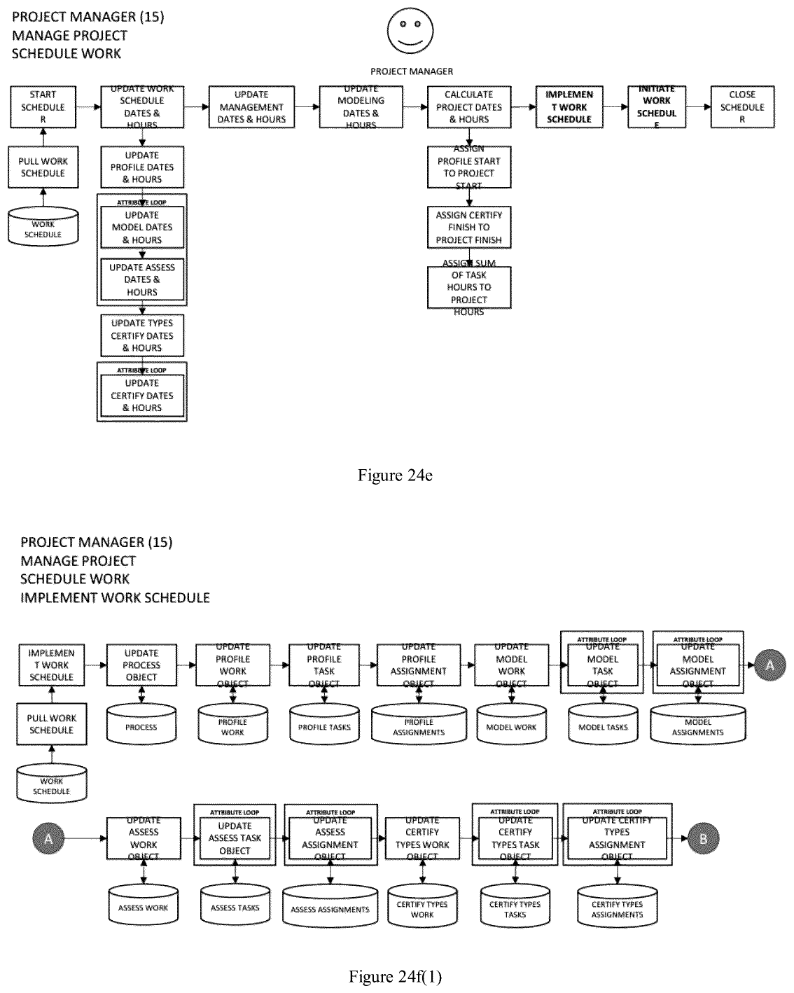

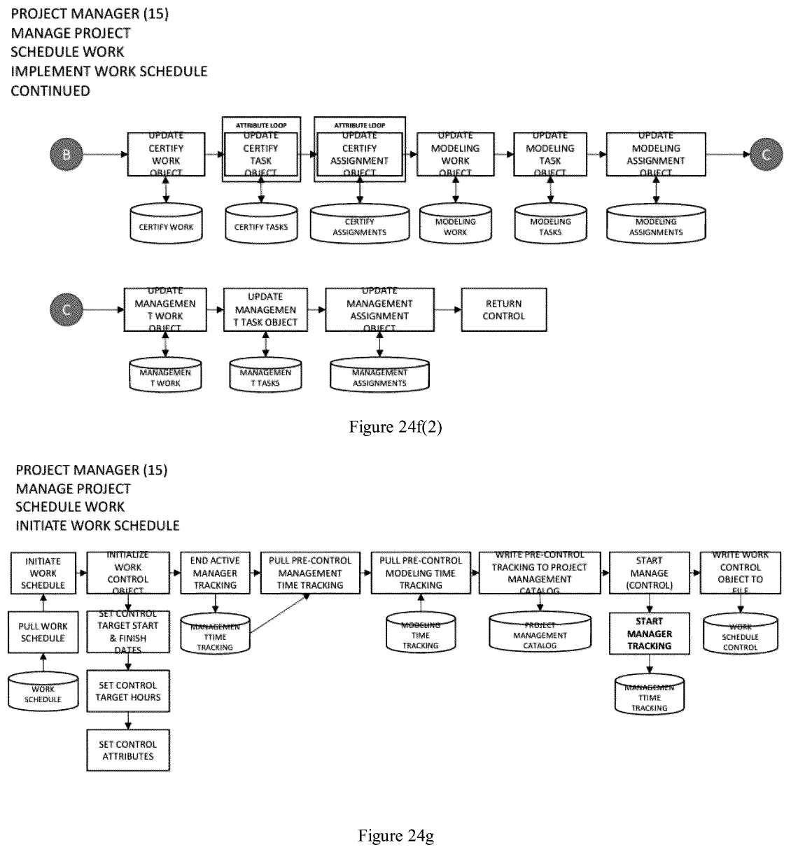

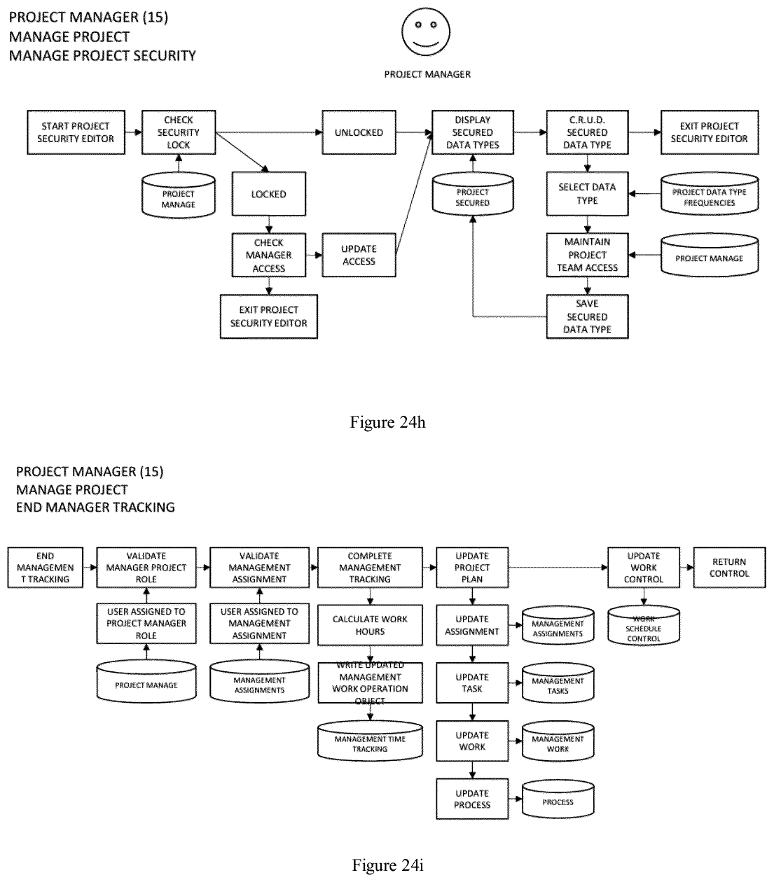

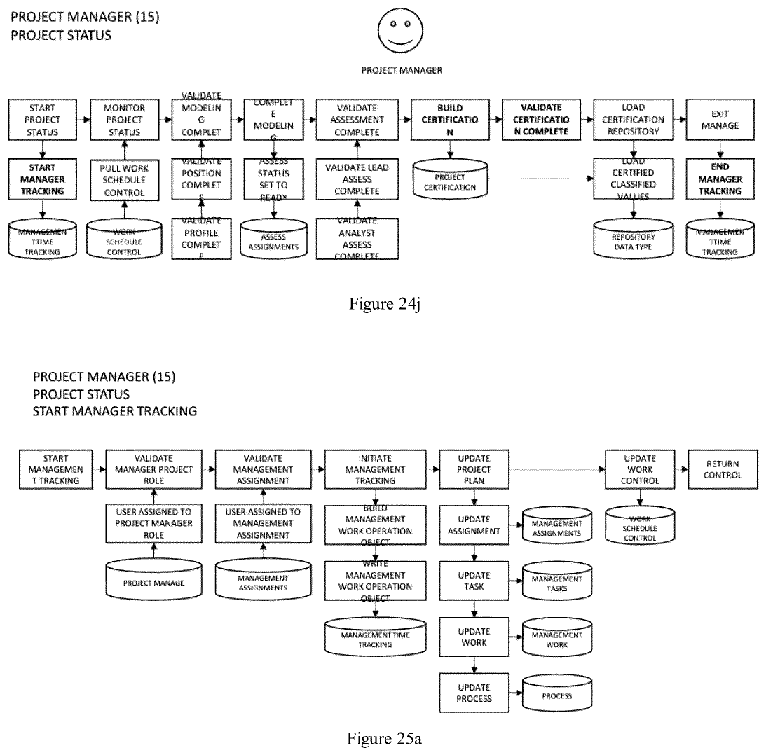

FIG. 24a illustrates aspects of the project manager role, in accordance with one embodiment.

FIG. 24b illustrates managing a project, in accordance with one embodiment.

FIG. 24c illustrates starting project manager tracking, in accordance with one embodiment.

FIG. 24d(1) illustrates building project management files, in accordance with one embodiment.

FIG. 24d(2) illustrates building project management files, in accordance with one embodiment.

FIG. 24e illustrates scheduling work, in accordance with one embodiment.

FIG. 24f(1) illustrates implementing a work schedule, in accordance with one embodiment.

FIG. 24f(2) illustrates implementing a work schedule, in accordance with one embodiment.

FIG. 24g illustrates initiating a work schedule, in accordance with one embodiment.

FIG. 24h illustrates managing project security, in accordance with one embodiment.

FIG. 24i illustrates ending project manager tracking, in accordance with one embodiment.

FIG. 24j illustrates aspects of tracking project status, in accordance with one embodiment.

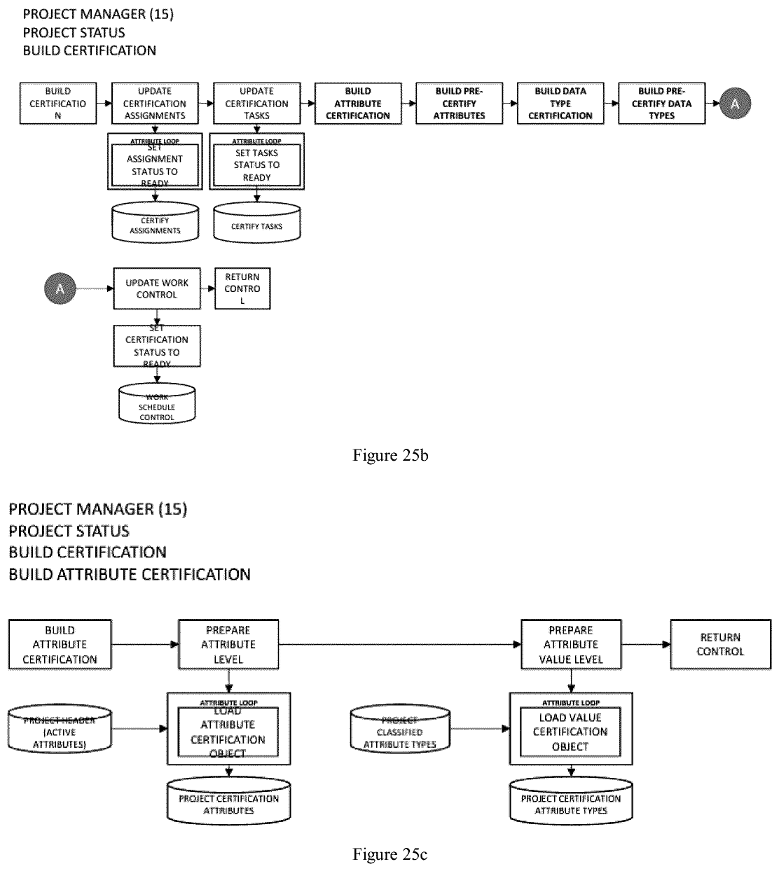

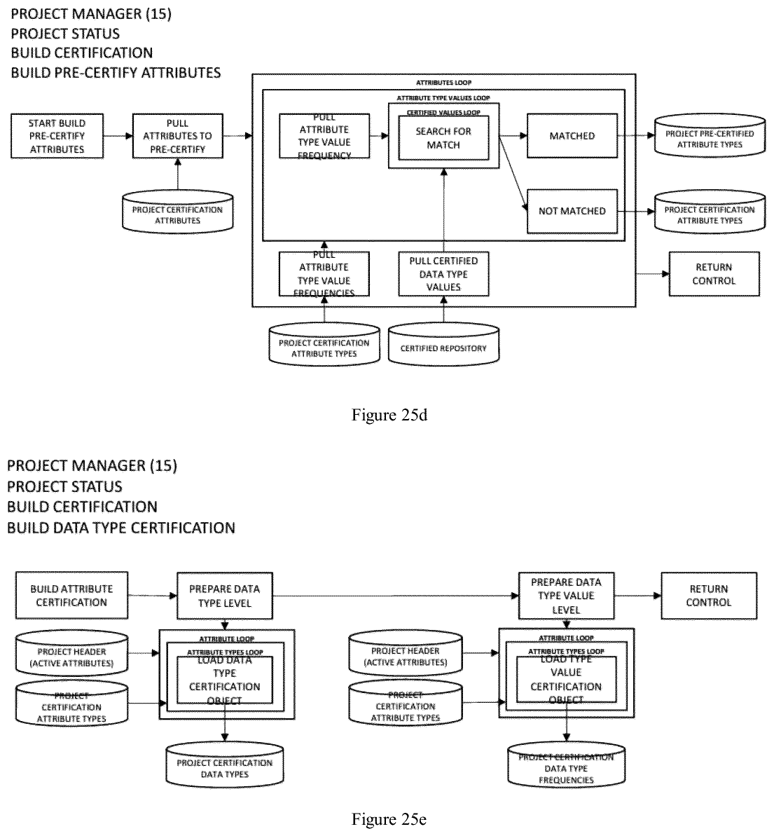

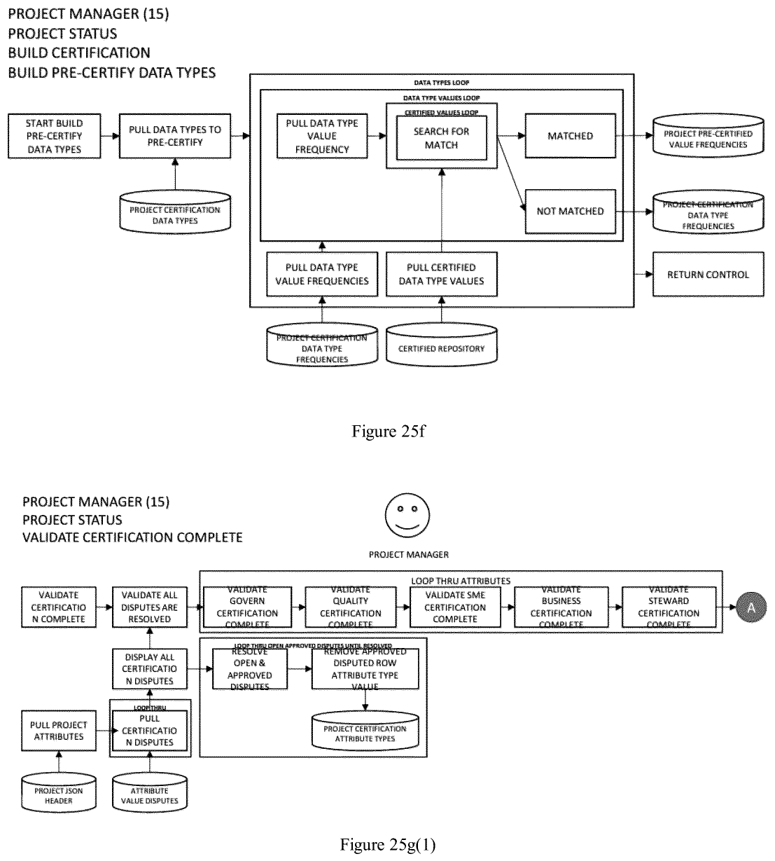

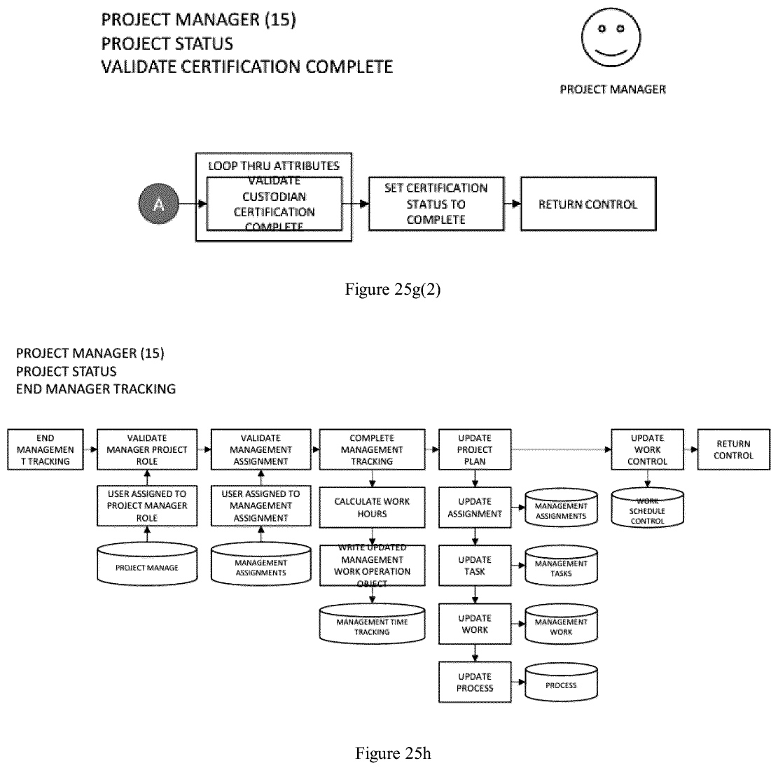

FIG. 25a illustrates starting manager tracking, in accordance with one embodiment.

FIG. 25b illustrates creating certification, in accordance with one embodiment.

FIG. 25c illustrates creating attributed certification, in accordance with one embodiment.

FIG. 25d illustrates identifying pre-certify values, in accordance with one embodiment.

FIG. 25e illustrates building data type values, in accordance with one embodiment.

FIG. 25f illustrates pre-certifying values by data type, in accordance with one embodiment.

FIG. 25g(1) illustrates validating that certification is complete, in accordance with one embodiment.

FIG. 25g(2) illustrates validating that certification is complete, in accordance with one embodiment.

FIG. 25h illustrates ending manager tracking, in accordance with one embodiment.

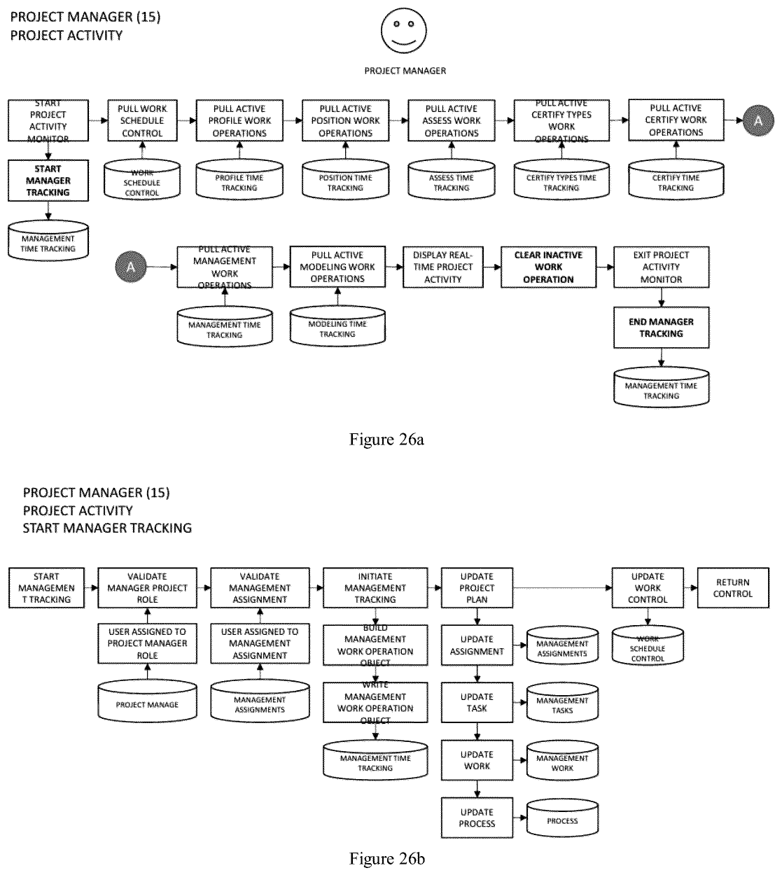

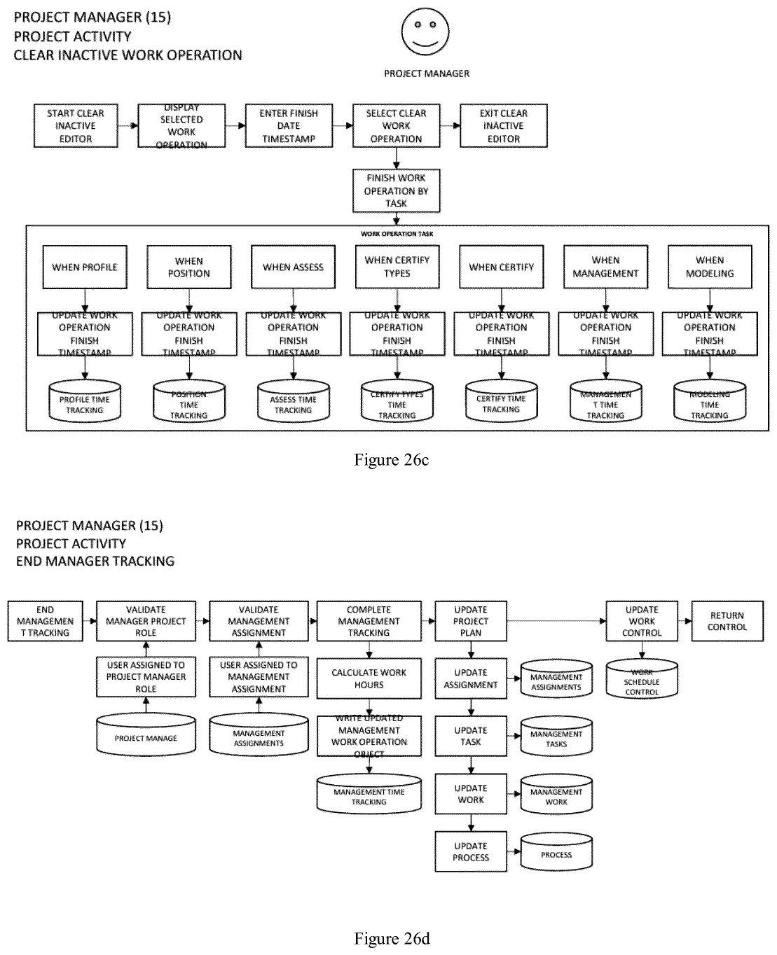

FIG. 26a illustrates a high level view of monitoring project work activity, in accordance with one embodiment.

FIG. 26b illustrates starting manager tracking, in accordance with one embodiment.

FIG. 26c illustrates clearing inactive work operations, in accordance with one embodiment.

FIG. 26d illustrates ending manager tracking, in accordance with one embodiment.

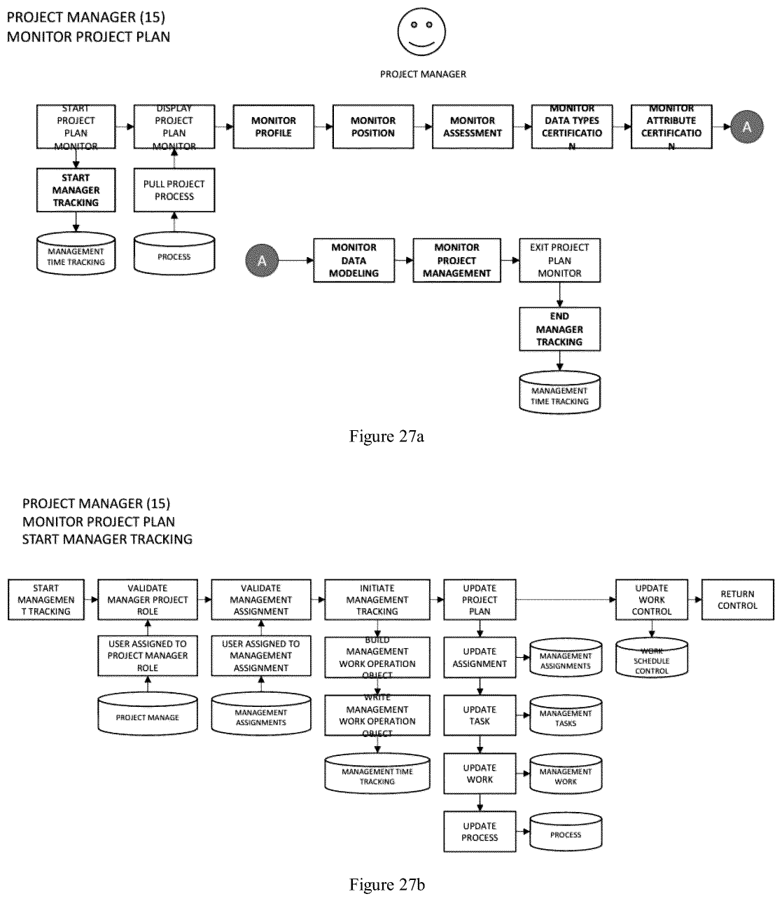

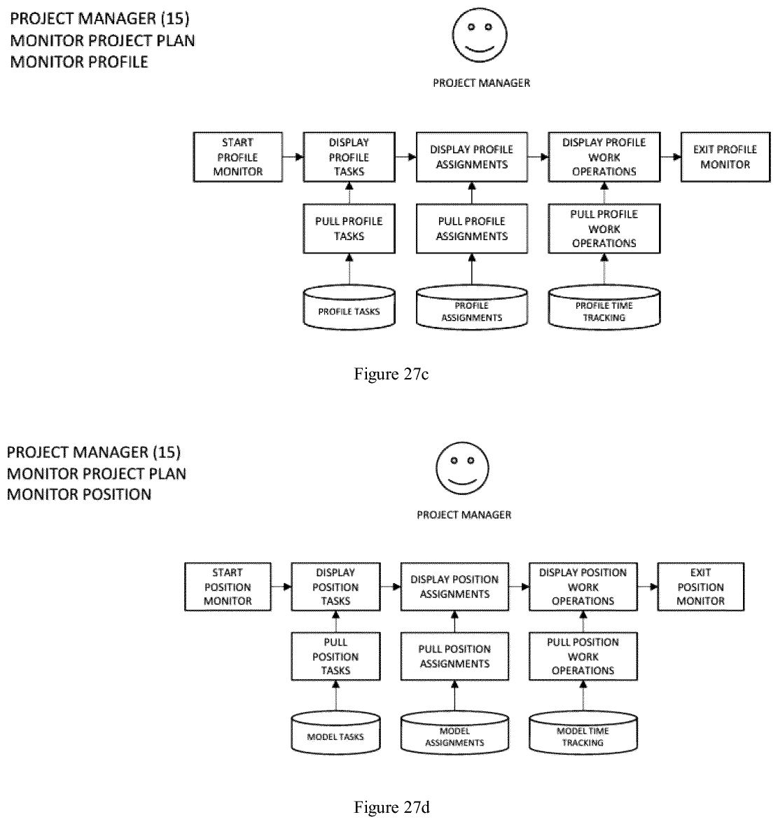

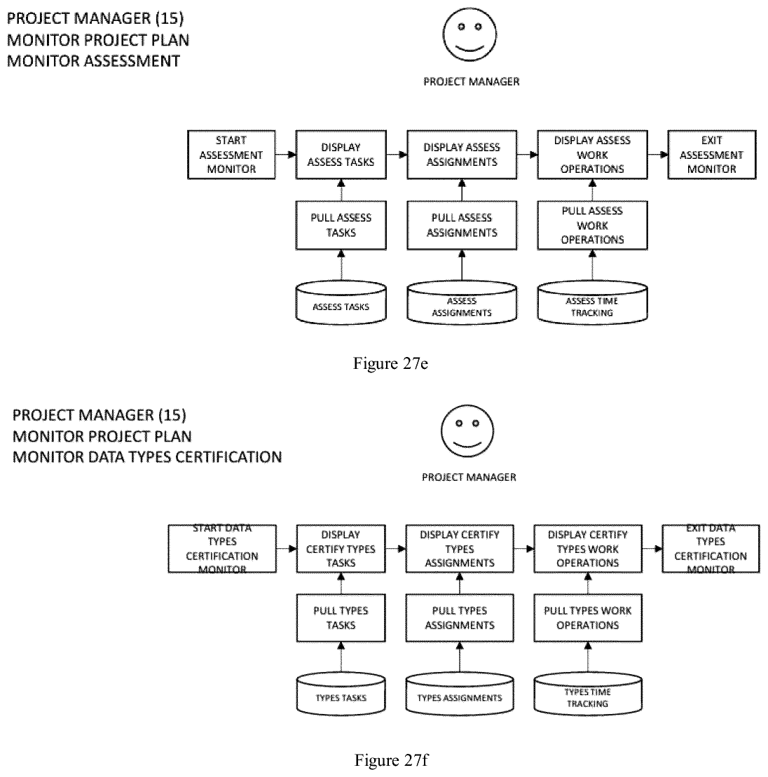

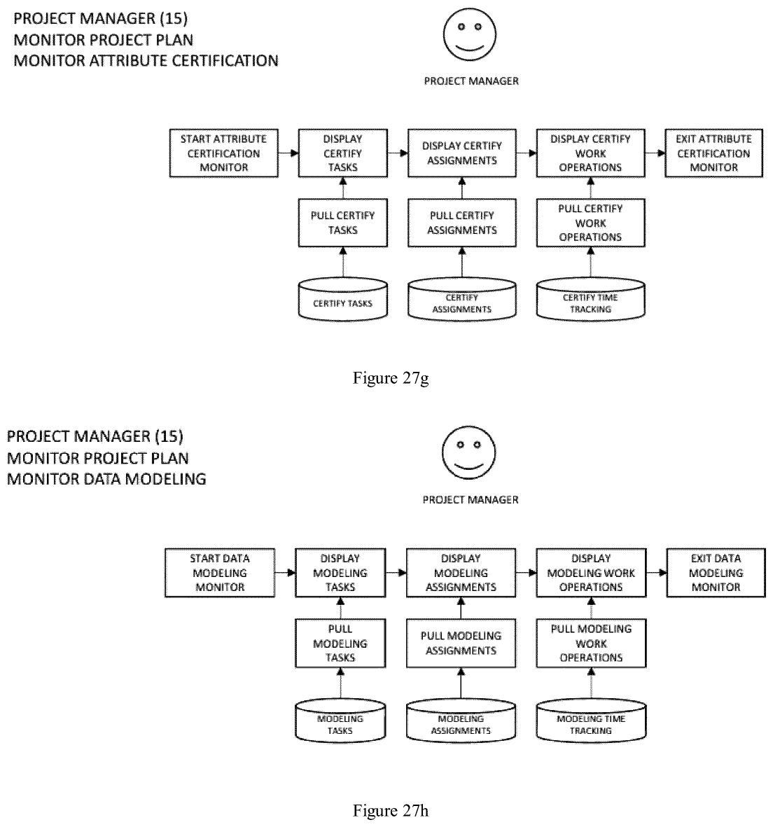

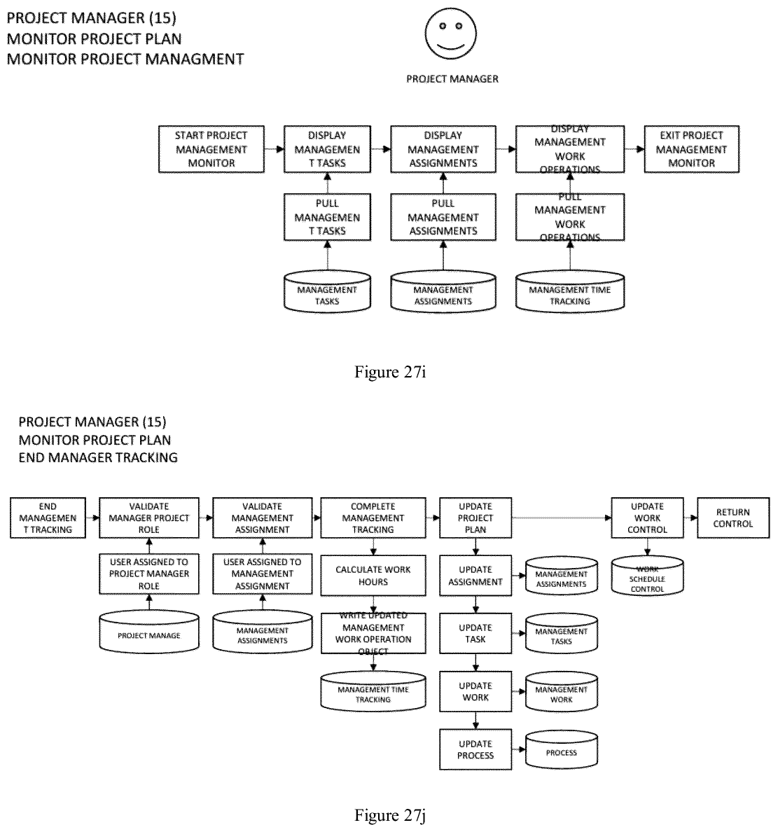

FIG. 27a illustrates a high level view of monitoring a project plan, in accordance with one embodiment.

FIG. 27b illustrates starting manager tracking, in accordance with one embodiment.

FIG. 27c illustrates monitoring a profile, in accordance with one embodiment.

FIG. 27d illustrates a monitoring a profile, in accordance with one embodiment.

FIG. 27e illustrates monitoring assessment, in accordance with one embodiment.

FIG. 27f illustrates monitoring data type certification, in accordance with one embodiment.

FIG. 27g illustrates monitoring attribute certification, in accordance with one embodiment.

FIG. 27h illustrates monitoring data modeling, in accordance with one embodiment.

FIG. 27i illustrates monitoring project management, in accordance with one embodiment.

FIG. 27j illustrates ending manager tracking, in accordance with one embodiment.

### DETAILED DESCRIPTION OF THE DISCLOSURE

The disclosure and its various features and advantageous details are explained more fully with reference to the non-limiting embodiments and examples that are described or illustrated in the accompanying drawings and detailed in the following description. It should be noted that features illustrated in the drawings are not necessarily drawn to scale, and features of one embodiment can be employed with other embodiments as those skilled in the art would recognize, even if not explicitly stated. Descriptions of well-known components and processing techniques may be omitted so as to not unnecessarily obscure the embodiments of the disclosure. The examples are intended merely to facilitate an understanding of ways in which the disclosure can be practiced and to further enable those skilled in the art to practice the embodiments of the disclosure. Accordingly, the examples and embodiments should not be construed as limiting the scope of the disclosure. Moreover, it is noted that like reference numerals represent similar parts throughout the several views of the drawings.

The present disclosure provides a system, method, and computer program for modeling unstructured data. More specifically, a data modeling solution is provided that enables classification of values within unstructured data sources. The system, method, and computer program operate at a content level. This means that the content of unstructured data is analyzed to classify it. The system extracts information from the pool of unstructured data and classifies it for analysis. Classification of data-including values, data type, class type, data class, and domain—may be saved to a data repository for further use by the system such that full classification need only be done once per value.

FIG. 1 illustrates an overview of components and steps of the modeling system, in accordance with one embodiment. Components include data type, class type, data class, and domain. Steps include classify, profile analysis, position analysis, and data quality assessment. In some embodiments, certification may also be performed. The system thus starts with a data source including at least one of unstructured, semi-structured, and structured data, and ends with classified data, which may be certified classified data.

At the most granular level, the system and method uses data types. The data types are used to identify specific data. A data modeler feeds valid values into a classification engine. The classification engine infers data constraints and identifies or creates the data type using those data constraints. The data modeler may feed additional valid values to a classification engine to maintain and update the data type's inferred data constraints. The data modeler may customize the inferred data constraints to make them appropriate for the situation The data modeler can customize the machine learned information or the automatically inferred information. The data modeler may configure additional custom data constraints for patterns, value patterns, ranges, valid values, pattern contains, value contains, pattern does not contain, value does not contain, numeric format, correct format, correct punctuation, and keywords. A classification engine will use the custom data constraints to filter the classified values and increase the accuracy of the classification results.

The data type is tied to a class type. In some embodiments, a data type may have multiple class types. A class type may have one primary data type. An example class type is gender1, with a primary data type being gender, with valid values being Male, Female, and Other. A second example class type is gender2, with a primary data type being gender abbreviations, with valid values being M, F, and O.

The class type is tied to a data class. In some embodiments, a data class may have one-to-many class types. An example would be a data class called gender, with class type of gender1 and another class type of gender2.

The data classes roll up into a domain. The domain can have one or many data classes, with the class(es) assigned to primary classes, secondary classes, and data quality classes.

FIG. 2 illustrates steps of data modeling and classification, in accordance with one embodiment. As shown, the method may include a classification step, a profile analysis step, a position analysis step, a data quality assessment step, and/or a data certification step. Each of these steps will be discussed more fully below.

In the classification step, a data source containing structured, semi-structured, and/or unstructured values is identified. These values are fed into a data classification engine for classification.

The profile analysis step and the position analysis step are verification steps in which the data modeler utilizes certain aspects of the data to confirm that it has been classified correct.

During profile analysis, the data modeler reviews frequencies of the data type. The data modeler may remove a data type and classified values, may assign the data type's classified values to another data type, and/or enforce the data type's classified values across all project values. The data modeler may access the data type's classified values to correct values and/or assign the classified values to new data types.

During position analysis, the data modeler reviews each analyzed value, with the classified values redacted with the data type name. The data modeler visually identifies overlooked and improperly classified values. The data modeler adds the overlooked values to the classified values and corrects improperly classified values. The data modeler dynamically creates and trains new data types, data classes, class types, and domains during position analysis. The data modeler identifies overlooked values without an existing data type and uses these values to create a new data type, data class, class type, and domain. The data modeler maintains existing data types by feeding overlooked values to the classification engine. The data modeler repeats this process for each analyzed value.

The data quality assessment step is used to ensure that the classified values meet an organization's standards. This may include, for example, formatting. If an organization prefers phone numbers in (xxx) xxx-xxxx format and the data classification puts phone numbers in XXX.XXX.XXXX format, this can be corrected at the data quality assessment step.

The data certification step is done by the data community. The data community roles represent data governance, data quality, data stewards, business owners, subject matter experts, and the IT custodians. The data community reviews the classified values for validity and accuracy to confirm proper classification. The data community reviews data classification against the original analyzed values to confirm whether the data classification is correct. During data certification, classification may be disputed and the data community can give input regarding the dispute. Disputes may be challenged and closed by the data community. Disputes may be approved and resolved by the project manager removing the disputed value from the classified values.

FIG. 3 illustrates a high-level overview of a data modeling solution, in accordance with one embodiment. As shown, data is provided for modeling. The data may be one or more of structured, semi-structured, and unstructured data. The data is processed by a data modeler (also referred to as a classifier), directed by a project manager, reviewed by a position classifier (also referred to as a model classifier), reviewed by a profile classifier, reviewed by an assessor, and certified by a certifier.

As shown in FIG. 3, the data modeling solution comprises a supervised machine learning algorithm. The line running from the certified repository to the classifier indicates that certified values may be used to automatically classify values in new unstructured data. The certification engine uses the certified values to automatically pre-certify values. This increases the accuracy of the classification engine and ensures that a value is only certified one time by the data community.

FIG. 4 illustrates a data security module that may be implemented with the data modeling solution, in accordance with one embodiment. As shown, the data security module includes a security solution, a data classifier (classification engine), a data redactor, and data security. Data is fed to the security module. Values are classified and values corresponding to secured data classes are redacted.

In an embodiment, the technology can be arranged to ingest, analyze and process structured, semi-structured, and unstructured values simultaneously. In this regard, the classification engine can provide an architecture that enables the technology to be able to deal with structured, semi-structured, and unstructured data. As an example of an application of the technology, it can be used to handle structured, semi-structured, and unstructured values from an email, where the email subject and the email body are unstructured and/or semi-structured values and the email from address and email from name are structured values, including analyzing and classifying values such as, for example, phone number, account number, contact name, first name, last name, email address, etc.

Data modeling and classification is shown and described with respect to specific roles. More specifically, a plurality of roles are identified wherein each of the roles analyzes and performs different levels of analysis to make sure the classification is valid, from different perspectives. It is to be appreciated that the roles may all be filled by a single user, a user may be assigned to each role, a plurality of users may be assigned to one or more roles, etc. Process flow through the roles may be done using a real time workforce management system such as disclosed herein with respect to FIGS. 24a-27j.

A system, method, and software program for real time workforce management is provided. The real time workforce management (RTWM) system enables management of projects in real time can be used to monitor progress, prevent project overrun, and properly allocate resources. Aspects of the system and method for data modelling that are described with reference to the real time workforce management system are noted with {RTWM). In alternative embodiments, these aspects may be implemented without use of the real time workforce management system.

### Classification Step

FIGS. 5a-8f illustrate aspects of data classification. In the classification step, a data source containing structured, semi-structured, and/or unstructured values is identified. These values are fed into a data classification engine for classification. Classification establishes one set of rules for a class type/These rules can be applied broadly over multiple data types and/or class types.

In some embodiments, during classification, a data modeler creates new data types. This includes creating an anchor around which unstructured data may be classified. The data types drive the entire classification process. The new data types allow classification of unstructured data. Classification may further include establishing data type classes and training the classification engine for these data type classes.

FIG. 5 illustrates a high-level overview of the process for creating and testing new data types, classes, and domains (the class types are part of the data classes), in accordance with one embodiment.

FIG. 6a illustrates a high level process flow for creating data types in accordance with one embodiment. As shown, steps in the process may include starting a modeler tracker, editing a data type, entering values, loading a certified value, creating a data type, and ending the modeler tracker.

FIGS. 6b-6i illustrate steps in creating data types.

FIG. 6b illustrates a process of creating and maintaining data types, in accordance with one embodiment. The modeler may be presented with the existing data types and can determine whether to maintain an existing or create a new data type. This figure also identifies that the modeler work is being tracked by the real-time workforce management (RTWM) solution.

FIG. 6c illustrates start of modeling tracking, in accordance with one embodiment. More specifically, FIG. 6c illustrates the process for initiating the tracking of the data modeler's work for modeling data types. This references the RTWM solution.

FIG. 6d illustrates editing of a data type, in accordance with one embodiment. More specifically, FIG. 6d illustrates an exemplary process the data modeler follows to edit an existing data type. The modeler has full access to edit metadata and data constraints manually. The modeler can maintain the data type by entering and removing values. The modeler is also able to load certified values directly from the certified repository.

FIG. 6e illustrates entering values as part of editing data type, in accordance with one embodiment. More specifically, FIG. 6e illustrates a process for feeding valid values to the classification engine to maintain the data constraints for the selected data type. The classification engine profiles each valid value to infer metadata (data constraints). The inferred metadata is then used to update the data type's metadata (data constraints). The process is repeated until all of the valid values are profiled and then the updated data type is saved.

It is to be appreciated that the system, method, and computer program maintain classification data types using a supervised machine learning process. Valid values are fed to the classification engine to add/update data constraints. This is an at least partially automated process for maintaining data types.

FIG. 6f illustrates removing values as part of editing data type, in accordance with one embodiment. This figure shows a process for feeding invalid values to the classification engine to maintain the data constraints for the selected data type. The classification engine profiles each submitted value to infer metadata (data constraints). The inferred metadata is then used to update the data type's metadata (data constraints). The process is repeated until all desired invalid values are profiled and then the updated data type is saved. This process is substantially the same as entering values except the inferred metadata is used to remove the characteristics of the submitted value from the data type's metadata (data constraints).

This supervised machine learning process maintains the classification data types by feeding values to the classification engine to remove data constraints. This is an at least partially automated process for maintaining data types.

It is to be appreciated that the system, method, and computer program create/maintain classification data types using a supervised machine learning process. Valid values are fed to the classification engine to remove data constraints. This is an at least partially automated process for maintaining data types

FIG. 6g illustrates loading certified values as part of editing data type, in accordance with one embodiment. FIG. 6g illustrates an exemplary process for feeding certified values to the classification engine to maintain the data constraints for the selected data type. The classification engine profiles each certified value to infer metadata (data constraints). The inferred metadata is then used to update the data type's metadata (data constraints). The process is repeated until all desired certified values are profiled and then the updated data type is saved.

FIG. 6h illustrates creating a data type, in accordance with one embodiment. More specifically, FIG. 6h illustrates a process for feeding valid values to the classification engine to create the data type. The classification engine profiles each valid value to infer metadata (data constraints). The inferred metadata is then used to create the metadata (data constraints) for the new data type. The process is repeated until all desired valid values are profiled and then the new data type is saved.

It is to be appreciated that the system, method, and computer program maintain classification data types using a supervised machine learning process. Valid values are fed to the classification engine to add/update data constraints. This is an at least partially automated process for creating classification data types.

FIG. 6i illustrates ending modeler tracking, in accordance with one embodiment. This figure identifies the process for completing the tracking of the data modeler's work for modeling data types. This references the RTWM solution.

FIG. 7a illustrates creating data classes, in accordance with one embodiment. This figure provides an overview of the process the data modeler follows to create and maintain a classification data class for the modeling solution. The modeler is presented with the existing data classes and determines whether to maintain an existing or create a new data class. As shown, the modeler work may be tracked by the real-time workforce management (RTWM) solution.

FIG. 7b illustrates a high level process flow for creating data classes, in accordance with one embodiment. As shown, this process may include starting modeling tracking, editing data class, managing class types, editing data class type, creating data class type, creating data class, and ending modeler tracking.

FIGS. 7c-7i illustrate steps in creating data classes.

FIG. 7c illustrates starting modeler tracking, in accordance with one embodiment. This figure identifies the process for initiating the tracking of the data modeler's work for modeling data classes. This references the RTWM solution.

FIG. 7d illustrates editing the data class, in accordance with one embodiment. This figure displays the process the data modeler follows for editing a data class. The modeler is presented with the data class metadata and determines the changes to be made and then the updated class is saved.

FIG. 7e illustrates the step of managing class types in editing data classes, in accordance with one embodiment. This figure depicts the process the data modeler follows to manage the class types. The modeler is able to edit or delete an existing class type or create a new class type.

FIG. 7f illustrates the step of editing data class types in editing data classes, in accordance with one embodiment. This figure depicts the process the data modeler follows for maintaining the class types. The modeler is able to edit all of the metadata that forms the relationship between the class type and the data type and then the updated class type is saved.

FIG. 7g illustrates the creating data class types, in accordance with one embodiment. This figure depicts the process the data modeler follows for creating the class types. The modeler is able to enter all of the metadata that forms the relationship between the class type and the data type and the new class type is saved.

FIG. 7h illustrates the creating data class, in accordance with one embodiment. This figure depicts the process that the data modeler follows for creating data classes. The data modeler enters the name and description for the new data class before making the class active, then saving the data class.

FIG. 7i illustrates ending modeler tracking, in accordance with one embodiment. This figure identifies the process for completing the tracking of the data modeler's work for modeling data classes. This references the RTWM solution.

FIG. 8a illustrates creating data domains, in accordance with one embodiment. This figure provides an overview of the process that the data modeler follows for creating and maintaining the data domains. The modeler is presented with the existing data domains and determines whether to edit an existing domain or create a new one. The figure also identifies the tracking of the data modeler's work. (RTWM).

FIG. 8b illustrates a high level process flow for creating data domains, in accordance with one embodiment. As shown, the process may include starting modeling tracking, editing data domain, creating data domain, and ending modeler tracking.

FIGS. 8c-8f illustrate steps in creating data domains.

FIG. 8c illustrates starting modeler tracking, in accordance with one embodiment. This figure identifies the process for initiating the tracking of the data modeler's work for modeling data domains. This references the RTWM solution.

FIG. 8d illustrates editing the data domain, in accordance with one embodiment. This figure identifies the process the modeler follows for editing the data domains. The modeler edits the domain's metadata, primary classes, secondary classes, data quality classes, and filters and then the data domain is saved. The domains are used to drive the values classified from unstructured values. The domains identify all of the classes to be used by the classification engine. This is why data modeling solution is also referred to as the domain search.

FIG. 8e illustrates creating the data domain, in accordance with one embodiment. This figure depicts the process the modeler follows to create a data domain. The modeler is required to enter the domain name and a description. The modeler then adds the primary classes, the secondary classes, the data quality classes, and the data filters before saving the data domain. The modeler will develop the domains to extract specific data from the unstructured data.

FIG. 8f illustrates ending modeler tracking, in accordance with one embodiment.

### Profile Analysis Step

The data modeler looks at classification from the profile and position perspective to ensure that the data has been classified correctly. The profile analysis step and the position analysis step are verification steps in which the data modeler utilizes certain aspects of the data to confirm that it has been correctly classified.

During profile analysis, the data modeler reviews frequencies of the data type. The data modeler may remove a data type and classified values, may assign the data type's classified values to another data type, and/or enforce the data type's classified values across all project values. The data modeler may access the data type's classified values to correct values and/or assign the classified values to new data types.

FIGS. 9a-9i illustrate aspects of profile analysis.

FIG. 9a illustrates a high level process flow for profile analysis, in accordance with one embodiment. As shown, this process may include one or more of starting profile tracking, displaying data type values, securing selected data type values, editing data type value frequency, enforcing data type values, completing profile analysis, and ending profile tracking.

FIG. 9b illustrates the process of profiling analysis, in accordance with one embodiment. More specifically, FIG. 9b illustrates an exemplary process that the data modeler follows to perform the profiling analysis. The first step is to validate that all of the expected data types have been classified by reviewing the data type frequencies presented. The modeler then systematically reviews the values for each model data type and validates the values are correct. The modeler is able to update, delete, and reassign the values to a new data type individually or in mass at the data type level. Once all the values for all desired data types have been validated, the modeler marks the work complete.

FIG. 9c illustrates starting profile tracking, in accordance with one embodiment. This figure identifies the process for initiating the tracking of the data modeler's profile analysis work. This references the RTWM solution.

FIG. 9d illustrates displaying data type values, in accordance with one embodiment. This figure identifies the process the data modeler follows to analyze the data types' values. The modeler accesses each data type and validates the value frequencies are valid and correct for the data type. The modeler is able to edit, delete, and reassign the value frequencies to a new data type. This gives the modeler control over the certified values during the profiling analysis.

FIG. 9e illustrates securing selected data type values, in accordance with one embodiment. This figure depicts the process that the classification engine follows to ensure that all secured data types' values are secured and redacted in the results displayed to the modeler. This capability demonstrates the control and governance over the classified values introduced by the system, method, and computer program disclosed herein.

FIG. 9f illustrates editing data type value frequency, in accordance with one embodiment. FIG. 9f illustrates the process that the data modeler follows to edit the value frequency. The first step is to assign the data type and then the value itself is edited. The modeler may need to break a value frequency into multiple values and assign different data types to each new value. When implemented, the changes are applied to each occurrence of the original value.

FIG. 9g illustrates enforcing data type values, in accordance with one embodiment. A process used during profile analysis to enforce the data type across the project is shown. The first step pulls all the project attributes and then loops through the attributes' classified values and updates every occurrence of the enforced values to the enforced data type. Next the profile classifier analyzes the original unstructured values for every attribute and searches for matches to the enforced values. Matches are added to the classification results with the enforced data type. This allows the modeler to ensure that all occurrences of the data type's values are properly classified across the entire project.

FIG. 9h illustrates completing position analysis, in accordance with one embodiment. More specifically, FIG. 9h illustrates an exemplary process implemented by the profile analysis to mark the work assignment complete and exit the profile analysis. The first step validates that the user is a data modeler assigned to the project. Next, the project assignment, task, and work for the profile analysis is updated to reflect completion. The schedule work control is updated to indicate the completion of the work assignment.

FIG. 9i illustrates ending profile tracking, in accordance with one embodiment. This figure identifies the process for completing the tracking of the data modeler's profile analysis work. This references the RTWM solution.

### Position Analysis Step

The data modeler looks at classification from the profile and position perspective to ensure that the data has been classified correctly. The profile analysis step and the position analysis step are verification steps in which the data modeler utilizes certain aspects of the data to confirm that it has been correctly classified. During position analysis, the data modeler reviews each analyzed value, with the classified values redacted with the data type name. The data modeler visually identifies overlooked and improperly classified values. The data modeler adds the overlooked values to the classified values and corrects improperly classified values. The data modeler dynamically creates and trains new data types, data classes, class types, and domains during position analysis. The data modeler identifies overlooked values without an existing data type and uses these values to create a new data type, data class, class type, and domain. The data modeler maintains existing data types by feeding overlooked values to the classification engine. The data modeler repeats this process for each analyzed value.

The modeler is also able to perform detailed analysis against the values using an analyzer. The modeler is able to import the entire unstructured value into the analyzer and then remove unwanted content to isolate the data of interest. The modeler is then able to leverage the analyzer tool to break the unstructured values into structured values and assign data types. This ability allows the modeler to correct large amounts of overlooked content very quickly.

FIG. 10a-10i illustrate aspects of position analysis. The data modeler may use the analyzer to train the machine learning algorithm.

FIG. 10a illustrates a high-level process flow for position analysis, in accordance with one embodiment. As shown, this process may include one or more of starting position tracking, building data type, loading data type, building keyword, loading keyword, locating values, building and training new keywords, securing values, viewing classified values, implementing an attribute, and completing position analysis.

FIG. 10b illustrates a model classifier, in accordance with one embodiment. More specifically, FIG. 10b illustrates the process that a data modeler follows to perform the position analysis. The modeler is first presented with the attribute row summary that identifies the number of data types and values classified for each attribute value. The modeler then reviews each attribute value and validates visually that the values have been properly classified within the unstructured value. Any values that are not classified properly are adjusted and the updates are saved. The modeler is able to run the classification engine against the current attribute value, all the attribute values, or all the project values. The modeler does this to apply the adjustments made to the modeling data types during the position analysis. The modeler is also able to mark desired completion of the position analysis at the attribute level or across all attributes. Once all the attribute values have been validated and marked complete, the modeler is able to mark the work assignment complete.

This figure also identifies that the data modeler's time is being tracked by the real-time workforce management (RTWM) solution.

FIG. 10c illustrates starting position tracking, in accordance with one embodiment. This figure identifies the process for initiating the tracking of the data modeler's position analysis work. This references the RTWM solution.

FIG. 10d illustrates displaying attribute row summary, in accordance with one embodiment. This figure demonstrates the process the classification engine follows to create the position analysis' summary report that is displayed to the data modeler. As shown, this process dynamically builds the summary information for the values classified for each attribute value.

FIG. 10e(1) identifies the process the data modeler follows to review the unstructured attribute value to identify the business values improperly classified within the unstructured value, in accordance with one embodiment. The modeler is presented with a redacted version of the attribute's unstructured value. All classified business values are redacted within the unstructured value. This allows the modeler to be able to visually determine whether the values were properly classified. The modeler is then able to add new classified values or adjust the existing classified values to correct the situation and ensure all business values are properly classified within the attribute's unstructured value. The modeler is also able to correct the situation by copying and pasting the values improperly classified into the analyzer tool to perform detail analysis. This allows the modelers to identify and implement the proper classification correction for the business values. Once all of the values with improper classifications are resolved, the modeler reviews all of the classified values for the attribute and across all attributes for the current row to validate proper classification of all the business values within the unstructured attribute value. Once satisfied, the data modeler marks the attribute modeled.

In some embodiments, the modeler is also able to toggle between the original attribute value and the redacted attribute value. This allows the modeler to visually detect values that were not properly classified.

FIG. 10e(2) identifies the process the data modeler follows to create a new data type, in accordance with one embodiment. As shown, the modeler takes the original unstructured value and uses the analyzer to reformat the unstructured value, often into multiple reformatted values. The modeler edits or removes the reformatted values and then adds new data type names, class names, class type names, and domain names for each reformatted value. The reformatted values are then used to create the new classification data type and other objects, and classify the current unstructured value using the new classification objects.

FIG. 10e(3) illustrates building a data type, in accordance with one embodiment, in accordance with one embodiment. More specifically FIG. 10e(3) illustrates the process the analyzer follows to create the new classification data types, classes, class types, and domains.

FIG. 10e(4) illustrates loading a data type, in accordance with one embodiment. More specifically FIG. 10e(4) illustrates the process the analyzer follows to create a new data type using the reformatted value.

FIG. 10e(5) illustrates creating a keyword data type, in accordance with one embodiment. More specifically FIG. 10e(5) illustrates the process the data modeler follows to create a new keyword data type. The modeler takes the original unstructured value and uses the analyzer to reformat the unstructured value. The modeler edits or removes the reformatted values and then adds the new keyword, data type names, class names, class type names, and domain names. The reformatted values and keywords are then used to create the new classification keyword data type and other objects, and classify the current unstructured value using the new classification objects.

FIG. 10e(6) illustrates creating a new classification keyword, in accordance with one embodiment. More specifically FIG. 10e(6) illustrates the process the analyzer follows to create the new classification keyword data types, classes, class types, and domains.

FIG. 10e(7) illustrates creating a new data type, in accordance with one embodiment. More specifically FIG. 10e(7) illustrates the process the analyzer follows to create a new data type using the reformatted value and keyword.

FIG. 10e(8) illustrates creating and training a new keyword data type, in accordance with one embodiment. More specifically FIG. 10e(8) illustrates the process the data modeler follows to create and train a new keyword data type using values from multiple unstructured attribute values. The modeler enters a keyword and selects analyze. The modeler then enters new classification data type name, class name, class type name, and domain name. The modeler next submits the returned values to build and train the new keyword data type. The analyzer automatically runs the classification engine and the data modeler validates that the classification results include the new keyword data type.

FIG. 10e(9) illustrates selecting valid values, in accordance with one embodiment. More specifically FIG. 10e(9) illustrates the process that the data modeler follows to supervise the selection of valid values submitted to the classification engine to create the new keyword data types.

FIG. 10e(10) illustrates building and training a new keyword, in accordance with one embodiment. More specifically FIG. 10e(10) illustrates the process that the analyzer follows to build and train a new classification data type and create the corresponding new classification data class, class type, and domains as directed.

FIG. 10e(11) illustrates training a new keyword, in accordance with one embodiment. More specifically FIG. 10e(11) illustrates the process that the analyzer follows to process each submitted value and keyword to create the new keyword data types.

FIG. 10f illustrates securing redacted row value, in accordance with one embodiment. More specifically FIG. 10f illustrates the process that the classification engine follows to ensure that all secured data types' values are secured and redacted in the results displayed to the modeler. This capability demonstrates the control and governance over the classified values provided by the system, method, and computer program disclosed herein.

FIG. 10g illustrates securing base row value, in accordance with one embodiment. FIG. 10g shows an exemplary process that the classification engine follows to ensure that all secured data types' values are secured and redacted in the results displayed to the modeler. This capability demonstrates the control and governance over the classified values provided by the system, method, and computer program disclosed herein.

FIG. 10h illustrates classifying a new value, in accordance with one embodiment. More specifically, FIG. 10h illustrates the process the data modelers follow to manually classify a new value. The modeler selects the new value button and then copies and pastes the new value into the receiving field. The modeler then assigns a modeling data type to the value. The modeler has the ability to then apply the new classification to the current attribute value, all the attribute's values, or all the project's values.

FIG. 10i illustrates securing a classified value, in accordance with one embodiment. More specifically, FIG. 10i illustrates the process that the classification engine follows to ensure that all secured data types' values are secured and redacted in the results displayed to the modeler. This capability demonstrates the absolute control and governance over the classified values the solution introduces.

FIG. 10j illustrates implementing a new classified value for the attribute, in accordance with one embodiment. More specifically, FIG. 10j illustrates the process the classification engine follows to implement the new classified value across all the attribute's unstructured values.

FIG. 10k illustrates implementing a new classified value, in accordance with one embodiment. More specifically, FIG. 10k illustrates the process the classification engine follows to implement the new classified value across all the project's unstructured values.

FIG. 10l illustrates analyzing a set of values, in accordance with one embodiment. More specifically, FIG. 10l illustrates the process the data modeler follows to analyze a set of values from the attribute's unstructured values. The modeler copies and pastes the values into the analyzer and selects the analyze button. This automatically breaks the values into individual values that the modeler then analyzes, corrects problems, and assigns modeling data types to. The analyzer allows the modeler to manually classify several one-to-many values at a time, saving the time necessary to manually classify the values individually. The modeler is then able to implement for just the current attribute value, across all the attribute's values, or across all the project's values.

FIG. 10m illustrates implementing newly classified values, in accordance with one embodiment. More specifically, FIG. 10m illustrates the process the classification engine follows to implement the newly classified value(s) against the current attribute value, all the attribute's values, or all the project's values.

FIG. 10n illustrates reviewing classified values, in accordance with one embodiment. More specifically, FIG. 10n illustrates an exemplary process a data modeler may follow to review the classified values for the current attribute value. The modeler is able to review all the unsecured values to validate proper classification. The modeler is able to delete or exclude specific classified values as appropriate.

FIG. 10o illustrates securing classified values, in accordance with one embodiment. More specifically, FIG. 10o illustrates the process that the classification engine follows to ensure that all secured data types' values are secured and redacted in the results displayed to the modeler. This capability demonstrates the absolute control and governance over the classified values the solution introduces.

FIG. 10p illustrates applying values, in accordance with one embodiment. FIG. 10p shows a process the data modeler may follow to classify an individual value and apply it to the current attribute value, all the attribute's values, or across all the project's values.

FIG. 10q illustrates analyzing classified values, in accordance with one embodiment. FIG. 10q shows a process the data modeler may follow to analyze all of the classified values from all the attributes for the current row of data. This allows the modeler to determine if everything is classified properly across all the current row's attributes.

FIG. 10r illustrates securing data, in accordance with one embodiment. FIG. 10r shows a process that the classification engine may follow to ensure that all secured data types' values are secured and redacted in the results displayed to the modeler. This capability demonstrates the absolute control and governance over the classified values the solution introduces.

FIGS. 10s(1), 10s(2), and 10s(3) illustrate classifying values within an unstructured value, in accordance with one embodiment. These figures illustrate the process the classification engine executes to classify values within an unstructured value. This process is substantially the same as the other described processes for classifying values within an unstructured value because the processes use the same classification engine.

FIGS. 10s(1), 10s(2), and 10s(3) illustrate the process executed by the classification engine to classify values within the submitted unstructured value. The classification engine first identifies the pattern for the submitted unstructured value and then compresses the pattern. The classification engine then searches against the compressed pattern for the unstructured value using the compressed patterns from the modeling data types identified by the submitted data domains' primary classes. The value for a matched compressed pattern is extracted from the unstructured value and then validated using the data constraints from the matched data type. Values that pass the data constraint validation are now classified and redacted from the original search value and the process is repeated until all the primary classes are processed. The process repeats for the secondary classes and then the data quality classes from the submitted data domains. The classified values are then returned to the caller.

FIG. 10t illustrates completing position analysis, in accordance with one embodiment. FIG. 10t illustrates the process implemented by the position analysis to mark the work assignment complete and exit the position analysis. The first two steps validate that all of the attribute's values have been marked as modeled and the user is a data modeler assigned to the project. Next, the project assignment, task, and work for the current attribute are updated to reflect completion. The schedule work control is updated to indicate the completion of the work assignment.

FIG. 10u illustrates ending position tracking, in accordance with one embodiment. FIG. 10u identifies the process for completing the tracking of the data modeler's position analysis work. This references the RTWM solution.

### Data Quality Assessment Step

FIGS. 11a-11s and 12a-12s illustrate aspects of data quality assessment. The data quality team reviews the classification and analyzes whether the classifications meets an organization's standards. More specifically a data quality analyst is going to measure the data against the data quality standards of the organization. For example, if the organization uses XX/XX/XXXX as date format, the data quality analyst will correct data formats having the date as XX/XX/XX.

FIGS. 11a-11s illustrate the process followed by a data quality analyst. FIGS. 12a-12s illustrate the process followed by a data quality lead.

FIG. 11a illustrates aspects of a data quality assessment step, in accordance with one embodiment. More specifically, FIG. 11a illustrates an exemplary process that the data quality analyst follows to assess the quality of the classification results. The analyst is presented with the row summary and systematically reviews the classified values for each unstructured value for the attribute and then marks the row reviewed. The analyst is able to classify selected or all of the attribute's unstructured values as needed. The analyst is able to mark all of the attribute's values as reviewed when appropriate and complete the assessment for the attribute.

FIG. 11a further identifies that the analyst's time is being tracked by the real-time workforce management (RTWM) solution.

FIG. 11b illustrates a high-level process flow for the data quality assessment, in accordance with one embodiment. As shown, the process may include one or more of the following steps: start assess analyst tracking, secure base value, secure redacted value, view classified values, secure classified values, secure classified attributes, classify unstructured value, and complete analyst assessment.

FIG. 11c illustrates starting analyst tracking, in accordance with one embodiment. FIG. 11c illustrates the process for initiating the tracking of the data quality analyst's assessment work. This references the RTWM solution.

FIG. 11d illustrates creating assessments, in accordance with one embodiment. More specifically, FIG. 11d illustrates a process the classification engine may follow to create the assessments attribute summary information that is displayed to the data quality analyst. As shown, the process dynamically builds summary information for values classified for each attribute value.

FIG. 11e illustrates reviewing unstructured attribute values, in accordance with one embodiment. More specifically, FIG. 11e illustrates an exemplary process the data quality analyst follows to review the unstructured attribute value to identify the business values improperly classified within the unstructured value. The analyst is able to toggle between the original unstructured attribute value and a redacted version. All classified business values are redacted within the unstructured value with the data type name, allowing the analyst to visually determine whether the values were properly classified. The analyst is then able to add new classified values or adjust the existing classified values to correct the situation and ensure all business values are properly classified within the attribute's unstructured value. The analyst reviews all of the classified values for the attribute and across all attributes to validate the values meet the organization's data quality standards. Once satisfied, the data quality analyst marks the attribute's value as reviewed.

FIG. 11f illustrates securing base row values, in accordance with one embodiment. FIG. 11f illustrates the process that the classification engine follows to ensure that all secured data types' classified values are secured and redacted in the results displayed to the analyst. This capability demonstrates the control and governance over the classified values the solution introduces.

FIG. 11g illustrates securing redacted row values, in accordance with one embodiment. FIG. 11g illustrates a process that the classification engine follows to ensure that all secured data types' values are secured and redacted in the results displayed to the analyst. This capability demonstrates the control and governance over the classified values the solution introduces.

FIG. 11h illustrates classifying a new value, in accordance with one embodiment. FIG. 11h illustrates a process a data quality analyst follows to manually classify a new value. The analyst selects the new value button and then copies and pastes the new value into the receiving field. The analyst then assigns a modeling data type to the value. The analyst has the ability to then apply the new classification to the current attribute value, all the attribute's values, or all the project's values.

FIG. 11i illustrates securing classified values, in accordance with one embodiment. FIG. 11i illustrates a process that the classification engine follows to ensure that all secured data types' values are secured and redacted in the results displayed to the analyst. This capability demonstrates the control and governance over the classified values the solution introduces.

FIG. 11j illustrates implementing a new classified value, in accordance with one embodiment. FIG. 11j illustrates a process the classification engine follows to implement the new classified value across all the attribute's unstructured values.

FIG. 11k illustrates implementing a new classified value, in accordance with one embodiment. FIG. 11k depicts a process the classification engine follows to implement the new classified value across all the project's unstructured values.

FIG. 11l illustrates reviewing classified values, in accordance with one embodiment. FIG. 11l illustrates a process that the analyst follows to review the classified values for the current attribute value. The analyst is able to review all the unsecured values to validate proper classification. The analyst can choose to delete or exclude specific classified values as appropriate.

FIG. 11m illustrates securing classified values, in accordance with one embodiment. FIG. 11m illustrates a process that the classification engine follows to ensure that all secured data types' values are secured and redacted in the results displayed to the analyst. This capability demonstrates the control and governance over the classified values the solution introduces.

FIG. 11n illustrates classifying and applying an individual value, in accordance with one embodiment. FIG. 11n illustrates a process the data quality analyst follows to classify an individual value and apply it to the current attribute value, all the attribute's values, or across all the project's values.

FIG. 11o illustrates analyzing classified values, in accordance with one embodiment. FIG. 11o illustrates a process the analyst follows to analyze classified values from the attributes for the current row of data. This allows the analyst to determine if everything is classified properly across all the current row's attributes.

FIG. 11p illustrates securing classified attributes, in accordance with one embodiment. FIG. 11p illustrates a process that the classification engine follows to ensure that all secured data types' values are secured and redacted in the results displayed to the analyst. This capability demonstrates the control and governance over the classified values the solution introduces.

FIGS. 11q(1), 11q(2), and 11q(3) illustrate classifying values within an unstructured value, in accordance with one embodiment. These figures illustrate the process the classification engine executes to classify values within an unstructured value. This process is substantially the same as the other described processes for classifying values within an unstructured value because the processes use the same classification engine.

FIGS. 11q(1), 11q(2), and 11q(3) identify a process executed by the classification engine to classify values within the submitted unstructured value. The classification engine first identifies the pattern for the submitted unstructured value and then compresses the pattern. The classification engine then searches against the compressed pattern for the unstructured value using the compressed patterns from the modeling data types identified by the submitted data domains' primary classes. The value for a matched compressed pattern is extracted from the unstructured value and then validated using the data constraints from the matched data type. Values that pass the data constraint validation are now classified and redacted from the original search value and the process is repeated until all the primary classes are processed.

As shown, this process may be repeated for the secondary classes and then the data quality classes from the submitted data domains. The classified values are then returned to the caller.

FIG. 11r illustrates completing the analyst assessment, in accordance with one embodiment. More specifically, FIG. 11r illustrates a process implemented by the assessment analysis to mark the work assignment complete and exit the assessment analysis. The first two steps validate that all the attribute's values have been marked as reviewed and the user is an analyst assigned to the project. Next, the project assignment, task, and work for the current attribute are updated to reflect completion. The schedule work control is updated to indicate the completion of the work assignment.

FIG. 11s illustrates ending analyst tracking, in accordance with one embodiment. FIG. 11s illustrates a process for completing the tracking of the assessment work completed by the analyst. This references the RTWM solution.

FIGS. 12a-12s illustrate the process followed by a data quality lead.

FIG. 12a illustrates aspects of the data quality assessment step, in accordance with one embodiment. More specifically, FIG. 12a illustrates a process that the data quality lead can follow to assess the quality of the classification results. The lead is presented with the row summary and systematically reviews the classified values for each unstructured value for the attribute and then marks the row reviewed. The lead is able to classify selected or all of the attribute's values as needed. The lead is able to mark all of the attribute's values as reviewed when appropriate and complete the assessment for the attribute.

This figure also identifies that the data quality lead's time is being tracked by the real-time workforce management (RTWM) solution.

FIG. 12b illustrates a high-level process flow for data quality assessment by a data quality lead, in accordance with one embodiment. As shown, the process may include one or more of the following steps: start assess lead tracking, secure base value, secure redacted value, view classified value, secure classified value, view classified analysis, secure classified values, secure classified attributes, classify unstructured value, and complete lead assessment.

FIG. 12c illustrates starting lead tracking, in accordance with one embodiment.

FIG. 12c illustrates the process for initiating tracking of work completed by the data quality lead. This references the RTWM solution.

FIG. 12d illustrates creating the assessment's attribute summary information, in accordance with one embodiment. More specifically, FIG. 12d illustrates a process the classification engine can follow to create the assessment's attribute summary information that is displayed to the data quality lead. As the figure indicates, this process dynamically builds the summary information for the values classified for each unstructured attribute value.

FIG. 12e illustrates reviewing unstructured attribute value, in accordance with one embodiment. More specifically, FIG. 12d illustrates a process the data quality lead may follow to review the unstructured attribute value to identify the business values improperly classified within the unstructured value. The lead is able to toggle between the original unstructured attribute value and a redacted version. Classified business values are redacted within the unstructured value, allowing the lead to visually determine whether the values were properly classified. The lead is then able to add new classified values or adjust the existing classified values to correct the situation and ensure all business values are properly classified within the attribute's unstructured value. The lead reviews all of the classified values for the attribute and across all the row's attributes to validate the values meet the organization's data quality standards. Once satisfied, the data quality lead marks the attribute's value reviewed.

FIG. 12f illustrates securing the base value, in accordance with one embodiment. FIG. 12f illustrates a process that the classification engine follows to ensure that all secured data types' values are secured and redacted in the results displayed to the lead. This capability demonstrates the control and governance over classified values the solution introduces.

FIG. 12g illustrates securing redacted value, in accordance with one embodiment. FIG. 12g illustrates a process that the classification engine may follow to ensure that secured data types' values are secured and redacted in the results displayed to the lead. This capability demonstrates the absolute control and governance over the classified values the solution introduces.

FIG. 12h illustrates classifying a new value, in accordance with one embodiment. More specifically, FIG. 12h illustrates a process the data quality lead may follow to manually classify a new value. The lead selects the new value button and then copies and pastes the new value into the receiving field. The lead then assigns a modeling data type to the value. The lead has the ability to then apply the new classification to the current attribute value, all the attribute's values, or all the project's values.

FIG. 12i illustrates securing classified values, in accordance with one embodiment. More specifically, FIG. 12i illustrates a process that the classification engine may follow to ensure that secured data types' values are secured and redacted in the results displayed to the lead. This capability demonstrates the absolute control and governance over the classified values the solution introduces.

FIG. 12j illustrates implementing a new classified value, in accordance with one embodiment. FIG. 12j illustrates a process the classification engine may follow to implement the new classified value across all the project's unstructured values.

FIG. 12k illustrates implementing a new classified value, in accordance with one embodiment. FIG. 12k illustrates a process the classification engine may follow to implement the new classified value across all the attribute's unstructured values.

FIG. 12l illustrates reviewing classified values, in accordance with one embodiment. FIG. 12l illustrates a process that a lead may follow to review the classified values for the current attribute value. The lead is able to review all the unsecured values to validate proper classification. The lead is also able to delete or exclude specific classified values as appropriate.

FIG. 12m illustrates securing classified values, in accordance with one embodiment. More specifically, FIG. 12m illustrates a process that the classification engine may follow to ensure that secured data types' values are secured and redacted in the results displayed to the lead. This capability demonstrates the control and governance over the classified values the solution introduces.

FIG. 12n illustrates applying a classified value, in accordance with one embodiment. FIG. 12n illustrates a process the data quality lead follows to classify an individual value and apply it to the current attribute value, all the attribute's values, or across all the project's values.

FIG. 12o illustrates analyzing classified values, in accordance with one embodiment. FIG. 12o illustrates a process a lead may follow to analyze all of the classified values from all the attributes for the current row of data. This allows the lead to determine if everything is classified properly across all the current row's attributes.

FIG. 12p illustrates securing classified attributes, in accordance with one embodiment. FIG. 12b illustrates the process that the classification engine follows to ensure that all secured data types' values are secured and redacted in the results displayed to the lead. This capability demonstrates the absolute control and governance over the classified values the solution introduces.

FIGS. 12q(1), 12q(2), and 12q(3) illustrate classifying values within an unstructured value, in accordance with one embodiment. These figures illustrate the process the classification engine executes to classify values within an unstructured value. This process is substantially the same as the other described processes for classifying values within an unstructured value because the processes use the same classification engine.

FIGS. 12q(1), 12q(2), and 12q(3) illustrate the process executed by the classification engine to classify values within the submitted unstructured value. The classification engine first identifies the pattern for the submitted unstructured value and then compresses the pattern. The classification engine then searches against the compressed pattern for the unstructured value using the compressed patterns from the modeling data types identified by the submitted data domains' primary classes. The value for a matched compressed pattern is extracted from the unstructured value and then validated using the data constraints from the matched data type. Values that pass the data constraint validation are now classified and redacted from the original search value and the process is repeated until all the primary classes are processed.

As indicated in the figure, this process is repeated for the secondary classes and then the data quality classes from the submitted data domains. The classified values are then returned to the caller.

FIG. 12r illustrates completing lead assessment, in accordance with one embodiment. More specifically, FIG. 12r illustrates a process implemented by the assessment analysis to mark the work assignment complete and exit the assessment analysis. The first two steps validate that all the attribute's values have been marked as “reviewed” and the user is a lead assigned to the project. Next, the project assignment, task, and work for the current attribute are updated to reflect completion. The schedule work control is updated to indicate the completion of the work assignment.

FIG. 12s illustrates ending lead tracking, in accordance with one embodiment. FIG. 12s identifies the process for completing the tracking of the assessment work completed by the lead. This references the RTWM solution.

FIGS. 13a-13r and 14a-14m illustrate aspects of data certification. The data certification step may be done by the data community. The data community roles represent data governance, data quality, data stewards, business owners, subject matter experts, and the IT custodians. The data community reviews the classified values for validity and accuracy to confirm proper classification. The data community reviews data classification against the original analyzed values to confirm whether the data classification is correct. During data certification, classification may be disputed and the data community can give input regarding the dispute. Disputes may be challenged and closed by the data community. Disputes may be approved and resolved by the project manager removing the disputed value from the classified values. The data community certifies the results and validates that they are correct.

FIG. 13a illustrates aspects of certifying data types, in accordance with one embodiment. More specifically, FIG. 13a illustrates a process the certifier may follow to review the classified values and pre-certified values for each data type. Once satisfied the classified values are valid, the certifier marks the data type certified. When all the desired data types have been certified, the certifier completes the data type certification.

This figure also illustrates that the certifier's time may be tracked by the real-time workforce management (RTWM) solution.

FIG. 13b-13r illustrate aspects of certifying data.

FIG. 13b illustrates a high level process of certifying data. As shown, the process may include one or more of the steps of: data community certifies classified values, open a dispute, and data community resolves an approved dispute. FIG. 13c illustrates aspects of data certification, in accordance with one embodiment. FIG. 13c illustrates an overview of the process the data community follows to certify data and publish the certified results for use.

FIG. 13d illustrates publishing certified results for data modeling, in accordance with one embodiment. FIG. 13d illustrates an overview of the process followed by the data community to certify data and publish the certified results for use specific to the data modeling solution

FIG. 13e illustrates certifying classified values, in accordance with one embodiment. FIG. 13e illustrates an overview of a process that may be followed by the data community to certify data at the attribute and data type levels. FIG. 13e illustrates that the data community disputes and resolves disputes amongst themselves by approving or challenging disputes.

FIG. 13f illustrates resolving approved disputes, in accordance with one embodiment. FIG. 13f illustrates a process the project manager follows to resolve approved disputes. The project manager will first review the disputes and then runs the job to resolve the disputes.

FIG. 13g-13r illustrate data type certification. FIG. 14a-14m illustrate attribute certification.

FIG. 13g illustrates a high level process flow for data type certification, in accordance with one embodiment. The process may include one or more of starting certify types tracking, selecting data type to review, securing data type certification value frequencies, saving dispute, saving challenge dispute, selecting pre-certified data type to review, securing data type pre-certified value frequencies, saving pre-certified data type dispute, certifying data type, and completing data type certification. FIG. 13h illustrates starting certifying tracking, in accordance with one embodiment. FIG. 13h illustrates a process for initiating the tracking of the certification work completed by the certifier. This references the RTWM solution.

FIG. 13i illustrates selecting data types to review, in accordance with one embodiment. More specifically, FIG. 13i illustrates a process the certifier may follow for each data type. The certifier reviews each of data type's values for validity. The certifier is able to dispute values and view disputes identified by other certifiers to either agree or challenge the disputes.

FIG. 13j illustrates securing data types values, in accordance with one embodiment. More specifically, FIG. 13j illustrates a process that the certification application follows to ensure that all secured data types' values are secured and redacted in the results displayed to the certifier. This capability demonstrates the absolute control and governance over the classified values the solution introduces.

FIG. 13k illustrates saving a dispute, in accordance with one embodiment. FIG. 13k illustrates a process that the certification application follows to save a dispute. The first step is to identify the certifier's roles and then set the dispute indicator for each role to the certifier with the date and timestamp. The dispute is then written to file.

FIG. 13l illustrates saving a dispute challenge, in accordance with one embodiment. FIG. 13l illustrates a process that the certification application follows to save a dispute challenge. The first step is to identify the certifier's roles and then set the challenge indicator for each role to the certifier with the date and timestamp. The dispute is then written to file.

FIG. 13m illustrates the certification process for pre-certified values, in accordance with one embodiment. FIG. 13m illustrates a certification process that the certifier follows to review the pre-certified values for the data type. The certifier validates the pre-certified values for the data type. The certifier is able to dispute the pre-certified values and view disputes identified by other certifiers to either approve or challenge the disputes.

FIG. 13n illustrates securing data types, in accordance with one embodiment. FIG. 13n illustrates a process that the certification application follows to ensure that secured data types' values are secured and redacted in the results displayed to the certifier. This capability demonstrates the absolute control and governance over the classified values the solution introduces.

FIG. 13o illustrates saving a dispute for a pre-certified value, in accordance with one embodiment. FIG. 13o illustrates a process that the certification application follows to save a dispute for a pre-certified value. The first step is to identify the certifier's roles and then set the dispute indicator for each role to the certifier with the date and timestamp. The dispute for the pre-certified value is then written to file.

FIG. 13p illustrates aspects of certifying a data type, in accordance with one embodiment. More specifically, FIG. 13p illustrates a process the certification application follows to certify a data type. The first step is to validate there are no active disputes for the data type's values and no active disputes against the data type's pre-certified values. Next, the roles for the certifier are pulled and used to mark each of the data type's values certified for each of the certifier's roles with the certifier's name and the current date and timestamp.

FIG. 13q illustrates completing data type certification, in accordance with one embodiment. More specifically, FIG. 13q illustrates a process the certification application follows to complete the certification for the data types. The first step is to validate that all of the data types have been certified. The next step is to pull the certifier's roles and update the data type's certification indicators for each of the certifier's roles with the date and timestamp. The updated certification data type is written back to file and the work control is updated and written to file.

FIG. 13r illustrates ending certifying of data types, in accordance with one embodiment. FIG. 13r identifies a process for completing the tracking of the certification work completed by the certifier. This references the RTWM solution.

FIGS. 14a-14m illustrate attribute certification.

FIG. 14a illustrates aspects of certifying attributes, in accordance with one embodiment. More specifically, FIG. 14a illustrates a process that the certifier follows to certify the values for an attribute. The certifier systematically reviews the classified values and the pre-certified values for each attribute. This process is repeated until all of desired values are certified for all of the desired attributes. Once finished, the certifier marks the attribute certified.

FIG. 14a further illustrates that the certifier's time may be tracked by the real-time workforce management (RTWM) solution.

FIG. 14b illustrates a high level process flow for attribute certification, in accordance with one embodiment. As shown, the process may include one or more of the following: start certify tracking, select attribute to review, secure attribute certification types, save dispute, save challenge dispute, select pre-certified attribute to review, secure attribute pre-certified types, save pre-certified attribute dispute, certify attribute, and complete attribute certification. FIG. 14c illustrates starting certify tracking, in accordance with one embodiment. FIG. 14c illustrates a process for initiating the tracking of the certification work completed by a certifier. This references the RTWM solution.

FIG. 14d illustrates aspects of certifying attributes, in accordance with one embodiment. More specifically, FIG. 14d illustrates a process that a certifier may follow to review the values for an attribute. The certifier is first presented with the values to review for validity and proper classification. Values that are invalid or mis-classified are disputed. The dispute identifies the value, the reason for the dispute, disputer, and tracks approvals or challenges. The certifier will review disputes identified by other certifiers and either approve or challenge the disputes. The disputes are saved and made available to the rest of the data community for review. This process defines a closed system the certifiers use to govern the classified values. This process ensures the data community is able to govern the classified data without interference.

FIG. 14e illustrates aspects of securing attributes, in accordance with one embodiment. FIG. 14e illustrates a process that the certification application may follow to ensure that all secured data types' values are secured and redacted in the results displayed to the certifier. This capability demonstrates the absolute control and governance over the classified values the solution introduces.

FIG. 14f illustrates saving a dispute, in accordance with one embodiment. FIG. 14f illustrates a process that the certification application follows to save disputes. The first step is to identify the roles for the certifier and then set the dispute indicators for the certifier's roles with the certifier name, current date, and timestamp. The dispute is then written to file.

FIG. 14g illustrates saving a dispute challenge, in accordance with one embodiment. More specifically, FIG. 14g illustrates a process that the certification application follows to save dispute challenges. The first step is to identify the roles for the certifier and then set the challenge indicators for the certifier's roles with the certifier name, the current date, and timestamp. The updated dispute is then written to file.

FIG. 14h illustrates reviewing pre-certified values, in accordance with one embodiment. FIG. 14h illustrates a process a certifier follows to review the pre-certified values. The certifier is presented with the pre-certified values to review. The certifier is able to dispute the pre-certified values, when appropriate.

FIG. 14i illustrates securing data types values, in accordance with one embodiment. FIG. 14i illustrates a process that the certification application follows to ensure that secured data types' values are secured and redacted in the results displayed to the certifier. This capability demonstrates the control and governance over the classified values the solution introduces.

FIG. 14j illustrates saving disputes for pre-certified attribute values, in accordance with one embodiment. More specifically, FIG. 14j illustrates a process the certification application follows to save disputes for pre-certified attribute values. The first step is to identify the roles for the certifier and then set the dispute indicators for the certifier's roles with the certifier name, the current date, and timestamp. The pre-certified dispute is then written to file.

FIG. 14k illustrates aspects of certifying an attribute, in accordance with one embodiment. More specifically, FIG. 14k illustrates a process the certification application follows to certify an attribute. The first step is to validate there are no active disputes or pre-certified disputes. Next, identify the roles for the certifier and then set the attribute certification indicators for the certifier's roles with the certifier name, the current date, and timestamp. The updated attribute certification may then be written to file.

FIG. 14l illustrates completing attribute certification, in accordance with one embodiment. More specifically, FIG. 14l illustrates a process the certification application follows to complete the attribute certification. The first step validates that all of the data types have been certified by the certifier. Next, identify the roles for the certifier and then set the attribute certification indicators for the certifier's roles with the certifier name, the current date, and timestamp. The updated attribute certification may then be written to file.

FIG. 14m illustrates ending certify tracking, in accordance with one embodiment. FIG. 14m illustrates a process for completing the tracking of the certification work completed by the certifier. This references the RTWM solution.

### Classification Engine

The classification engine drives classification using the system, method, and computer program described above. In various embodiments, the system, method, and computer program may be configured to ingest, analyze and process structured, semi-structured, and unstructured values simultaneously. In this regard, the classification engine can provide an architecture that enables the technology to be able to deal with structured, semi-structured, and unstructured data. As an example of an application of the technology, it can be used to handle structured, semi-structured, and unstructured values from an email, where the email subject and the email body are unstructured and/or semi-structured values and the email from address and email from name are structured values, including analyzing and classifying values such as, for example, phone number, account number, contact name, first name, last name, email address, etc.

FIG. 15a-15 (j) 3 illustrate aspects of a classification engine and testing of a classification engine, in accordance with one embodiment.

FIG. 15a illustrates a high level process flow of the classification engine, in accordance with one embodiment. As shown, the process may include one or more of the following steps: identify, classify structured value, select validate, view correction, classify, base classify unstructured value, search, and classify unstructured value. FIG. 15b illustrates an aspect of the classification system, in accordance with one embodiment. It can be useful for the data modeler to be able to test the classification system. The data modeler is thus provided with the testing center to test the data domains and the associated classes. This figure identifies that the modeler is able to test data quality types (identify), data model types (classify), and data domains (search). The modeler selects which test to run.

FIG. 15c illustrates a process used to identify types, in accordance with one embodiment. More specifically, FIG. 15c illustrates a process the data modeler follows to test data quality types. The data modeler enters the value to test and selects the identify type button. The classification engine is then run to classify the value and returns the inferred data type. The modeler is also able to test the data type's ability to validate the value by selecting a data quality class and class type and selecting the validate button. Next, the modeler is able to correct invalid content by selecting the view correction button to run the classification engine to automatically correct the invalid value.

This primarily solves overloaded values; meaning the value has more information than it should. An example would be expecting the value to be a city, but instead the value contains a city, state, and zip code. The classification engine is capable of extracting the city to correct the situation. In general, the data modeler may be testing that the classification engine identifies the value's data quality data type correctly.

FIG. 15d illustrates a classifying structured value, in accordance with one embodiment. FIG. 15d illustrates process used by the classification engine to classify a value's data quality data type. U.S. patent application Ser. No. 63/363,970 for SYSTEM AND METHOD FOR CREATING RELATIONAL AND NON-RELATIONAL DATABASES FROM STRUCTURED AND UNSTRUCTURED DATA SOURCES, filed on May 2, 2022, provides further detail on validation and is hereby incorporated by reference in its entirety.

FIG. 15e illustrates validating a value, in accordance with one embodiment. More specifically, FIG. 15e illustrates a process used by the classification engine to validate the value submitted by the data modeler. The submitted value's pattern is identified and then compressed. The compressed pattern is then compared to valid compressed patterns for the data type. The status is returned to indicate whether the value passed or failed the validation. U.S. patent application Ser. No. 63/363,970 for SYSTEM AND METHOD FOR CREATING RELATIONAL AND NON-RELATIONAL DATABASES FROM STRUCTURED AND UNSTRUCTURED DATA SOURCES, filed on May 2, 2022, provides further detail on validation and is hereby incorporated by reference in its entirety.

FIG. 15f illustrates identifying a correction, in accordance with one embodiment. FIG. 15f illustrates a process followed by the classification engine to identify the correction to the invalid value submitted. U.S. patent application Ser. No. 63/363,970 for SYSTEM AND METHOD FOR CREATING RELATIONAL AND NON-RELATIONAL DATABASES FROM STRUCTURED AND UNSTRUCTURED DATA SOURCES, filed on May 2, 2022, provides further detail on validation and is hereby incorporated by reference in its entirety.

FIG. 15g illustrates testing modeling data types, in accordance with one embodiment. FIG. 15g illustrates the process the modeler uses to test the modeling data types. The modeler enters an unstructured value and selects any filters required. The modeler then selects the classify data button.

The classification engine is run and returns all the values classified by the model data types. This is used primarily to test the data modeling data types against unstructured values.

FIG. 15h illustrates classifying values within an unstructured value, in accordance with one embodiment. More specifically, FIG. 15h illustrates a process executed by the classification engine to classify values within the unstructured value. As shown, the pattern is identified for the submitted value and then compressed. The compressed pattern is then searched against using the compressed patterns from the modeling data types. When a modeling data type's compressed pattern is found, the data constraints for the data type are applied to validate the value meets the constraints. When the value passes the data constraints, it is classified and returned for display. This process is repeated for all of the modeling data types.

FIG. 15i illustrates testing data domains, in accordance with one embodiment. More specifically, FIG. 15i illustrates a process that the data modeler follows for testing data domains using the classification engine. The search testing is used by the modeler to prepare the data classes for use with the data modeling solution. The search testing literally uses the same classification engine used by the data modeling solution. This allows the modeler to fully test the model data class.

The modeler enters an unstructured value, selects the data domains to test, and selects the search button. The classification engine then is then run using the data domains to identify the data to classify from within the unstructured value. The engine returns the classified values for the modeler to validate.

The search testing center allows the modeler to fully test all of the modeling data classes extensively prior to use with the modeling solution.

FIGS. 15j(1), 15j(2), and 15j(3) illustrates classifying values within a submitted unstructured value, in accordance with one embodiment. These figures identify the process executed by the classification engine to classify values within the submitted unstructured value. The classification engine first identifies the pattern for the submitted unstructured value and then compresses the pattern. The classification engine then searches against the compressed pattern for the unstructured value using the compressed patterns from the modeling data types identified by the submitted data domains' primary classes. The value for a matched compressed pattern is extracted from the unstructured value and then validated using the data constraints from the matched data type. Values that pass the data constraint validation are now classified and redacted from the original search value and the process is repeated until all the primary classes are processed.

As shown in FIGS. 15j(1), 15j(2), and 15j(3), this process may be repeated for the secondary classes and then the data quality classes from the submitted data domains. The classified values are then returned for the modeler to validate in the testing center.

### Certified Repository

The system may comprise an certified repository having one or more databases of certified classification results, or certified values may be used to classify values in new unstructured values. For example, returning to FIG. 3, the line running from the certified repository to the classifier indicates that certified values may be used to automatically classify values in new unstructured data. This increases the accuracy of the classification engine and ensures that a value is only certified one time by the data community.

FIG. 16a-16m illustrates aspects of a certified repository, in accordance with one embodiment.

FIG. 16a illustrates a high level process flow of modeling, building, and maintaining a certified repository. The process may include one or more of: starting modeler tracking, securing certified data type values, securing search data type values, securing certified class values, securing searching class values, securing aggregate values, building search data types, building certified classes, building search class, building aggregate, and ending modeler tracking.

FIGS. 16b(1), 16b(2), and 16b(3) illustrate aspects of building a certified repository, in accordance with one embodiment. More specifically, FIGS. 16b(1), 16b(2), and 16b(3) identify a process that the data modeler follows to model (build and maintain) certified and search data types and classes, and the aggregates. This allows the modeler to create new search data types using the certified data types. The modeler creates corresponding certified and search classes for each of the data types. The modeler is then able to create aggregates that utilize the certified and search classes to consolidate data types together (similar concept to the SQL table).

FIGS. 16b(1), 16b(2), and 16b(3) further illustrate that the modeler is able to view and delete the certified and search data types, classes, and aggregates. The modeler maintains the certified and search objects using these capabilities.

As shown, the data modeler's time may be tracked by the real-time workforce management (RTWM) solution.

FIG. 16c illustrates starting modeler tracking, in accordance with one embodiment. FIG. 16c illustrates a process for initiating the tracking of the modeling work completed by the data modeler. This references the RTWM solution.

FIG. 16d illustrates securing certified data types, in accordance with one embodiment. FIG. 16d illustrates a process that the certification application follows to ensure that all secured data types' values are secured and redacted in the results displayed to the modeler.

FIG. 16e illustrates securing search data types, in accordance with one embodiment. FIG. 16e illustrates a process that the certification application follows to ensure that all secured data types' values are secured and redacted in the results displayed to the modeler.

FIG. 16f illustrates securing certified class values, in accordance with one embodiment. FIG. 16f illustrates a process that the certification application follows to ensure that all secured data types' values are secured and redacted in the results displayed to the modeler.

FIG. 16g illustrates securing search class values, in accordance with one embodiment. FIG. 16g illustrates a process that the certification application follows to ensure that all secured data types' values are secured and redacted in the results displayed to the modeler.

FIG. 16h illustrates securing aggregate values, in accordance with one embodiment. FIG. 16h the process that the certification application follows to ensure that all secured data types' values are secured and redacted in the results displayed to the modeler.

The capabilities illustrates in FIG. 16d-16h further demonstrate the control and governance over classified values that is available using the system, method, and computer program herein disclosed.

FIG. 16i illustrates building search data types, in accordance with one embodiment. More specifically, FIG. 16i illustrates a process that a data modeler may follow to create new search data types. The modeler simply selects the certified data types and the repository application will automatically create the new search data types using the values from the selected data types. The new search data types are written to file for future use.

FIG. 16j illustrates building certified classes, in accordance with one embodiment. More specifically, FIG. 16j illustrates a process that a data modeler may follow to create new certified data classes. The modeler simply selects the certified data types and the repository application will automatically create the new certified data classes using the values from the selected certified data types. The new certified data classes are written to file for future use.

FIG. 16k illustrates building search classes, in accordance with one embodiment. More specifically, FIG. 16k illustrates a process that a data modeler may follow to create new search data classes. The modeler simply selects the search data types and the repository application will automatically create the new search data classes using the values from the selected search data types. The new search data classes are written to file for future use.

FIG. 16l illustrates building aggregates, in accordance with one embodiment. More specifically, FIG. 16l illustrates a process that a data modeler may follow to create aggregates. The modeler is prompted to enter the name and description for the aggregate. The certified data types are then presented for the modeler to select the data types to consolidate together and form the aggregate. The values from the selected certified data types are loaded into the new aggregate and saved to file.

FIG. 16m illustrates ending modeler tracking, in accordance with one embodiment. FIG. 16m illustrates a process for completing the tracking of the repository modeling work completed by the data modeler. This references the RTWM solution.

FIG. 17a-17i illustrate the process a data modeler (or domain searcher) follows to perform analysis against values in the certified repository.

FIG. 17a illustrates aspects of such a process, in accordance with one embodiment. As shown, the process may include one or more of the steps of: start modeler tracking, type search, select search data type value frequency, class search, select search data class value frequency, aggregate search, and end modeler tracking. FIG. 17b illustrates aspects of performing analysis against values in the certified repository, in accordance with one embodiment. More specifically, FIG. 17b illustrates a process the domain searcher (data modeler) will follow to perform analysis against the values in the certified repository. The domain searcher is presented with the ability to perform searches against the search data types, classes, and aggregates.

FIG. 17b shows that the data modeler's time may be tracked by the real-time workforce management (RTWM) solution.

FIG. 17c illustrates starting modeling tracking, in accordance with one embodiment. FIG. 17c identifies the process for initiating the tracking of the modeling and analysis work completed by the data modeler (domain searcher). This references the RTWM solution.

FIG. 17d illustrates entering a search value, in accordance with one embodiment. More specifically, FIG. 17d illustrates a process that the domain searcher follows to perform analysis against the values in the certified repository. The domain searcher is prompted to enter a search value and select a search data type prior to initiating the search. The repository application will pull all of the selected data type's values that align to the search value and present the results to the domain searcher for analysis. The domain searcher is able to drill into matches to view all of the certified values for the matched search value.

FIG. 17e illustrates selecting search type value frequency, in accordance with one embodiment. More specifically, FIG. 17e illustrates a process the domain searcher follows to review the selected data type value frequency matched to the search value submitted. The searcher is first presented with all of the matches for the search value submitted. The searcher is able to select a matched value to then view all of the certified values for this occurrence of the matched value; meaning that the certified values classified from the same unstructured value are presented for analysis. The searcher is also able to access the original unstructured value that the matched value originated from. This allows the searcher complete access to all of the classified values from the certified repository and the original attribute to perform detailed analysis.

FIG. 17f illustrates class searching, in accordance with one embodiment. More specifically, FIG. 17f illustrates a process the domain searcher follows to use the search classes to analyze the classification values in the certified repository. The domain searcher is prompted to enter a search value and the search class prior to initiating the search. The repository application will pull all of the search class' values that align to the search value and present the results to the domain searcher for analysis. The domain searcher is able to drill into matches to view all of the certified values for the matched search value.

FIG. 17g illustrates reviewing the selected data class value frequency, in accordance with one embodiment. More specifically, FIG. 17g illustrates a process the domain searcher follows to review the selected data class value frequency matched to the search value submitted. The searcher is able to select a matched value to then view all of the certified values for this occurrence of the matched value; meaning that the certified values classified from the same unstructured value are presented for analysis. The searcher is also able to access the original unstructured value that the matched value originated from. This allows the searcher complete access to all of the classified values from the certified repository and the original attribute to perform detailed analysis.

FIG. 17h illustrates aggregate searching, in accordance with one embodiment. More specifically, FIG. 17h illustrates a process the domain searcher follows to use the aggregates to analyze the classification values in the certified repository. The domain searcher is prompted to enter a search value and select the aggregate prior to initiating the search. The repository application will pull all of the aggregate values that align to the search value and present the results to the domain searcher for analysis. The aggregate contains all of the certified data type values for the domain searcher to analyze.

FIG. 17i illustrates ending modeler tracking, in accordance with one embodiment. FIG. 17i identifies a process for completing the tracking of the repository modeling and analysis work completed by the data modeler (domain searcher). This references the RTWM solution.

### Data Security

FIG. 18a-18c illustrate securing data types containing sensitive information.

FIG. 18a illustrates a high level overview of securing data types containing sensitive information, in accordance with one embodiment. The process may include one or more of the following steps: identify data type to secure, redact sensitive data type values within a data value, and display redacted data value. FIG. 18b illustrates aspects of securing data types containing sensitive information, in accordance with one embodiment. More specifically, FIG. 18b illustrates a process that the project manager follows to secure data types containing sensitive information across the entire data modeling project. The process is straightforward; the manager selects the data types to secure and then grants access to specific project team members. Granting no access will secure the data type values from the entire project team, including the project manager.

FIG. 18c illustrates aspects of security access, in accordance with one embodiment. FIG. 18c illustrates a process that the Clean Cloud application follows to secure sensitive values across the project. The first example validates the accessor's rights for the secured data type. All secured data types are then redacted in the unstructured value and returned to the caller. The second example validates the accessor's rights for the secured data type values. All secured data type values are redacted and returned to the caller. This example implies that the entire data type value is redacted and returned to the caller when secured.

FIG. 18d-18p illustrate aspects of a data security platform, in accordance with one embodiment.

FIG. 18d illustrates a high level process of securing sensitive data types. The process may include one or more of the following steps: start manager tracking, edit secured data type, add secured data type, edit secured aggregate, add secured aggregate, build security domain, build security certified, test security solution, classify unstructured value, and end manager tracking. FIG. 18e illustrates aspects of securing sensitive data types, in accordance with one embodiment. More specifically, FIG. 18e illustrates a process the manager follows to secure sensitive data types. The manager is presented with the existing secured data types and aggregates. The manager is able to create new or edit existing data types and aggregates. The manager is also able to create new security domains and security certified (meaning that the security is enforced using the certified classified values to enforce the security, rather than just classified values). The manager is provided with testing capabilities in the testing center to validate the secured data type and aggregate values are redacted properly.

FIG. 18e also shows that the project manager's time may be tracked by the real-time workforce management (RTWM) solution.

FIG. 18f illustrates start manager tracking, in accordance with one embodiment.

FIG. 18f illustrates a process for initiating the tracking of the security work completed by the project manager. This references the RTWM solution.

FIG. 18g illustrates securing sensitive data types, in accordance with one embodiment. More specifically, FIG. 18g illustrates a process the project manager follows to edit a secured data type. The manager is able to view the roles and individuals granted read access to the secured data type. The manager has the ability to grant or remove read access to specific roles or individuals. All changes are saved for future use.

FIG. 18h illustrates adding secured data types, in accordance with one embodiment. This figure identifies the process the project manager follows to add a new secured data type. The project manager is initially presented with a list of available data classes. The manager selects a data class and the corresponding data types are presented. The manager selects a data type and then grants roles and individual users read access.

FIGS. 18i(1) and 18i(2) illustrate editing secured aggregates, in accordance with one embodiment. More specifically, FIGS. 18i(1) and 18i(2) illustrate a process the project manager follows to edit existing secured aggregates. The manager is presented with the selected aggregate and is able to view the roles and users granted read access to the aggregate. The manager is able to grant and remove access to roles and individual users. The manager is also able to add new data types by accessing the data classes and selecting new data types to secure. The manager is also able to remove data types from the security aggregate. The manager is able to maintain the secured aggregates using this process.

FIG. 18j illustrates adding secured aggregates, in accordance with one embodiment. More specifically, FIG. 18j illustrates a process the manager follows to create a new secured aggregate. The manager first enters a name for the new aggregate. The manager then selects data classes to identify the specific data types to be secured. This process is repeated until the manager has identified all the aggregate's data types to secure. The manager then grants read access to roles and users. The new secured aggregate is saved to file for future use.

FIG. 18k illustrates building a secure domain, in accordance with one embodiment. More specifically, FIG. 18k illustrates a process the security platform follows to create a new security domain. The class names for the secured aggregates and data types are pulled from file and consolidated. Next, the new security domain is created and all of the data classes from the secured aggregates and data types are loaded into the new domain's secondary classes. The new domain is now complete and saved to file for future use.

FIG. 18l illustrates certifying build security, in accordance with one embodiment. More specifically, FIG. 18l illustrates a process that the security platform follows to create a new security domain using certified data. The data class names for the secured aggregates and data types are pulled from file and consolidated. Next, the values for the consolidated classes are extracted from the certified repository and stored in the certified repository for future use. The intention is that only certified values will be identified and redacted using the certified security domain.

FIG. 18m illustrates testing the security solution, in accordance with one embodiment. More specifically, FIG. 18m illustrates a process that the manger follows to test the security solution using the testing center. The manager is able to enter a user id and value to test and see what data will be redacted for the user. The manager is able to add as many values and user ids as needed to fully test the security. When the manager selects the secure button, the value is returned with secured values redacted. This allows the manager to test and determine if the security is properly configured to secure the sensitive information.

FIG. 18n illustrates securing sensitive information, in accordance with one embodiment. More specifically, FIG. 18n illustrates a process the security platform follows to secure the sensitive information using the certified values. First, the secured certified values are pulled from the certified repository. Next the submitted unstructured values are classified and the classified values are compared to the secured certified values. When matched, the sensitive certified values are redacted in the unstructured value. This process is repeated for every sensitive certified value pulled from the certified repository. The redacted results are returned to the caller.

FIGS. 18o(1), 18o(2), and 18o(3) illustrates classifying an unstructured value, in accordance with one embodiment. These figures illustrate the process the classification engine executes to classify values within an unstructured value. This process is substantially the same as the other described processes for classifying values within an unstructured value because the processes use the same classification engine.

FIGS. 18o(1), 18o(2), and 18o(3) illustrate the process executed by the classification engine to classify values within the submitted unstructured value. The classification engine first identifies the pattern for the submitted unstructured value and then compresses the pattern. The classification engine then searches against the compressed pattern for the unstructured value using the compressed patterns from the modeling data types identified by the submitted data domains' primary classes. The value for a matched compressed pattern is extracted from the unstructured value and then validated using the data constraints from the matched data type. Values that pass the data constraint validation are now classified and redacted from the original search value and the process is repeated until all the primary classes are processed.

As indicated in the figure, this process is repeated for the secondary classes and then the data quality classes from the submitted data domains. The classified values are then returned to the caller.

FIG. 18p illustrates ending manager tracking, in accordance with one embodiment. FIG. 18p identifies the process for completing the tracking of the security work completed by the project manager. This references the RTWM solution.

### Machine Learning

The system, method, and computer program provided herein may include a machine learning algorithm for classifying data. Training sets may be provided and developed for growing the capabilities of the machine learning algorithm. In some embodiments, the data modeler feeds values to the machine learning algorithm in the data classification engine. The data classification engine infers a data type based on data constraints.

It is to be appreciated that the system, method, and computer program maintain classification data types using a supervised machine learning process. Valid values are fed to the classification engine to add/update/or remove data constraints. This is an at least partially automated process for maintaining data types.

FIGS. 19a(1), 19a(2), and 19a(3) illustrate aspects of classifying unstructured values using the machine learning algorithm, in accordance with one embodiment. These figures illustrate the process the classification engine executes to classify values within an unstructured value. This process is substantially the same as the other described processes for classifying values within an unstructured value because the processes use the same classification engine.

FIGS. 19a(1), 19a(2), and 19a(3) illustrate the process executed by the classification engine to classify values within the submitted unstructured value. The classification engine first identifies the pattern for the submitted unstructured value and then compresses the pattern. The classification engine then searches against the compressed pattern for the unstructured value using the compressed patterns from the modeling data types identified by the submitted data domains' primary classes. The value for a matched compressed pattern is extracted from the unstructured value and then validated using the data constraints from the matched data type. Values that pass the data constraint validation are now classified and redacted from the original search value and the process is repeated until all the primary classes are processed.

As indicated in the figure, this process is repeated for the secondary classes and then the data quality classes from the submitted data domains. The classified values are then returned to the caller.

### System, Method, and Computer Program

Returning now to the overall system, method, and computer program for modeling unstructured data, aspects are shown and described below.

FIG. 20 illustrates an application view of a data modeling solution, in accordance with one embodiment. As shown, the model builder includes a classification engine, model classifier, a profile classifier, a domain searcher, and a certification engine. The model builder further includes a clean cloud interface. The roles of classifier (data modeler), project manager, assessor, and certifier are shown.

FIG. 21 illustrates an application view of a security module, in accordance with one embodiment. FIG. 21 illustrates a security platform and a clean cloud interface. The roles of classifier, project manager, model classifier, profile classifier, assessor, and certifier are depicted.

FIG. 22a-22f illustrate login screens for a variety of roles.

FIG. 22a illustrates the project manager login and how the manager creates new projects and accesses existing projects, in accordance with one embodiment. This important because the solution and project are initiated and governed by the project manager. Something else to note in the figure is that this also identifies that even the work performed by the project manager is being tracked by the workforce management solution.

FIG. 22b illustrates a data modeler login, in accordance with one embodiment.

This figure depicts the data modeler login. This login is for performing modeling and analysis tasks. The modeler logs into the Clean Cloud application and then selects the type of modeling to perform.

The modeler can access the certified repository to model classification data types, classes, and aggregates for the certified data. The newly modelled certified data types, classes, and aggregates are leveraged by the classification engine to automatically classify and certify data. The new modeled certified data types, classes, and aggregates are also utilized by the search engine provided for the certified repository.

The modeler can access the search engines to perform analysis against the certified data in the certified repository. The search capabilities are the equivalent of a SELECT in SQL and develop the certified repository a classification database that contains certified data.

The modeler can access an existing project to perform modeling for the project. This would include creating and maintaining classification data types, classes, class types, and domains.

The modeler can create new projects to create new classification data types, classes, class types, and domains for a planned project. In some embodiments, only a project manager can create a real data modeling project, the data modeler is creating a project bucket to track time against. The modeler needs to be able to create classification classes and domains used by the project manager to initiate the classification job and create the actual project.

FIG. 22c illustrates a lead modeler login, in accordance with one embodiment. More specifically, FIG. 22c illustrates the data modeler login for active project work. The data modeler is presented with all the active domain search projects assigned to them. When the modeler selects a project, the modeler's assignments for the project are presented. The lead modelers are responsible for performing the profile analysis and position analysis. They also participate as a lead to review the data quality assessment performed by the data quality analysts. The figure depicts the modeler selecting a project assignment.

FIG. 22d illustrates an analyst login, in accordance with one embodiment. More specifically, FIG. 22d illustrates the data quality analyst login for active project work. The data quality analysts perform the assessments to validate the classification results are accurate and meet the organization's data quality standards. This figure is depicting the analyst selecting a project and then the assessment project assignment.

FIG. 22e illustrates the certifier role, in accordance with one embodiment. More specifically, FIG. 22e illustrates the data community member login for active project work. The data community member will have one or more specific certifier roles assigned to them for the project to represent different areas of the organization. The six roles are governance, quality, business, subject matter experts, custodians, and data stewards. When the data community member selects a project and a certification project assignment, they are charged with certifying that the classified values are accurate and valid.

FIG. 22f illustrates manager login for a data security program, in accordance with one embodiment. This figure depicts the process the security platform follows to log the manager into the platform. The user ID and password are validated for the manager and the manager's projects are pulled and presented. The manager then accesses the security platform.

FIG. 23a illustrates a high level process view of running a project using a data modeling solution, in accordance with one embodiment. As shown, the process may include one or more of the following steps: build domain project, start manager tracking, build domain project, build domain classifications, classify unstructured value, and end manager tracking. FIG. 23b-23f illustrate aspects of running a project using a data modeling solution, in accordance with one embodiment.

FIG. 23b illustrates initiating a project. More specifically, FIG. 23b illustrates a process a project manager may follow to create the project for the data modeling solution. The project manager first selects a data source and the attributes to analyze within the data source. This causes the classification engine to extract all of the data from the original unstructured data source and then load the values into a JSON catalog for processing. The project manager then selects the domains that identify the data to classify. The manager is able to auto classify values by selecting certified data classes. Next, the manager initiates the classification job and the job monitor is displayed. The project manager's time may be tracked, as identified by the figure. This references the RTWM solution.

FIG. 23c illustrates starting a manager tracker, in accordance with one embodiment.

FIG. 23c identifies the process for initiating the tracking of the project manager's work for building the data modeling project. This references the RTWM solution.

FIGS. 23d(1) and 23d(2) illustrate building domain classification, in accordance with one embodiment. More specifically, FIG. 23b illustrates a process the classification engine executes to classify data in the unstructured values. The first step is to extract the values for each attribute from the JSON catalog for processing. If the manager identified certified classes, the classification engine pulls the certified values and stores them for use. Next, the classification engine analyzes each unstructured value from all of the attributes in parallel by first automatically classifying and redacting certified values when present and then analyzing the (redacted) value using the domains. The classified values are stored for analysis and the totals are presented to the project manager for review.

FIGS. 23e(1), 23e(2), and 23e(3) illustrate classifying unstructured values, in accordance with one embodiment. These figures illustrate the process the classification engine executes to classify values within an unstructured value. This process is substantially the same as the other described processes for classifying values within an unstructured value because the processes use the same classification engine.

FIGS. 23e(1), 23e(2), and 23e(3) illustrate the process executed by the classification engine to classify values within the submitted unstructured value. The classification engine first identifies the pattern for the submitted unstructured value and then compresses the pattern. The classification engine then searches against the compressed pattern for the unstructured value using the compressed patterns from the modeling data types identified by the submitted data domains' primary classes. The value for a matched compressed pattern is extracted from the unstructured value and then validated using the data constraints from the matched data type. Values that pass the data constraint validation are now classified and redacted from the original search value and the process is repeated until all the primary classes are processed.

As indicated in the figure, this process is repeated for the secondary classes and then the data quality classes from the submitted data domains. The classified values are then returned to the caller.

FIG. 23f illustrates ending manager tracking, in accordance with one embodiment. FIG. 23f illustrates a process for completing the tracking of the project manager's work for building the data modeling project. This references the RTWM solution.

### Real Time Workforce Management

A system, method, and software program for real time workforce management is provided. The real time workforce management (RTWM) system enables management of projects in real time can be used to monitor progress, prevent project overrun, and properly allocate resources. In some embodiments, the real time workforce management system includes a layer of security wherein users can only access aspects of the project if they have a legitimate work assignment made to them.

FIG. 24a-24j, 25a-25h, 26a-26d, and 27a-27j illustrate aspects of the real time workforce management system in accordance with one embodiment.

FIG. 24a illustrates aspects of the project manager role, in accordance with one embodiment. More specifically, FIG. 24a illustrates management processes that the project manager uses to build the project, monitor project status, monitor project work activity, and monitor the project plan. The project manager will select the appropriate management process to govern the project, work, and workforce.

FIG. 24b illustrates managing a project, in accordance with one embodiment. More specifically, FIG. 24a illustrates a process the project manager uses to establish the project management governance. The project manager assigns project team members to project roles, creates the project plan, creates the work schedule, and manages the project security. FIG. 24b further illustrates that the project manager's time may be tracked.

FIG. 24c illustrates starting project manager tracking, in accordance with one embodiment. FIG. 24c illustrates a process for initiating the tracking of the project manager's work for managing and monitoring (governing) the data modeling project.

FIGS. 24d(1) and 24d(2) illustrate building project management files, in accordance with one embodiment. FIGS. 24d(1) and 24d(2) illustrate a process the RTWM solution follows to create project management files. The process includes creating all of the files required to define and track the project work.

FIG. 24e illustrates scheduling work, in accordance with one embodiment. More specifically, FIG. 24e illustrates a process the project manager follows to create the work schedule. This work is completed using the RTWM work scheduler. The project manager first assigns all of the dates and hours for each of the modeling and analysis work schedule tasks. Next the dates and hours for managing the project and performing the classification data modeling tasks are assigned by the project manager.

The work schedule is then automatically calculated by the RTWM scheduler. The work schedule is then implemented, which updates all of the underlying project management and work schedule files. The project manager initiates the project in the last step. Initiating the project releases the assignments to the project team members to start the project work.

FIGS. 24f(1) and 24f(2) illustrates implementing a work schedule, in accordance with one embodiment. FIGS. 24f(1) and 24f(2) illustrate the RTWM scheduler updating all of the project management and work schedule files with the dates and hours assigned for each of the work schedule tasks.

FIG. 24g illustrates initiating a work schedule, in accordance with one embodiment. FIG. 24g illustrates the RTWM scheduler initializing the work control object with the project dates and estimated work hours. Next the RTWM scheduler updates the project tracking hours with the work performed by the project manager and data modeler completed for the project to date. The final step saves the scheduled work control object to file.

FIG. 24h illustrates managing project security, in accordance with one embodiment. More specifically, FIG. 24h illustrates a process that the project manager follows to define the security access for classification data types. The project manager has comprehensive control over the visibility of classified values to the project team members. This allows the project manager to secure data types that contain sensitive business data. The intention is to govern and control the visibility of sensitive business values exposed to the project team, minimizing insider threats.

FIG. 24i illustrates ending project manager tracking, in accordance with one embodiment. FIG. 24i illustrates a process for completing the tracking of the project manager's work for building and initiating the work schedule control file and establishing the data type security for the data modeling project.

FIG. 24j illustrates aspects of tracking project status, in accordance with one embodiment. More specifically, FIG. 24j illustrates a process the project manager follows to track the project work. The project manager monitors the profile and position analysis completed by the data modelers. The project manager validates that all of the work has been completed properly before completing the modeling step that releases the work assignments to the data quality team to perform the assessment against the classification results to ensure the values meet the organization's data quality standards.

The project manager then monitors the assessment performed by the data quality team. When the data quality assessment work is complete, the project manager runs the job to prepare the classified values for certification and release the assignments to the data community to perform the data certification tasks. The project manager then monitors the work completed by the data community to certify the results. Once the certification work assignments are completed by the data community, the project manager validates the certification work is finished and marks the entire project complete.

The final step in the data modeling solution includes having the project manager load the certified values into the certified repository by data type. The project manager completes this final step of the project that establishes the certified data to be used to automatically classify and certify values in new unstructured data.

FIG. 25a illustrates starting manager tracking, in accordance with one embodiment. FIG. 25a illustrates a process for initiating the tracking of the project manager's work for monitoring the project status and governing the work assignments.

FIG. 25b illustrates creating certification, in accordance with one embodiment. More specifically, FIG. 25b illustrates a process that the classification engine follows to create the certification results. The first steps update and release the project work tasks for certifying the data. Next, the classification engine builds the attribute certification and pre-certifies values that have already been certified by the data community. Once this is complete the classification engine builds the data type certification and pre-certifies values that have already been certified by the data community. When this step completes, the classification engine updates the work control and releases the certification assignments to the data community.

FIG. 25c illustrates creating attributed certification, in accordance with one embodiment. More specifically, FIG. 25c illustrates a process that the classification engine uses to create the attribute certification. The first step establishes the attribute level certification files. Once complete, the classification engine loads all of the certified values by attribute and row for certification. This creates the most granular view of the data for certification because the data community is able to see exactly what values were classified for each attribute row.

FIG. 25d illustrates identifying pre-certify values, in accordance with one embodiment. More specifically, FIG. 25d illustrates a process the classification engine follows to identify and pre-certify values at the attribute level. The classification engine compares all of the existing certified values by data from the certified repository to the newly classified values to be certified by attribute. All value matches are removed from the certification values and loaded into the pre-certified values. The values that do not match are loaded by attribute and row for certification by the data community.

FIG. 25e illustrates building data type values, in accordance with one embodiment. More specifically, FIG. 25e illustrates a process the classification engine follows to build the data type values for certification. The first step creates the data type level certification files, which tracks the certification at the data type level. The next step creates the actual data type value frequencies for certification. This allows the data community to certify the values align with the classification data type and the values themselves are valid, accurate, and viable for analysis use.

FIG. 25f illustrates pre-certifying values by data type, in accordance with one embodiment. More specifically, FIG. 25f illustrates a process the classification engine follows to pre-certify values by data type. The first step loads the certified values by the classification data type for comparison to the newly classified data type values being certified. The values that match the certified values are loaded as pre-certified values for review by the data community.

FIGS. 25g(1) and 25g(2) illustrates validating that certification is complete, in accordance with one embodiment. These figures illustrate a process the project manager follows to validate the data community completed the certification process. The project manager first resolves any open certification disputes. Next, the project manager validates that all of the values have been certified by each role from the data community. Once satisfied the work has been completed properly, the project manager sets the work control status to complete, which marks the project complete.

FIG. 25h illustrates ending manager tracking, in accordance with one embodiment. FIG. 25h identifies the process for completing the tracking of the project manager's work for monitoring the project status and governing the work assignments.

FIG. 26a illustrates a high level view of monitoring project work activity, in accordance with one embodiment. FIG. 26a illustrates a process the project manager follows to monitor the project work activity in real time. The project manager has the ability to clear hung work sessions for project team members, which ensures that the project time is tracked and reported properly. As shown, the project manager's time may be tracked by the real-time workforce management (RTWM) solution.

FIG. 26b illustrates starting manager tracking, in accordance with one embodiment. FIG. 26b illustrates a process for initiating the tracking of the project manager's work for monitoring the project activity and governing the project team's work activity.

FIG. 26c illustrates clearing inactive work operations, in accordance with one embodiment. The project activity monitor allows the project manager to monitor active project work by resource. FIG. 26c illustrates a process the project manager follows to clear an inactive or hung work session. The primary concern is capturing the data and time the work session actually completed. The open work session is then closed using the captured date and time.

FIG. 26d illustrates ending manager tracking, in accordance with one embodiment. This figure identifies the process for completing the tracking of the project manager's work for monitoring the project activity and governing the project team's work activity.

FIG. 27a illustrates a high level view of monitoring a project plan, in accordance with one embodiment. More specifically, FIG. 27a illustrates a process that the project manager follows to monitor the project plan. The project manager is able to see what work has been completed at the project level. This process provides the project manager with a high-level view of the work completed against the project to date. This allows the project manager to identify when to govern the project work schedule assignments and project team members to ensure timely delivery of the project on time and budget. As shown, the project manager's time may be tracked by the real-time workforce management (RTWM) solution.

FIG. 27b illustrates starting manager tracking, in accordance with one embodiment. FIG. 27b illustrates a process for initiating the tracking of the project manager's work for monitoring the project plan to govern the work assignments and project team allocations.

FIG. 27c illustrates monitoring a profile, in accordance with one embodiment. More specifically, FIG. 27a illustrates a process the project manager follows to monitor the status of the profile analysis tasks and assignments. The project manager is also able to review the profile work operations to determine if the pace the work is completed will deliver the results on time and budget.

FIG. 27d illustrates a monitoring a profile, in accordance with one embodiment.

FIG. 27d illustrates a process the project manager follows to monitor the status of the position analysis tasks and assignments. The project manager is also able to review the position analysis work operations to determine if the pace the work is completed will deliver the results on time and budget.

FIG. 27e illustrates monitoring assessment, in accordance with one embodiment. The data quality team performs the data quality assessment to validate the values have been classified properly and that the classified values meet the organization's data quality standards. FIG. 27e illustrates the project manager monitoring the assessment work completed by the data quality team. The project manager is able to monitor the work operations to determine if the data quality assessment will be completed on time and budget.

FIG. 27f illustrates monitoring data type certification, in accordance with one embodiment. FIG. 27f illustrates a process the project manager follows to monitor the data type certification work completed by the data community. The project manager is able to monitor the work operations to determine if the data type certification will be completed on time and budget.

FIG. 27g illustrates monitoring attribute certification, in accordance with one embodiment. FIG. 27g illustrates a process the project manager follows to monitor the certification of the values by attribute. The project manager is able to monitor the work operations to determine if the attribute certification will be completed on time and budget.

FIG. 27h illustrates monitoring data modeling, in accordance with one embodiment. FIG. 27h illustrates a process the project manager follows to monitor the data modeling work completed for the project. The project manager reviews the work operations to determine if the data modeling work will complete on time and budget.

FIG. 27i illustrates monitoring project management, in accordance with one embodiment. This figure identifies the process the project manager follows to monitor the project management work completed for the project. The project manager reviews the work operations to determine if the project management will complete on time and budget.

FIG. 27j illustrates ending manager tracking, in accordance with one embodiment. FIG. 27f illustrates a process for completing the tracking of the project manager's work for monitoring the project plan to govern the work assignments and project team allocations. (RTWM)

In a non-limiting embodiment of the disclosure, a system, a method and a computer program are provided for data modeling, data quality, and data governance. The technology disclosed herein can assist in classification of unstructured data.

With reference to FIGS. 1 and 20, block figures of a model builder system 2, constructed according to the principles of the disclosure, are shown. The certification system 1 can in include a combination of computer resources assets, including a database 4, a processor 5, an input-output (I/O) interface 6, a network interface 7, a memory 8, an audio and video driver 9, a transceiver (not shown), a classifier 14, a project manager 15, a model classifier 16, a profile classifier 17, an assessor 18, a certifier 19, and a domain searcher 21. The certification system 2 can include a clean cloud interface 50, which can be configured to communicate with a remote server. The database 4 can include a database server. The database 4 can include a structured database 11, a semi-structured database 12, an unstructured database 13, and the certified repository 20. Any of the computer resources assets can be interconnected using various communication links, including buses, and can be mounted on a common motherboard or provided as separate computing devices. The certification system 1, including any of the computer resource assets contained in the system, can be configured to perform each process depicted in the attached drawings. Since the drawings form part of the instant disclosure and are included herein, aspects of the drawings that are clear and understandable from the illustrations will not be repeated herein, so as to reduce any redundancy in disclosure.

FIGS. 3 and 21 depict block figures of a security system 3, constructed according to the principles of the disclosure. In various embodiments, the security system 3 can include the MB system 2. In addition to any of the computer resource assets depicted in FIGS. 1 and 20, the security system 3 can include a security platform 30. The security platform 30 can include a security solution 32, a data classifier 33, a data redactor 34, a data security appliance 35, and a security controller 36. In an embodiment, the data classifier 33 can include the classifier 14. In an alternative embodiment, the classifier 14 can include the data classifier 33. The security system 3 can be configured to initialize a communication session with a communicating device 31, such as, for example a cellular phone of a caller. The security system 3 can be configured to receive an incoming communication from, or transmit an outgoing communication to, the communicating device 31. The security system 3, including any of the computer resource assets contained in the system, can be configured to perform each process depicted in the corresponding drawings.

The processor 5 can be arranged to process instructions for execution, including instructions stored in the memory. The processor can be arranged to generate and send or display graphical information for a graphic user interface (GUI) on a display screen, including, for example, an external input/output computer resource asset such as a computing device that can be coupled to a communication system via a communication link such as, for example, over a network. In other implementations, multiple processors or multiple buses can be used, as appropriate, along with multiple memories and types of memory. The computer resource asset can be connected with any computer resource asset in a user environment and arranged to provide portions of the necessary operations, such as, for example, a server bank, a group of blade servers, or a multi-processor system.

The processor 5 can include any of various commercially available processors. The processor can include a computing device. Dual microprocessors and other multi-processor architectures can be employed as the processor. The processor can include a central processing unit (CPU) or a graphic processing unit (GPU). The processor can be arranged to interact with any of the computer resource assets in the communication system to carry out or facilitate with the processes described herein.

Any of the computer resources contained in the certification system 1 can be communicatively coupled to a bus. The bus can include any of several types of bus structures that can further interconnect to a memory bus (with or without a memory controller), a peripheral bus, and a local bus using any of a variety of commercially available bus architectures.

The memory 8 can include a read-only memory (ROM), a random-access memory (RAM), a hard disk drive (HDD), an optical disk drive (ODD), and a database (DB). The memory can provide nonvolatile storage of data, data structures, and computer-executable instructions, and can accommodate the storage of any data in a suitable digital format. The memory can include a computer-readable medium that can hold executable or interpretable computer code (or instructions) that, when executed by the processor, cause the steps, processes and methods in this disclosure to be carried out. The computer-readable medium can be contained in the memory, and can include sections of computer code contained in a non-transitory medium.

A basic input-output system (BIOS) can be stored in the ROM, which can include, for example, a non-volatile memory, an erasable programmable read-only memory (EPROM), or an electrically erasable programmable read-only memory (EEPROM). The BIOS can contain the basic routines that help to transfer information between any one or more of the computing resource assets, such as during start-up.

The RAM can include dynamic random-access memory (DRAM), a synchronous dynamic random-access memory (SDRAM), a static random-access memory (SRAM), a nonvolatile random-access memory (NVRAM), or another high-speed RAM for caching data.

The HDD can include, for example, an enhanced integrated drive electronics (EIDE) drive, a serial advanced technology attachments (SATA) drive, or any suitable hard disk drive for use with big data. The HDD can be configured for external use in a suitable chassis (not shown).

The ODD can be arranged to read or write from or to a compact disk (CD)-ROM disk (not shown), or, read from or write to other high capacity optical media such as a digital versatile disk (DVD).

The HDD or ODD can be connected to the bus by a hard disk drive interface (not shown) and an optical drive interface (not shown), respectively. The hard disk drive interface (not shown) can include a Universal Serial Bus (USB) (not shown), an IEEE 1394 interface (not shown), and the like, for external applications.

The DB 4 can include one or more databases, including, for example, one or more relational databases. The DB can store machine learning (ML) training datasets and ML testing datasets for building and/or training a machine learning (ML) model. In an embodiment, one or more of the computer resource assets can include a machine learning platform that can be configured to build a machine learning model and train the ML model to perform the operations disclosed herein. The ML model can be trained to analyze audible, visual, textual or other content. The ML model can be loaded, for example, into the RAM, and run by the processor executing computer resource processes on the ML platform. The training datasets can be updated periodically (or continuously) with updated parametric values, such as, for example, during parametric tuning of the ML model.

The memory 8 can be arranged to provide mass storage, for example, in the DB 4. The memory can include a database server storage. The memory can contain a computer-readable medium, such as a solid-state drive (SSD), a hard disk device, an optical disk device, a flash memory or other similar solid-state memory device, or an array of devices, including devices in a storage area network or other configurations.

A computer program product can be tangibly embodied in a non-transitory computer-readable medium, which can be contained in the memory. The computer program product can contain instructions that, when executed, perform one or more methods or operations, such as those included in this disclosure. The computer-readable medium can include an information carrier such as the memory or memory on processor.

Any number of computer resources can be stored in the memory, including, for example, a program module, an operating system, an application program, an application program interface (API), or program data. The computing resource can include an API such as, for example, a web API, a simple object access protocol (SOAP) API, a remote procedure call (RPC) API, a representation state transfer (REST) API, or any other utility or service API. Any (or all) of the operating system, application programs, APIs, program modules, and program data can be cached in the RAM 12B as executable sections of computer code.

The API can include an API for a markup language such as, for example, SGML, SVG, HTML, XHTML/XML), XUL, or LaTeX.

The API can include an API for a style sheet language, such as, for example, CSS, DSSSL, or XSL. The API can include a web-based API, an operating system API, a database system API, a computer hardware API, or a library API. The API can include, for example, one or more of the APIs available at <<https://developers.google.com>>.

The API can include one or more APIs that connect webpages to scripts or programing languages, including modelling (for example, SGML, SVG, HTML, XHTML/XML, XUL) documents as objects.

The API can include a document object model (DOM) API, such as for HTML or XML (for example, DOM5 HTML), that can create object-oriented representations of AV content that can be modified with a scripting module (not shown). A DOM can include a cross-platform and language-independent convention for representing and interacting with objects in HTML, XHTML/XML, SGML, SVG, or XUL.

The network interface 7 can be connected to a network, which can include the Internet. The network interface can include a wired or a wireless communication network interface (not shown) or a modem (not shown). When used in a local area network (LAN), the computer resource asset can be connected to the LAN network through the wired or wireless communication network interface; and, when used in a wide area network (WAN), the computer resource asset can be connected to the WAN network through the modem. The modem (not shown) can be internal or external and wired or wireless. The modem can be connected to the system bus via, for example, a serial port interface (not shown). The network interface can include a receiver (not shown), a transmitter (not shown) or a transceiver (not shown).

The input-output (IO) interface 6 can receive commands or data from an operator via a user interface (not shown), such as, for example, a keyboard (not shown), a mouse (not shown), a pointer (not shown), a stylus (not shown), a microphone (not shown), a speaker (not shown), or a display device (not shown). The received commands and data can be forwarded from the IO interface as instruction to data signals, via the bus, to any of the computer resource assets in the embodiments depicted in any of the Figures.

The driver suite 9 can include an audio driver and a video driver. The audio driver can include a sound card, a sound driver, an interactive voice response (IVR) unit, or any other device necessary to render a sound signal on a sound production device, such as for example, a speaker. The video driver can include a video card, a graphics driver, a video adaptor, or any other device necessary to render an image signal on a display device.

The terms “a,” “an,” and “the,” as used in this disclosure, means “one or more,” unless expressly specified otherwise.

The term “backbone,” as used in this disclosure, means a transmission medium that interconnects one or more computing devices or communicating devices to provide a path that conveys data signals and instruction signals between the one or more computing devices or communicating devices. The backbone can include a bus or a network. The backbone can include an ethernet TCP/IP. The backbone can include a distributed backbone, a collapsed backbone, a parallel backbone or a serial backbone.

The term “bus,” as used in this disclosure, means any of several types of bus structures that can further interconnect to a memory bus (with or without a memory controller), a peripheral bus, or a local bus using any of a variety of commercially available bus architectures. The term “bus” can include a backbone.

The terms “communicating device” and “communication device,” as used in this disclosure, mean any hardware, firmware, or software that can transmit or receive data packets, instruction signals, data signals, optical signals, sound signals, radio frequency signals or electromagnetic signals over a communication link. The device can include a computer or a server. The device can be portable or stationary.

The term “communication link,” as used in this disclosure, means a wired or wireless medium that conveys data or information between at least two points. The wired or wireless medium can include, for example, a metallic conductor link, a radio frequency (RF) communication link, an Infrared (IR) communication link, or an optical communication link. The RF communication link can include, for example, WiFi, WiMAX, IEEE 802.11, DECT, 0G, 1G, 2G, 3G, 4G, or 5G cellular standards, or Bluetooth. A communication link can include, for example, an RS-232, RS-422, RS-485, or any other suitable serial interface.

The terms “computer,” “computing device,” or “processor,” as used in this disclosure, means any machine, device, circuit, component, or module, or any system of machines, devices, circuits, components, or modules that are capable of manipulating data according to one or more instructions. The terms “computer,” “computing device” or “processor” can include, for example, without limitation, a communicating device, a computer resource, a processor, a microprocessor (μC), a central processing unit (CPU), a graphic processing unit (GPU), an application specific integrated circuit (ASIC), a general purpose computer, a super computer, a personal computer, a laptop computer, a palmtop computer, a notebook computer, a desktop computer, a workstation computer, a server, a server farm, a computer cloud, or an array or system of processors, μCs, CPUs, GPUs, ASICs, general purpose computers, super computers, personal computers, laptop computers, palmtop computers, notebook computers, desktop computers, workstation computers, or servers.

The terms “computing resource” or “computer resource,” as used in this disclosure, means software, a software application, a web application, a web page, a computer application, a computer program, computer code, machine executable instructions, firmware, or a process that can be arranged to execute on a computing device as one or more processes.

The terms “computer asset,” “computing resource asset” or “computer resource asset,” as used in this disclosure, means a computing resource, a computing device or a communicating device.

The term “computer-readable medium,” as used in this disclosure, means any non-transitory storage medium that participates in providing data (for example, instructions) that can be read by a computer. Such a medium can take many forms, including non-volatile media and volatile media. Non-volatile media can include, for example, optical or magnetic disks and other persistent memory. Volatile media can include dynamic random-access memory (DRAM). Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium can include a “cloud,” which can include a distribution of files across multiple (e.g., thousands of) memory caches on multiple (e.g., thousands of) computers.

Various forms of computer readable media can be involved in carrying sequences of instructions to a computer. For example, sequences of instruction (i) can be delivered from a RAM to a processor, (ii) can be carried over a wireless transmission medium, or (iii) can be formatted according to numerous formats, standards or protocols, including, for example, WiFi, WiMAX, IEEE 802.11, DECT, 0G, 1G, 2G, 3G, 4G, or 5G cellular standards, or Bluetooth.

The term “database,” as used in this disclosure, means any combination of software or hardware, including at least one computing resource or at least one computer. The database can include a structured collection of records or data organized according to a database model, such as, for example, but not limited to at least one of a relational model, a hierarchical model, or a network model. The database can include a database management system application (DBMS). The at least one application may include, but is not limited to, a computing resource such as, for example, an application program that can accept connections to service requests from communicating devices by sending back responses to the devices. The database can be configured to run the at least one computing resource, often under heavy workloads, unattended, for extended periods of time with minimal or no human direction.

The terms “including,” “comprising” and their variations, as used in this disclosure, mean “including, but not limited to,” unless expressly specified otherwise.

The term “network,” as used in this disclosure means, but is not limited to, for example, at least one of a personal area network (PAN), a local area network (LAN), a wireless local area network (WLAN), a campus area network (CAN), a metropolitan area network (MAN), a wide area network (WAN), a metropolitan area network (MAN), a wide area network (WAN), a global area network (GAN), a broadband area network (BAN), a cellular network, a storage-area network (SAN), a system-area network, a passive optical local area network (POLAN), an enterprise private network (EPN), a virtual private network (VPN), the Internet, or the like, or any combination of the foregoing, any of which can be configured to communicate data via a wireless and/or a wired communication medium. These networks can run a variety of protocols, including, but not limited to, for example, Ethernet, IP, IPX, TCP, UDP, SPX, IP, IRC, HTTP, FTP, Telnet, SMTP, DNS, ARP, ICMP.

The term “server,” as used in this disclosure, means any combination of software or hardware, including at least one computing resource or at least one computer to perform services for connected communicating devices as part of a client-server architecture. The at least one server application can include, but is not limited to, a computing resource such as, for example, an application program that can accept connections to service requests from communicating devices by sending back responses to the devices. The server can be configured to run the at least one computing resource, often under heavy workloads, unattended, for extended periods of time with minimal or no human direction. The server can include a plurality of computers configured, with the at least one computing resource being divided among the computers depending upon the workload. For example, under light loading, the at least one computing resource can run on a single computer. However, under heavy loading, multiple computers can be required to run the at least one computing resource. The server, or any if its computers, can also be used as a workstation.

The terms “send,” “sent,” “transmission,” or “transmit,” as used in this disclosure, means the conveyance of data, data packets, computer instructions, or any other digital or analog information via electricity, acoustic waves, light waves or other electromagnetic emissions, such as those generated with communications in the radio frequency (RF) or infrared (IR) spectra. Transmission media for such transmissions can include coaxial cables, copper wire and fiber optics, including the wires that comprise a system bus coupled to the processor.

Devices that are in communication with each other need not be in continuous communication with each other unless expressly specified otherwise. In addition, devices that are in communication with each other may communicate directly or indirectly through one or more intermediaries.

Although process steps, method steps, or algorithms may be described in a sequential or a parallel order, such processes, methods and algorithms may be configured to work in alternate orders. In other words, any sequence or order of steps that may be described in a sequential order does not necessarily indicate a requirement that the steps be performed in that order; some steps may be performed simultaneously. Similarly, if a sequence or order of steps is described in a parallel (or simultaneous) order, such steps can be performed in a sequential order. The steps of the processes, methods or algorithms described in this specification may be performed in any order practical.

When a single device or article is described, it will be readily apparent that more than one device or article may be used in place of a single device or article. Similarly, where more than one device or article is described, it will be readily apparent that a single device or article may be used in place of the more than one device or article. The functionality or the features of a device may be alternatively embodied by one or more other devices which are not explicitly described as having such functionality or features.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A method for data modeling is provided, the method comprising:
classification of raw values to establish classified values;
profile analysis of the classified values;
position analysis of the classified values; and
data quality assessment of the classified values.

2. The method of claim 1, wherein the raw values are unstructured.

3. The method of claim 1, further comprising certification of the classified values.

4. The method of claim 1, wherein classification is done by a classification engine.

5. The method of claim 4, wherein the classification engine learns by machine learning.
